(19) United States
(12) Patent Application Publication
(10) Pub. No.: US 2022/0392455 A1
(43) Pub. Date: Dec. 8, 2022

(54) METHODS AND USER INTERFACES FOR VOICE-BASED USER PROFILE MANAGEMENT

(71) Applicant: Apple Inc., Cupertino, CA (US)

(72) Inventors: Jeffrey MA, Emerald Hills, CA (US); Corey J. PETERSON, Saratoga, CA (US); Pierre P. GREBORIO, Sunnyvale, CA (US); Rob Bowles SINCLAIR, Los Gatos, CA (US); Hiu Yi CHAN, Seattle, WA (US)

(21) Appl. No.: 17/832,657

(22) Filed: Jun. 5, 2022

Related U.S. Application Data
(60) Provisional application No. 63/349,080, filed on Jun. 4, 2022.
(60) Provisional application No. 63/197,475, filed on Jun. 6, 2021.

(51) Int. Cl. G10L 17/22; H04L 67/306; G06F 21/32

(52) U.S. Cl. CPC G10L 17/22; H04L 67/306; G06F 21/32

(57) ABSTRACT

The present disclosure generally relates to managing user profiles. An example method includes, at a computer system in communication with a display generation component and an input device: receiving, via the input device, a user input including a request to access a first restricted media item; and in response to the user input: in accordance with a determination the user input is a voice input and the voice input corresponds to a user profile authorized to access the first restricted media item using voice inputs, initiating playback of the first restricted media item; and in accordance with a determination the user input is a voice input and the voice input does not correspond to a user profile authorized to access the first restricted media item using voice inputs: forgoing initiating playback of the first restricted media item; and causing display, at the display generation component, of a validation user interface.

### CROSS-REFERENCE TO RELATED APPLICATIONS

This application claims priority to U.S. Provisional Application No. 63/349,080, entitled “METHODS AND USER INTERFACES FOR VOICE-BASED USER PROFILE MANAGEMENT” filed Jun. 4, 2022, and U.S. Provisional Application No. 63/197,475, entitled “METHODS AND USER INTERFACES FOR VOICE-BASED USER PROFILE MANAGEMENT,” filed Jun. 6, 2021, the entire contents of which are hereby incorporated by reference.

### RELATED APPLICATIONS

This application is related to U.S. patent application Ser. No. 17/468,286 entitled “METHODS AND USER INTERFACES FOR VOICE-BASED USER PROFILE MANAGEMENT” filed Sep. 7, 2021.

### FIELD

The present disclosure relates generally to computer user interfaces, and more specifically to techniques for managing user profiles.

### BACKGROUND

User profiles implemented on computer systems provide a customized experience to each user of such systems. Each user's experiences may be tailored based on one or more user characteristics, such as user preferences or behavior.

### BRIEF SUMMARY

Some techniques for managing user profiles using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing user profiles. Such methods and interfaces optionally complement or replace other methods for managing user profiles. Such methods and interfaces reduce the cognitive burden on a user and produce a more efficient human-machine interface. For battery-operated computing devices, such methods and interfaces conserve power and increase the time between battery charges.

Example methods are described herein. An example method includes, at a computer system in communication with a display generation component and one or more input devices: receiving, via the one or more input devices, a user input including a request to access a first restricted media item; and in response to receiving the user input: in accordance with a determination that the user input is a voice input and a determination that the voice input corresponds to a stored user profile that is authorized to access the first restricted media item using voice inputs, initiating playback of the first restricted media item; and in accordance with a determination that the user input is a voice input and a determination that the voice input does not correspond to a stored user profile that is authorized to access the first restricted media item using voice inputs: forgoing initiating playback of the first restricted media item; and causing display, at the display generation component, of a validation user interface.

An example method includes, at a computer system in communication with a display generation component and a voice input device: while a first user profile is active, receiving, via the voice input device, a voice input; and in response to receiving the voice input: in accordance with a determination that the voice input includes a request to switch user profiles, and a determination that the voice input corresponds to a second user profile, switching from the first user profile to the second user profile; and in accordance with a determination that the voice input includes a request to switch user profiles, and a determination that the voice input does not correspond to a stored user profile: forgoing switching user profiles; and causing display, at the display generation component, of a disambiguation user interface that includes a plurality of candidate user profiles.

An example method includes, at a computer system in communication with a display generation component, performing a configuration process for the computer system, wherein the configuration process includes: in accordance with a determination that a set of personalized voice recognition criteria is not met for an active user profile of the computer system, causing display, via the display generation component, of a set of one or more user interfaces including an option that, when selected, initiates a process that enables voice recognition for the active user profile; and in accordance with a determination that the set of personalized voice recognition criteria is met for the active user profile, proceeding with the configuration process without providing the option to enable voice recognition for the active user profile during the configuration process.

An example method includes, at a computer system in communication with a display generation component and a set of one or more voice input devices, while a first user profile of the computer system is an active user profile of the computer system, receiving, via the one or more input devices, a speech input corresponding to a second user profile of the computer system that is an inactive user profile of the computer system; and in response to receiving the speech input, providing a set of suggested media items associated with the second user profile of the computer system.

An example method includes, at a computer system in communication with a display generation component and a set of one or more input devices, causing display of, via the display generation component, a first candidate user profile that has a predetermined relationship with an active user profile of the computer system; receiving, via the one or more input devices, a first input that corresponds to a selection of the first candidate user profile; and in response to the first input, initiating a process to configure the first candidate user profile as a user profile for the computer system.

Example non-transitory computer-readable storage media are described herein. An example non-transitory computer-readable storage medium stores one or more programs configured to be executed by one or more processors of a computer system that is in communication with a display generation component and one or more input devices and includes instructions for: receiving, via the one or more input devices, a user input including a request to access a first restricted media item; and in response to receiving the user input: in accordance with a determination that the user input is a voice input and a determination that the voice input corresponds to a stored user profile that is authorized to access the first restricted media item using voice inputs, initiating playback of the first restricted media item; and in accordance with a determination that the user input is a voice input and a determination that the voice input does not correspond to a stored user profile that is authorized to access the first restricted media item using voice inputs: forgoing initiating playback of the first restricted media item; and causing display, at the display generation component, of a validation user interface.

An example non-transitory computer-readable storage medium stores one or more programs configured to be executed by one or more processors of a computer system that is in communication with a display generation component and a voice input device, the one or more programs including instructions for: while a first user profile is active, receiving, via the voice input device, a voice input; and in response to receiving the voice input: in accordance with a determination that the voice input includes a request to switch user profiles, and a determination that the voice input corresponds to a second user profile, switching from the first user profile to the second user profile; and in accordance with a determination that the voice input includes a request to switch user profiles, and a determination that the voice input does not correspond to a stored user profile: forgoing switching user profiles; and causing display, at the display generation component, of a disambiguation user interface that includes a plurality of candidate user profiles.

An example non-transitory computer-readable storage medium stores one or more programs configured to be executed by one or more processors of a computer system that is in communication with a display generation component, the one or more programs including instructions for: performing a configuration process for the computer system, wherein the configuration process includes: in accordance with a determination that a set of personalized voice recognition criteria is not met for an active user profile of the computer system, causing display, via the display generation component, of a set of one or more user interfaces including an option that, when selected, initiates a process that enables voice recognition for the active user profile; and in accordance with a determination that the set of personalized voice recognition criteria is met for the active user profile, proceeding with the configuration process without providing the option to enable voice recognition for the active user profile during the configuration process.

An example non-transitory computer-readable storage medium stores one or more programs configured to be executed by one or more processors of a computer system that is in communication with a display generation component and one or more input devices, the one or more programs including instructions for: while a first user profile of the computer system is an active user profile of the computer system, receiving, via the one or more input devices, a speech input corresponding to a second user profile of the computer system that is an inactive user profile of the computer system; and in response to receiving the speech input, providing a set of suggested media items associated with the second user profile of the computer system.

An example non-transitory computer-readable storage medium stores one or more programs configured to be executed by one or more processors of a computer system that is in communication with a display generation component and a set of one or more input devices, the one or more programs including instructions for: causing display of, via the display generation component, a first candidate user profile that has a predetermined relationship with an active user profile of the computer system; receiving, via the one or more input devices, a first input that corresponds to a selection of the first candidate user profile; and in response to the first input, initiating a process to configure the first candidate user profile as a user profile for the computer system.

Example transitory computer-readable storage media are described herein. An example non-transitory computer-readable storage medium stores one or more programs configured to be executed by one or more processors of a computer system that is in communication with a display generation component and one or more input devices and includes instructions for: receiving, via the one or more input devices, a user input including a request to access a first restricted media item; and in response to receiving the user input: in accordance with a determination that the user input is a voice input and a determination that the voice input corresponds to a stored user profile that is authorized to access the first restricted media item using voice inputs, initiating playback of the first restricted media item; and in accordance with a determination that the user input is a voice input and a determination that the voice input does not correspond to a stored user profile that is authorized to access the first restricted media item using voice inputs: forgoing initiating playback of the first restricted media item; and causing display, at the display generation component, of a validation user interface.

An example transitory computer-readable storage medium stores one or more programs configured to be executed by one or more processors of a computer system that is in communication with a display generation component and a voice input device, the one or more programs including instructions for: while a first user profile is active, receiving, via the voice input device, a voice input; and in response to receiving the voice input: in accordance with a determination that the voice input includes a request to switch user profiles, and a determination that the voice input corresponds to a second user profile, switching from the first user profile to the second user profile; and in accordance with a determination that the voice input includes a request to switch user profiles, and a determination that the voice input does not correspond to a stored user profile: forgoing switching user profiles; and causing display, at the display generation component, of a disambiguation user interface that includes a plurality of candidate user profiles.

An example transitory computer-readable storage medium stores one or more programs configured to be executed by one or more processors of a computer system that is in communication with a display generation component, the one or more programs including instructions for: performing a configuration process for the computer system, wherein the configuration process includes: in accordance with a determination that a set of personalized voice recognition criteria is not met for an active user profile of the computer system, causing display, via the display generation component, of a set of one or more user interfaces including an option that, when selected, initiates a process that enables voice recognition for the active user profile; and in accordance with a determination that the set of personalized voice recognition criteria is met for the active user profile, proceeding with the configuration process without providing the option to enable voice recognition for the active user profile during the configuration process.

An example transitory computer-readable storage medium stores one or more programs configured to be executed by one or more processors of a computer system that is in communication with a display generation component and one or more input devices, the one or more programs including instructions for: while a first user profile of the computer system is an active user profile of the computer system, receiving, via the one or more input devices, a speech input corresponding to a second user profile of the computer system that is an inactive user profile of the computer system; and in response to receiving the speech input, providing a set of suggested media items associated with the second user profile of the computer system.

An example transitory computer-readable storage medium stores one or more programs configured to be executed by one or more processors of a computer system that is in communication with a display generation component and a set of one or more input devices, the one or more programs including instructions for: causing display of, via the display generation component, a first candidate user profile that has a predetermined relationship with an active user profile of the computer system; receiving, via the one or more input devices, a first input that corresponds to a selection of the first candidate user profile; and in response to the first input, initiating a process to configure the first candidate user profile as a user profile for the computer system.

Example computer systems are described herein. An example computer system is configured to communicate with a display generation component and one or more input devices and includes: one or more processors; and memory storing one or more programs configured to be executed by the one or more processors, the one or more programs including instructions for: receiving, via the one or more input devices, a user input including a request to access a first restricted media item; and in response to receiving the user input: in accordance with a determination that the user input is a voice input and a determination that the voice input corresponds to a stored user profile that is authorized to access the first restricted media item using voice inputs, initiating playback of the first restricted media item; and in accordance with a determination that the user input is a voice input and a determination that the voice input does not correspond to a stored user profile that is authorized to access the first restricted media item using voice inputs: forgoing initiating playback of the first restricted media item; and causing display, at the display generation component, of a validation user interface.

An example computer system is configured to communicate with a display generation component and a voice input device and includes one or more processors; and memory storing one or more programs configured to be executed by the one or more processors, the one or more programs including instructions for: while a first user profile is active, receiving, via the voice input device, a voice input; and in response to receiving the voice input: in accordance with a determination that the voice input includes a request to switch user profiles, and a determination that the voice input corresponds to a second user profile, switching from the first user profile to the second user profile; and in accordance with a determination that the voice input includes a request to switch user profiles, and a determination that the voice input does not correspond to a stored user profile: forgoing switching user profiles; and causing display, at the display generation component, of a disambiguation user interface that includes a plurality of candidate user profiles.

An example computer system is configured to communicate with a display generation component and includes: one or more processors; and memory storing one or more programs configured to be executed by the one or more processors, the one or more programs including instructions for: performing a configuration process for the computer system, wherein the configuration process includes: in accordance with a determination that a set of personalized voice recognition criteria is not met for an active user profile of the computer system, causing display, via the display generation component, of a set of one or more user interfaces including an option that, when selected, initiates a process that enables voice recognition for the active user profile; and in accordance with a determination that the set of personalized voice recognition criteria is met for the active user profile, proceeding with the configuration process without providing the option to enable voice recognition for the active user profile during the configuration process.

An example computer system is configured to communicate with a display generation component and one or more input devices and includes: one or more processors; and memory storing one or more programs configured to be executed by the one or more processors, the one or more programs including instructions for: while a first user profile of the computer system is an active user profile of the computer system, receiving, via the one or more input devices, a speech input corresponding to a second user profile of the computer system that is an inactive user profile of the computer system; and in response to receiving the speech input, providing a set of suggested media items associated with the second user profile of the computer system.

An example computer system is configured to communicate with a display generation component and a set of one or more input devices and includes: one or more processors; and memory storing one or more programs configured to be executed by the one or more processors, the one or more programs including instructions for: causing display of, via the display generation component, a first candidate user profile that has a predetermined relationship with an active user profile of the computer system; receiving, via the one or more input devices, a first input that corresponds to a selection of the first candidate user profile; and in response to the first input, initiating a process to configure the first candidate user profile as a user profile for the computer system.

An example computer system is configured to communicate with a display generation component and one or more input devices and includes means for receiving, via the one or more input devices, a user input including a request to access a first restricted media item; and means for, in response to receiving the user input: in accordance with a determination that the user input is a voice input and a determination that the voice input corresponds to a stored user profile that is authorized to access the first restricted media item using voice inputs, initiating playback of the first restricted media item; and in accordance with a determination that the user input is a voice input and a determination that the voice input does not correspond to a stored user profile that is authorized to access the first restricted media item using voice inputs: forgoing initiating playback of the first restricted media item; and causing display, at the display generation component, of a validation user interface.

An example computer system is configured to communicate with a display generation component and a voice input device and includes means for, while a first user profile is active, receiving, via the voice input device, a voice input; and means for, in response to receiving the voice input: in accordance with a determination that the voice input includes a request to switch user profiles, and a determination that the voice input corresponds to a second user profile, switching from the first user profile to the second user profile; and in accordance with a determination that the voice input includes a request to switch user profiles, and a determination that the voice input does not correspond to a stored user profile: forgoing switching user profiles; and causing display, at the display generation component, of a disambiguation user interface that includes a plurality of candidate user profiles.

An example computer system is configured to communicate with a display generation component and includes means for performing a configuration process for the computer system, wherein the configuration process includes: in accordance with a determination that a set of personalized voice recognition criteria is not met for an active user profile of the computer system, causing display, via the display generation component, of a set of one or more user interfaces including an option that, when selected, initiates a process that enables voice recognition for the active user profile; and in accordance with a determination that the set of personalized voice recognition criteria is met for the active user profile, proceeding with the configuration process without providing the option to enable voice recognition for the active user profile during the configuration process.

An example computer system is configured to communicate with a display generation component and one or more input devices and includes means for, while a first user profile of the computer system is an active user profile of the computer system, receiving, via the one or more input devices, a speech input corresponding to a second user profile of the computer system that is an inactive user profile of the computer system; and means for, in response to receiving the speech input, providing a set of suggested media items associated with the second user profile of the computer system.

An example computer system is configured to communicate with a display generation component and a set of one or more input devices and includes means for causing display of, via the display generation component, a first candidate user profile that has a predetermined relationship with an active user profile of the computer system; means for receiving, via the one or more input devices, a first input that corresponds to a selection of the first candidate user profile; and means for, in response to the first input, initiating a process to configure the first candidate user profile as a user profile for the computer system.

Example computer program products are described herein. An example computer program product includes one or more programs configured to be executed by one or more processors of a computer system that is in communication with a display generation component and one or more input devices, the one or more programs including instructions for: receiving, via the one or more input devices, a user input including a request to access a first restricted media item; and in response to receiving the user input: in accordance with a determination that the user input is a voice input and a determination that the voice input corresponds to a stored user profile that is authorized to access the first restricted media item using voice inputs, initiating playback of the first restricted media item; and in accordance with a determination that the user input is a voice input and a determination that the voice input does not correspond to a stored user profile that is authorized to access the first restricted media item using voice inputs: forgoing initiating playback of the first restricted media item; and causing display, at the display generation component, of a validation user interface.

An example computer program product includes one or more programs configured to be executed by one or more processors of a computer system that is in communication with a display generation component and a voice input device, the one or more programs including instructions for: while a first user profile is active, receiving, via the voice input device, a voice input; and in response to receiving the voice input: in accordance with a determination that the voice input includes a request to switch user profiles, and a determination that the voice input corresponds to a second user profile, switching from the first user profile to the second user profile; and in accordance with a determination that the voice input includes a request to switch user profiles, and a determination that the voice input does not correspond to a stored user profile: forgoing switching user profiles; and causing display, at the display generation component, of a disambiguation user interface that includes a plurality of candidate user profiles.

An example computer program product includes one or more programs configured to be executed by one or more processors of a computer system that is in communication with a display generation component, the one or more programs including instructions for: performing a configuration process for the computer system, wherein the configuration process includes: in accordance with a determination that a set of personalized voice recognition criteria is not met for an active user profile of the computer system, causing display, via the display generation component, of a set of one or more user interfaces including an option that, when selected, initiates a process that enables voice recognition for the active user profile; and in accordance with a determination that the set of personalized voice recognition criteria is met for the active user profile, proceeding with the configuration process without providing the option to enable voice recognition for the active user profile during the configuration process.

An example computer program product includes one or more programs configured to be executed by one or more processors of a computer system that is in communication with a display generation component and one or more input devices, the one or more programs including instructions for: while a first user profile of the computer system is an active user profile of the computer system, receiving, via the one or more input devices, a speech input corresponding to a second user profile of the computer system that is an inactive user profile of the computer system; and in response to receiving the speech input, providing a set of suggested media items associated with the second user profile of the computer system.

An example computer program product includes one or more programs configured to be executed by one or more processors of a computer system that is in communication with a display generation component and a set of one or more input devices, the one or more programs including instructions for:

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing user profiles, thereby increasing the effectiveness, efficiency, and user satisfaction with such devices. Such methods and interfaces may complement or replace other methods for managing user profiles.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6M illustrate exemplary user interfaces for providing media content in accordance with some embodiments.

FIG. 7 is a flowchart of a process for providing media content in accordance with some embodiments.

FIGS. 8A-8E illustrate exemplary user interfaces for switching user profiles in accordance with some embodiments.

FIG. 9 is a flowchart of a process for switching user profiles in accordance with some embodiments.

FIGS. 10A-10M illustrate exemplary user interfaces for performing a configuration process in accordance with some embodiments.

FIG. 11 is a flowchart of a process for performing a configuration process in accordance with some embodiments.

FIGS. 12A-12G illustrate exemplary user interfaces for providing suggested content in accordance with some embodiments.

FIG. 13 is a flowchart of a process for providing suggested content in accordance with some embodiments.

FIGS. 14A-14E illustrate exemplary user interfaces for configuring user profiles in accordance with some embodiments.

FIG. 15 is a flowchart of a process for configuring user profiles in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for computer systems (e.g., electronic devices) that provide efficient methods and interfaces for managing user profiles. For example, computer systems, such as those described herein may provide a manner in which users may initiate playback of media items and/or switch profiles using voice inputs. Such techniques can reduce the cognitive burden on a user who requests access to media content and/or a user profile, thereby enhancing productivity. Further, such techniques can reduce processor and battery power otherwise wasted on redundant user inputs.

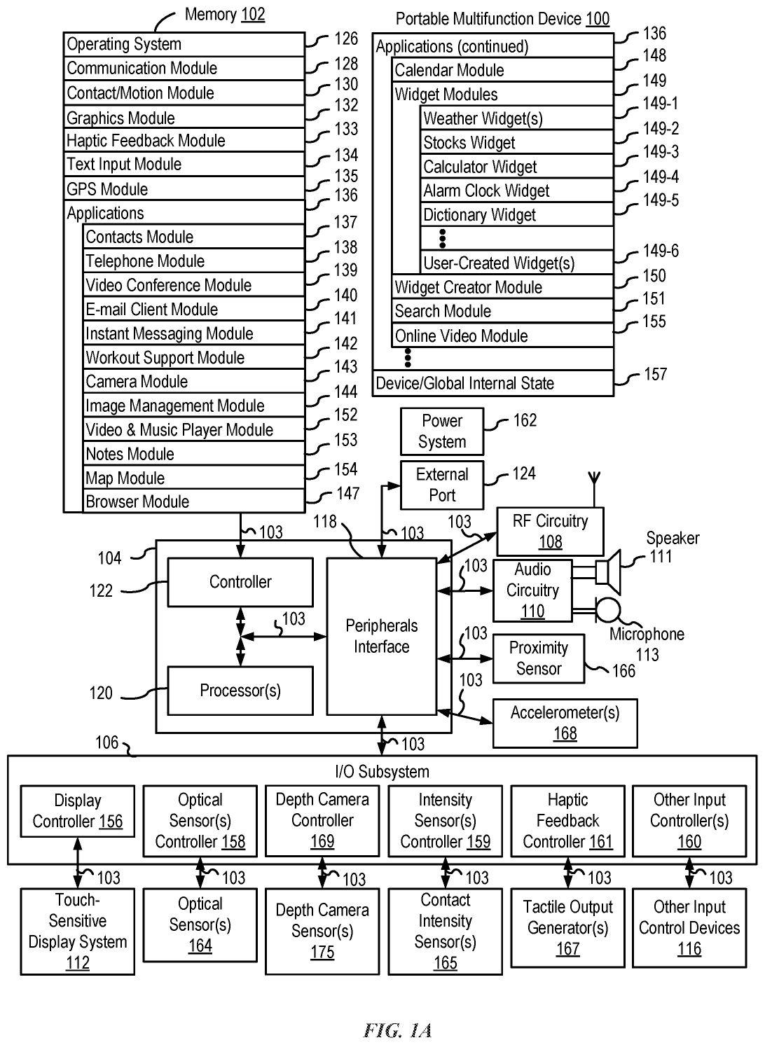

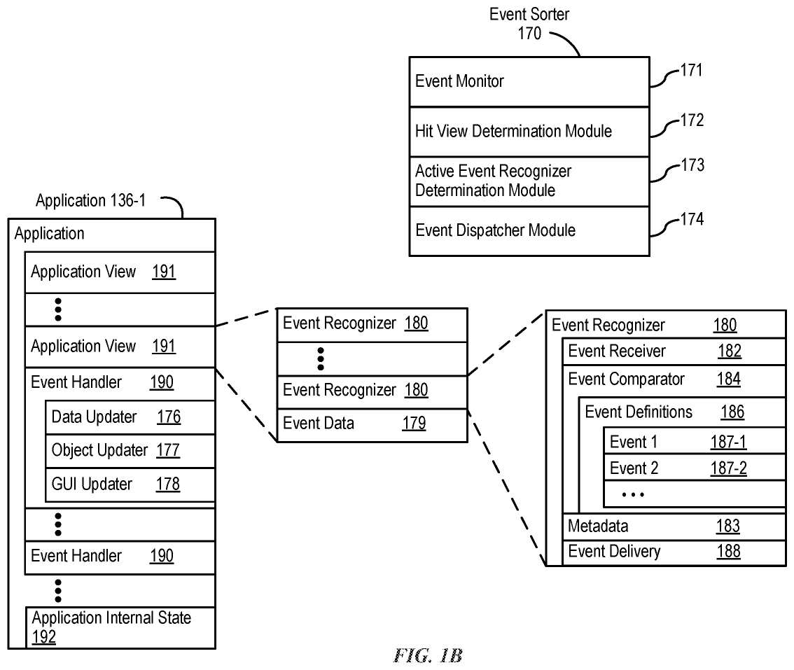

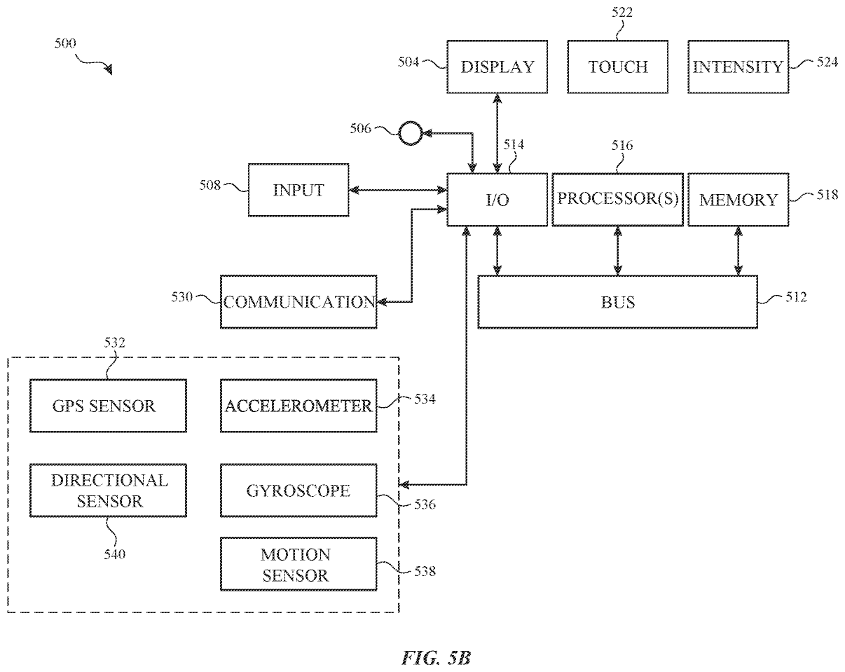

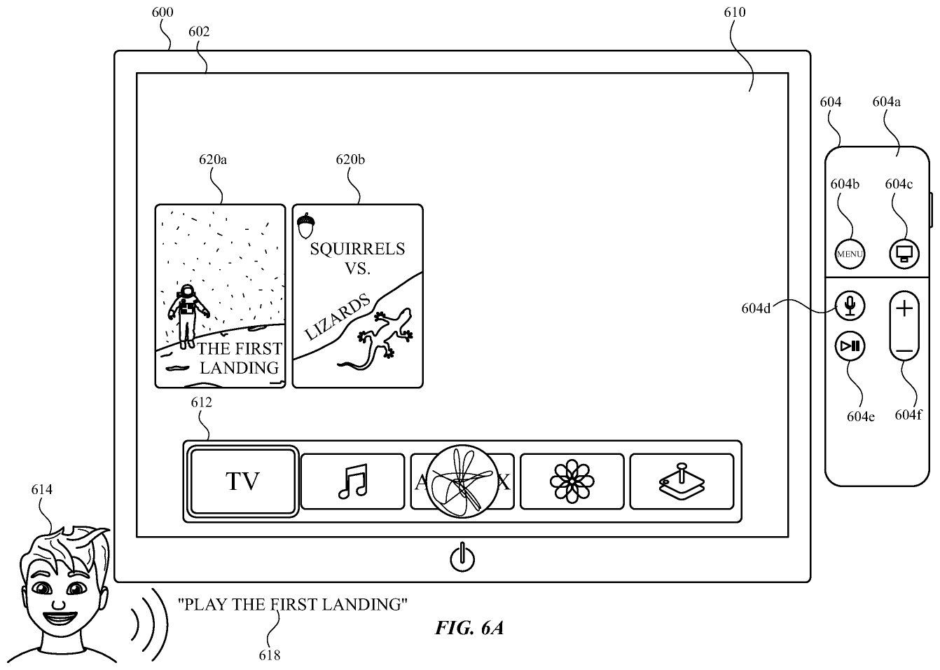

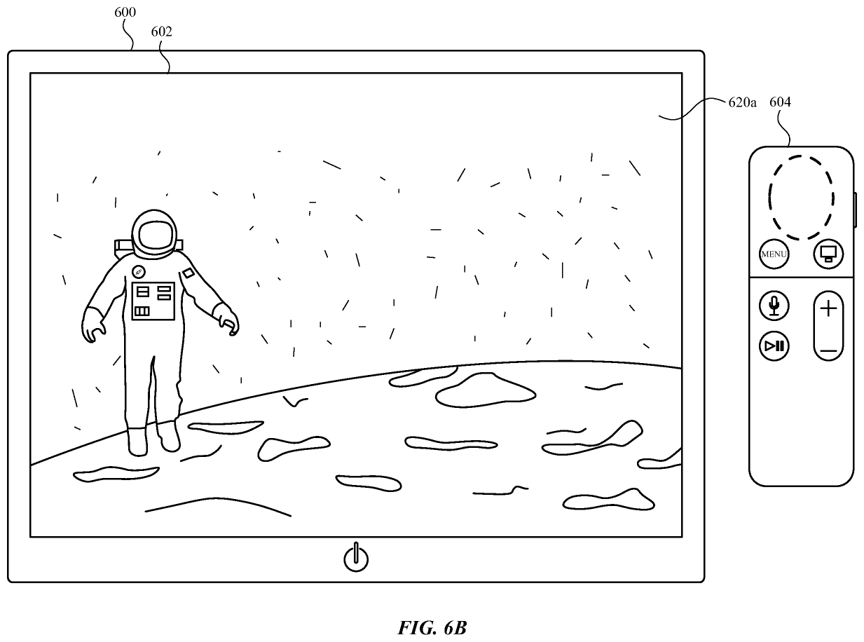

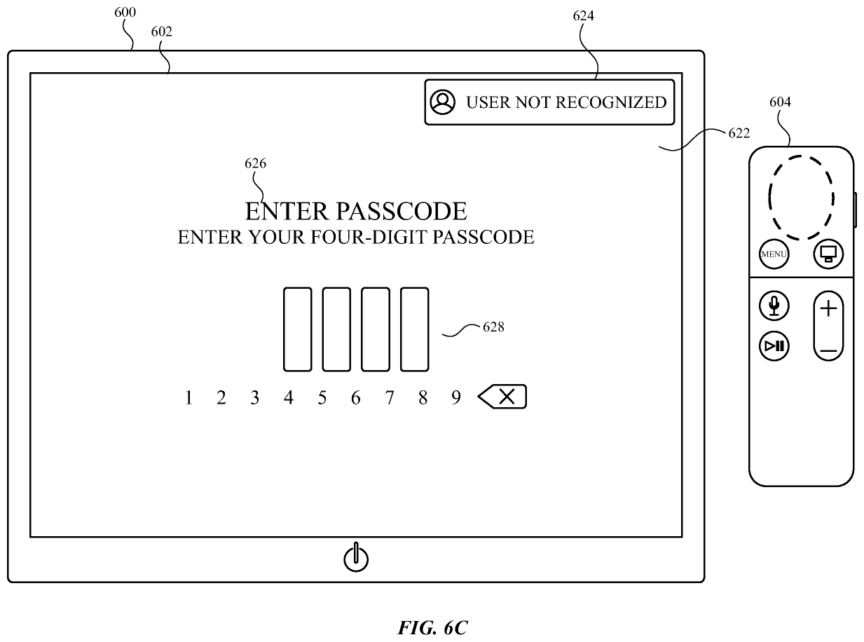

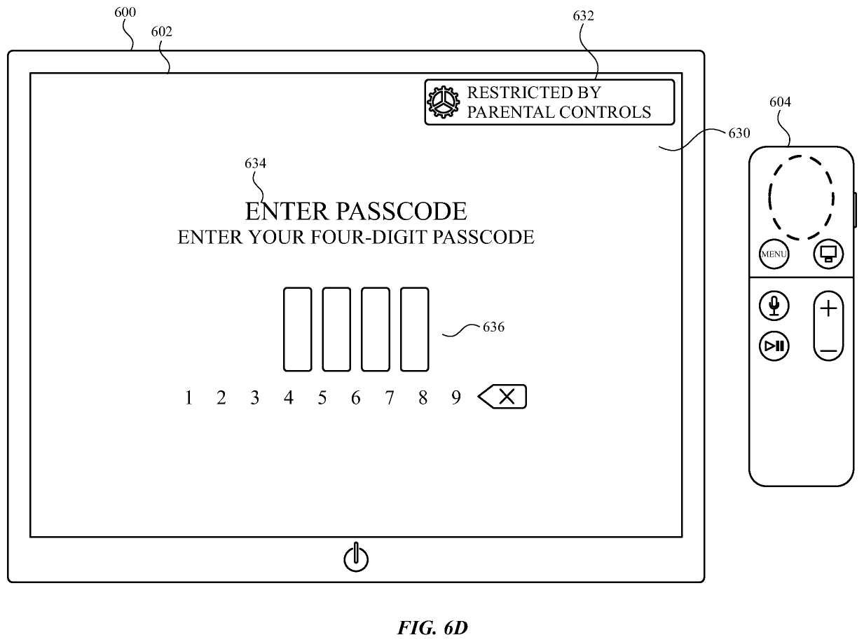

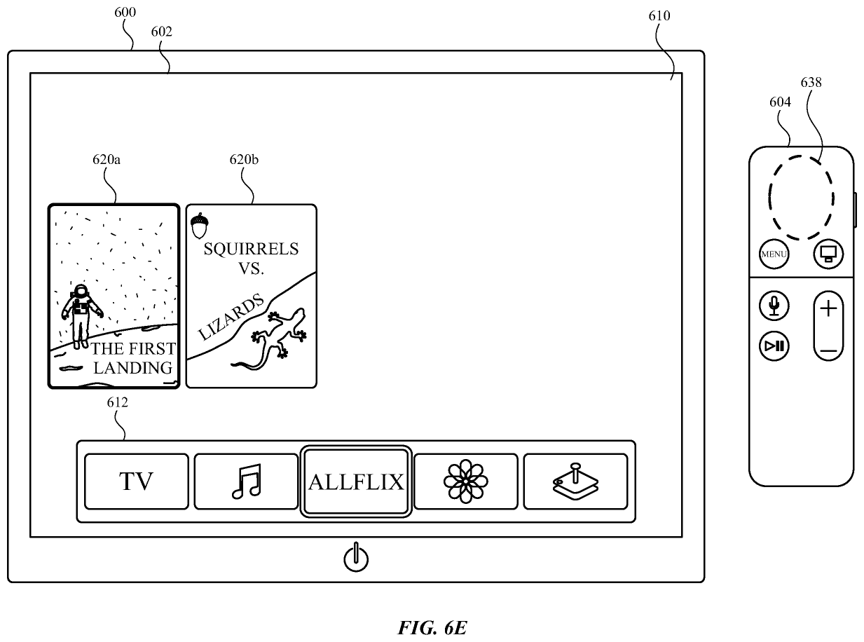

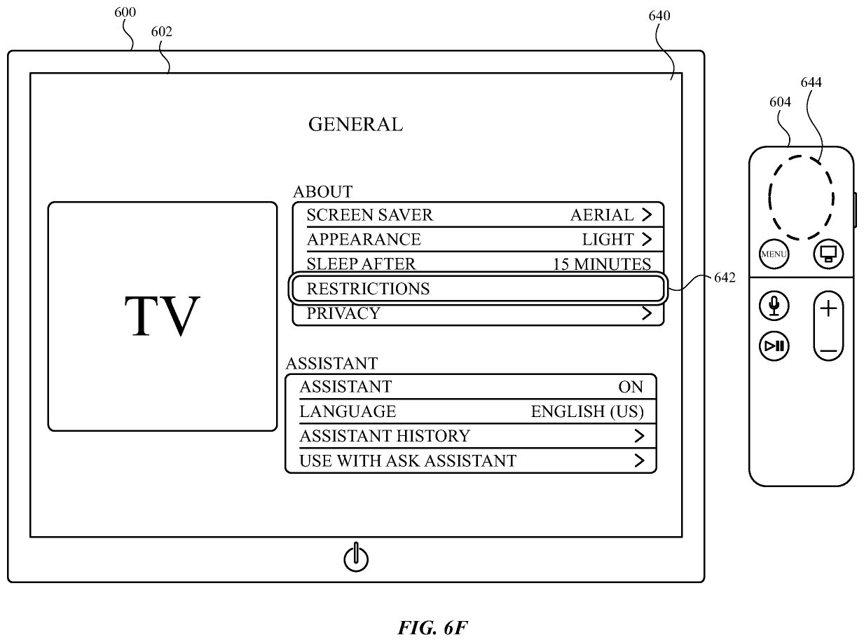

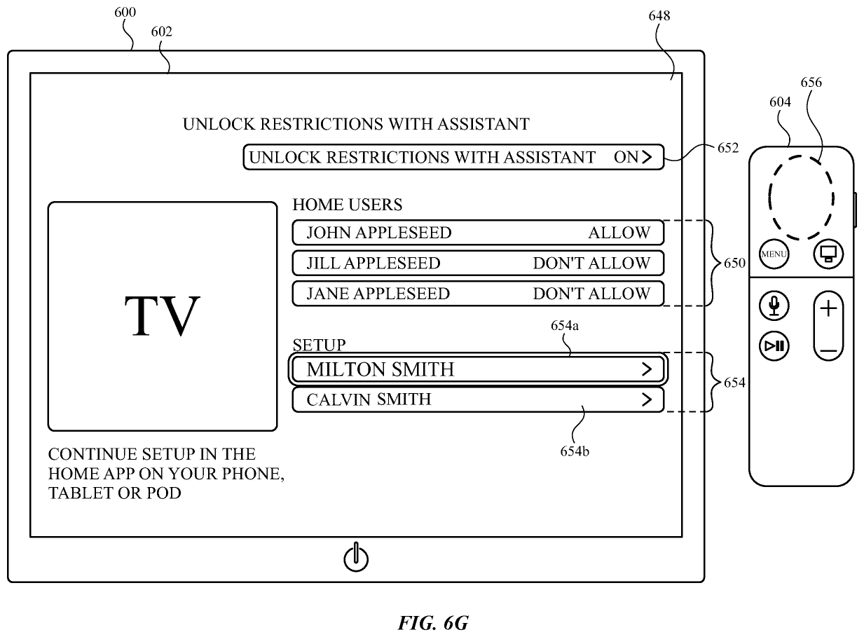

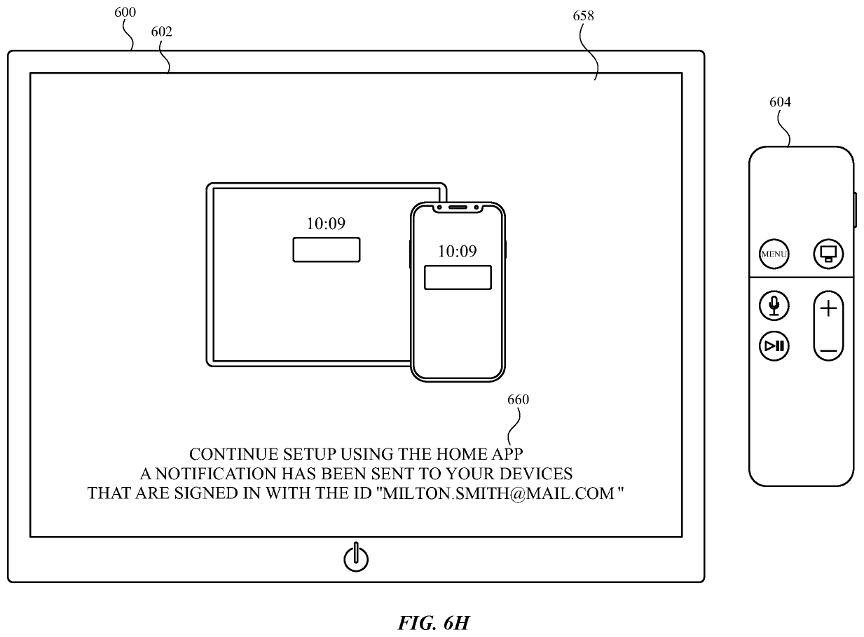

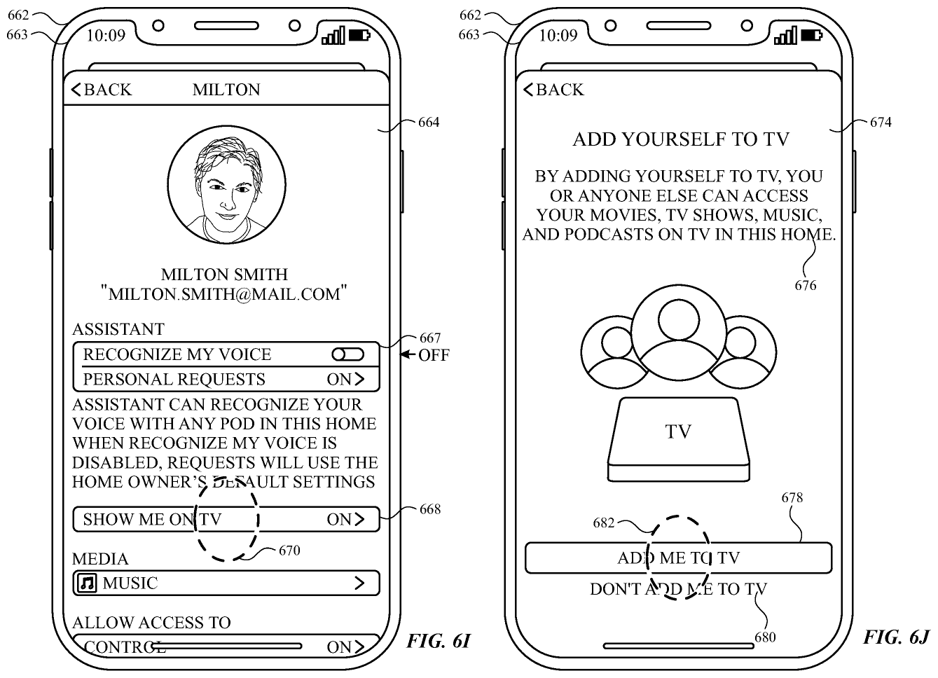

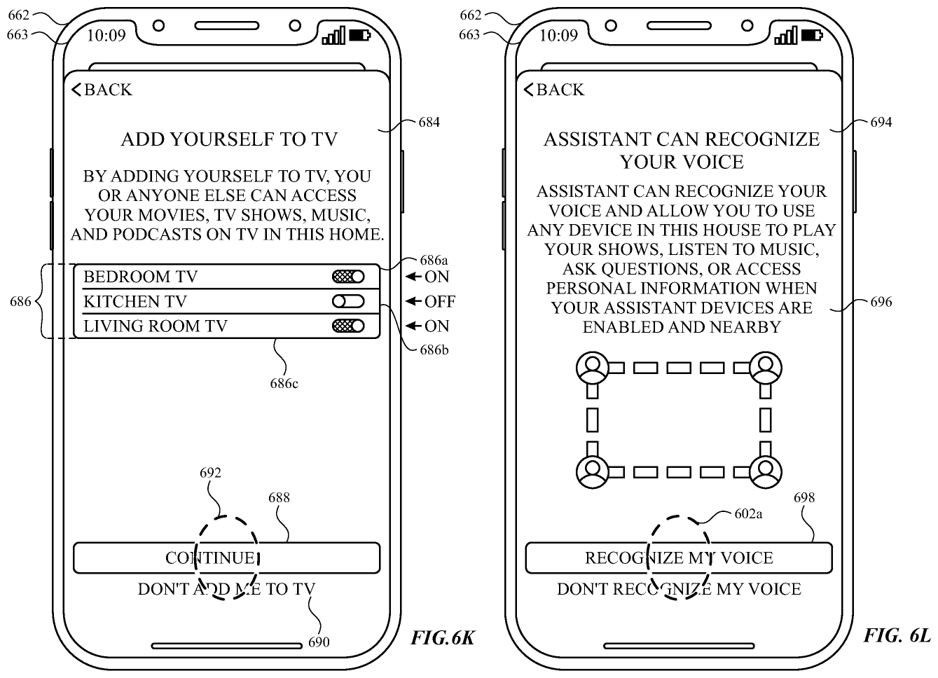

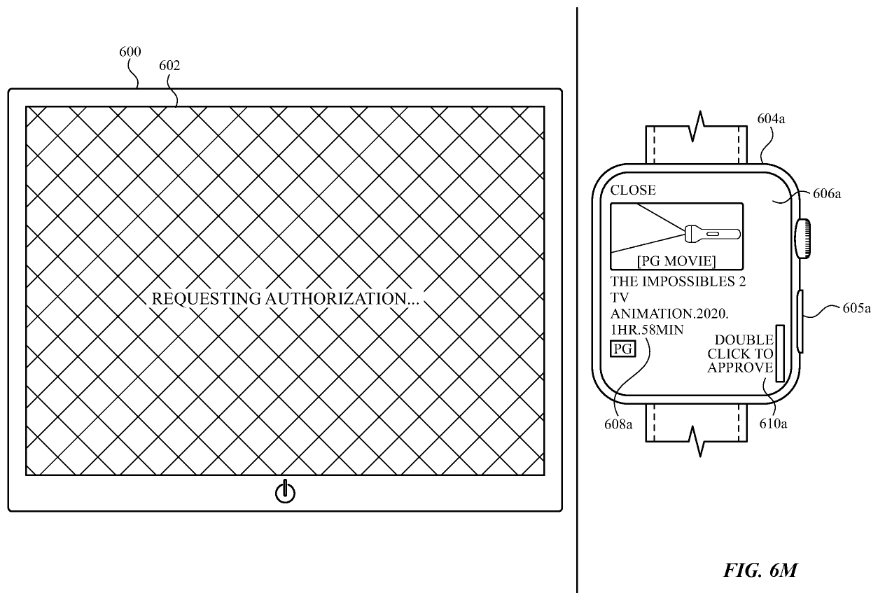

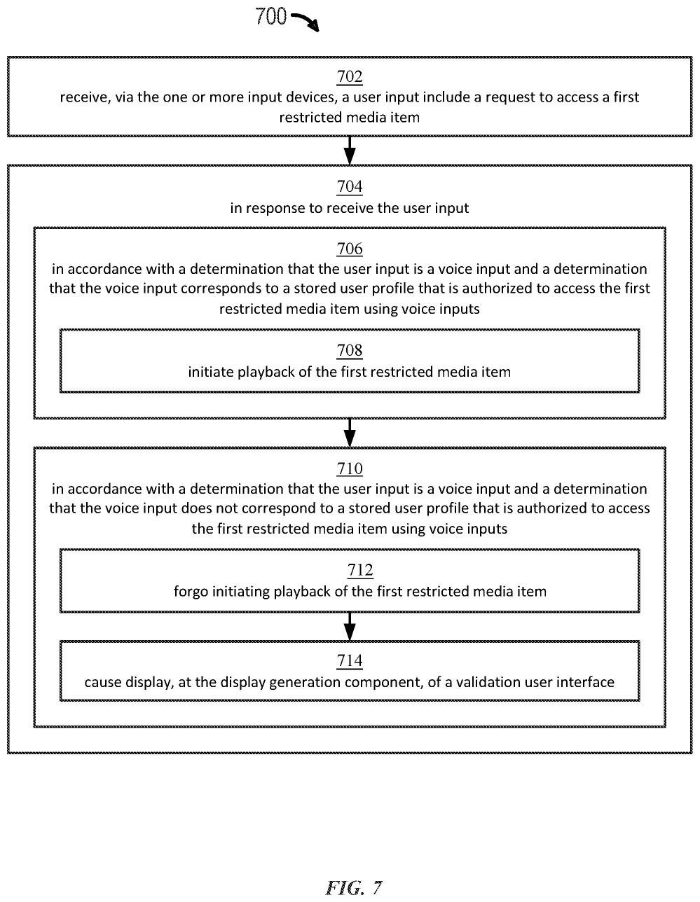

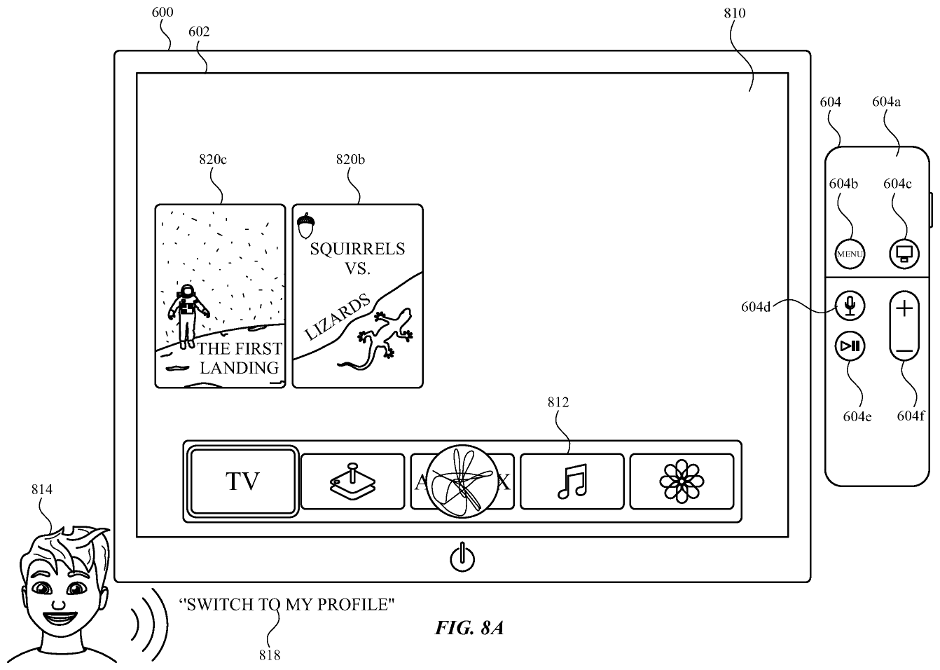

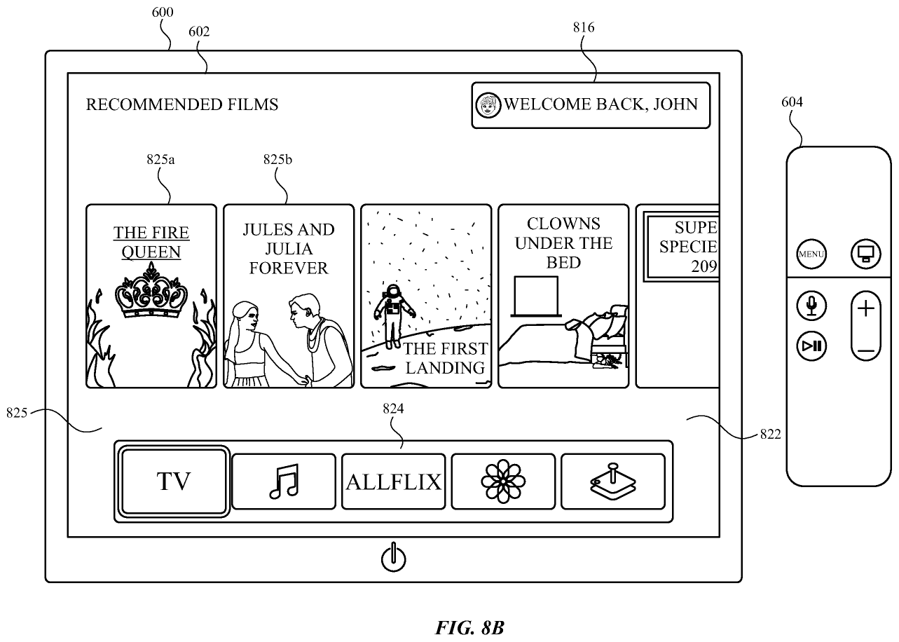

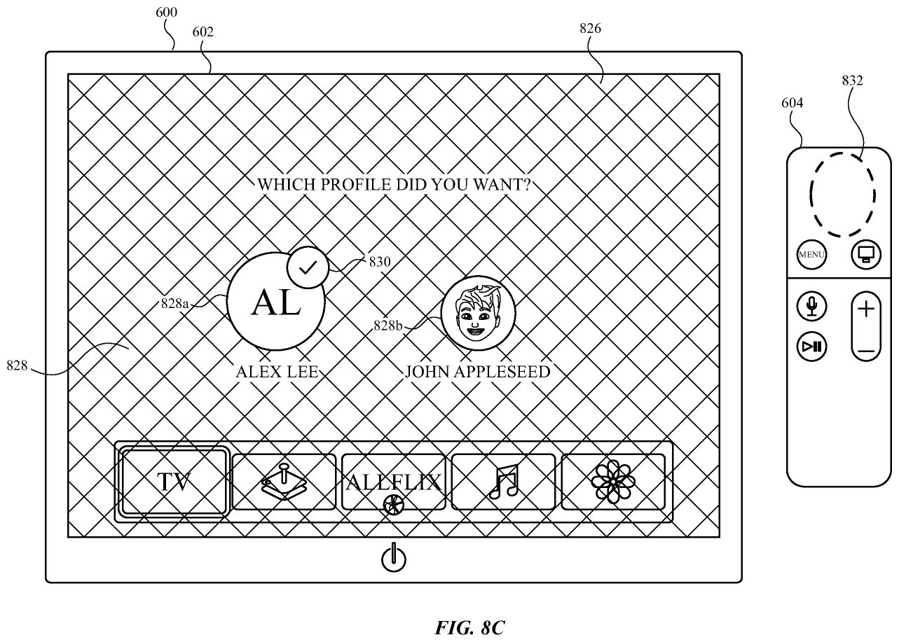

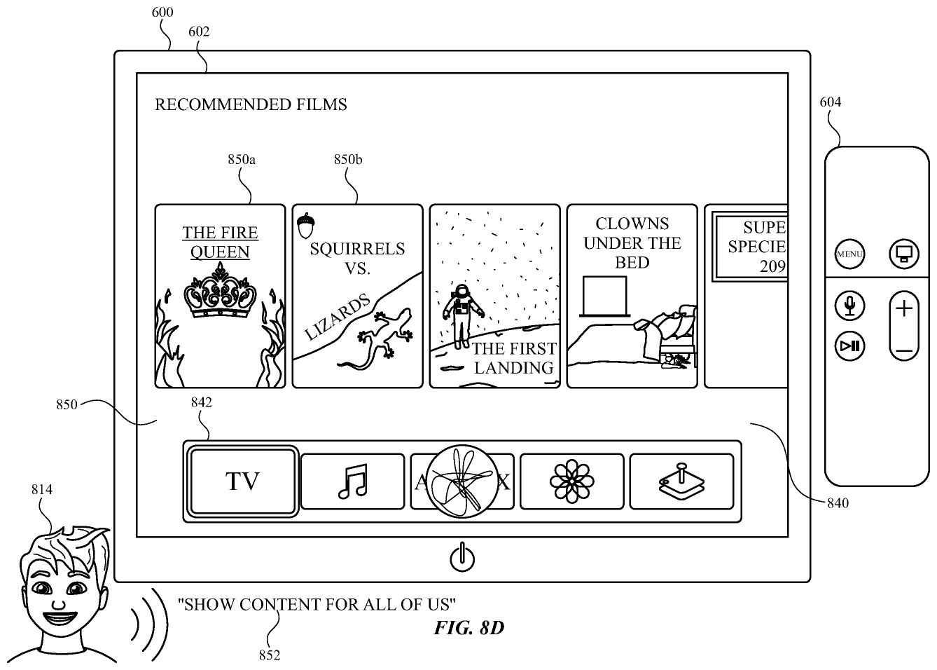

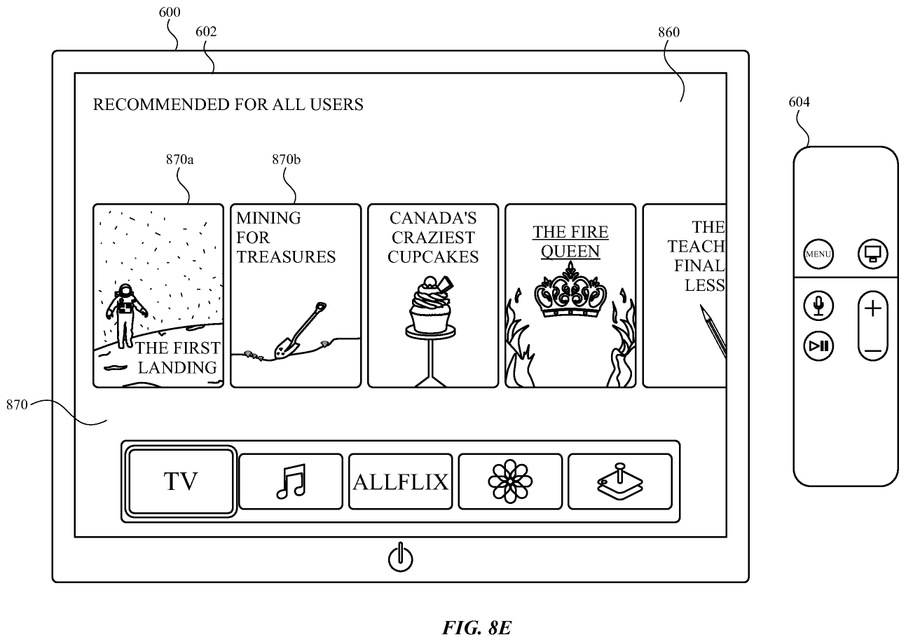

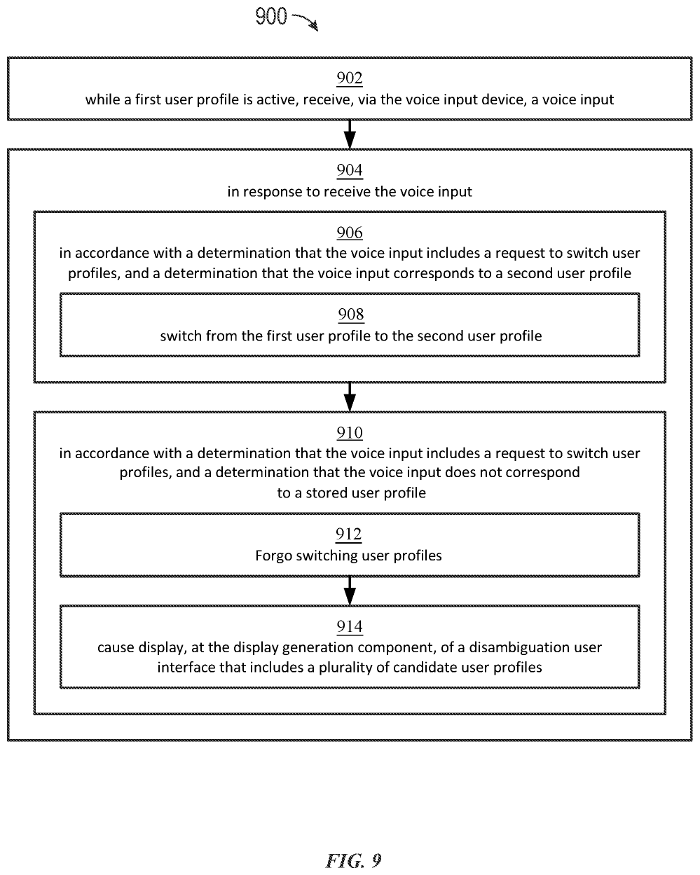

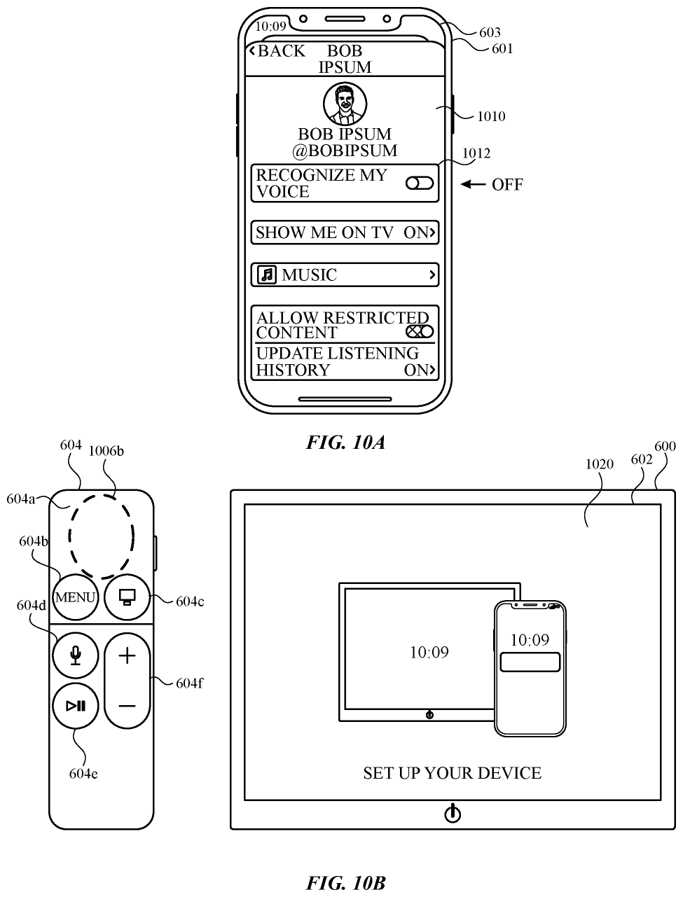

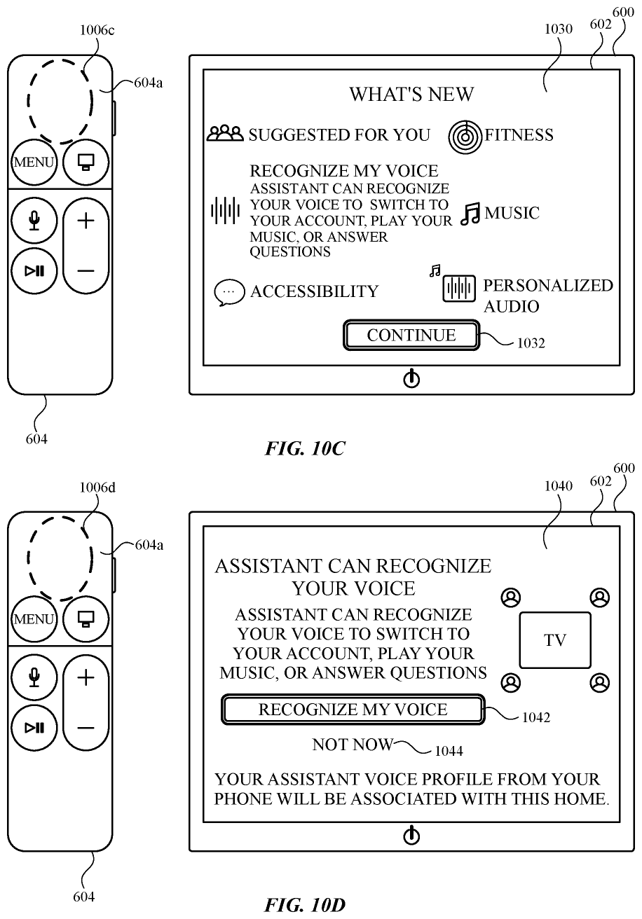

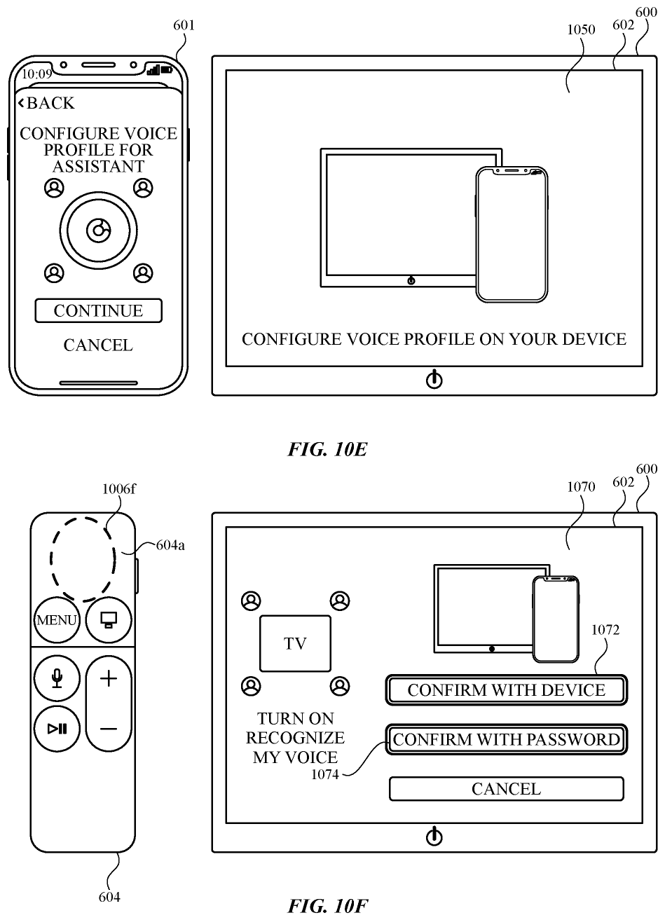

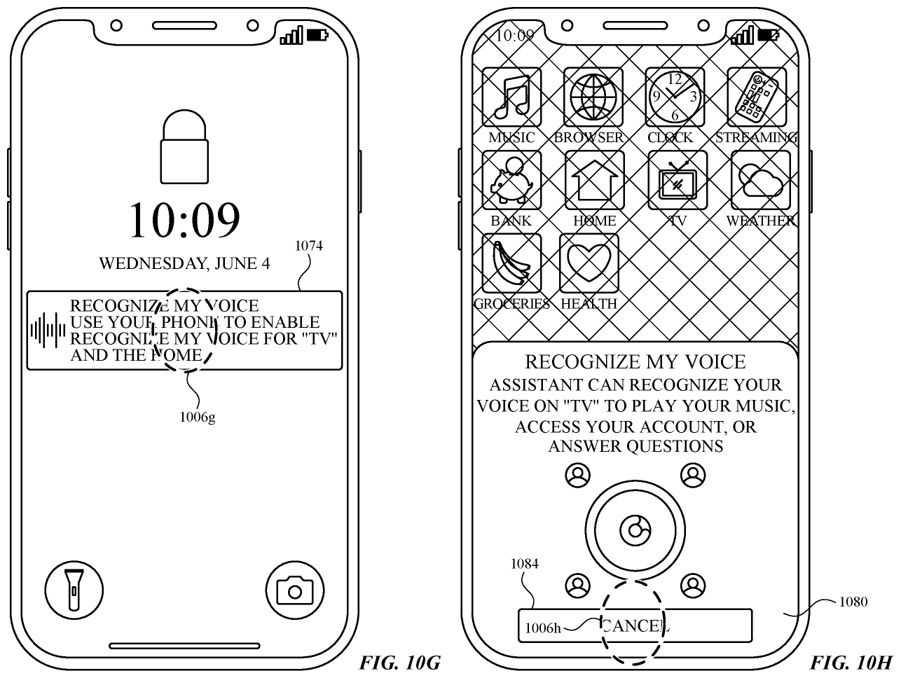

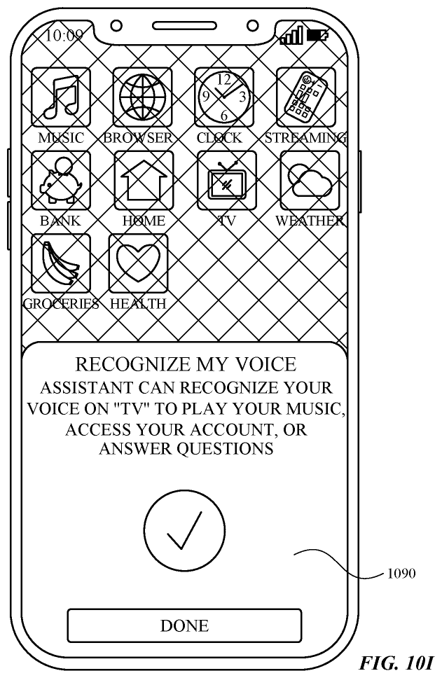

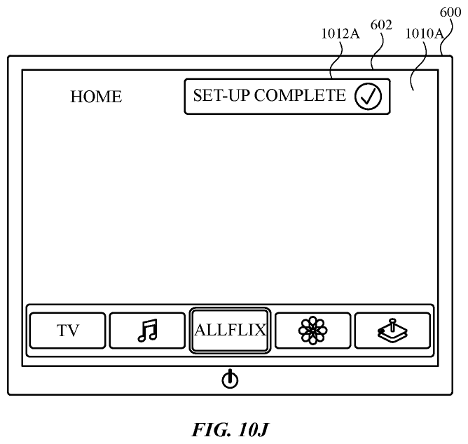

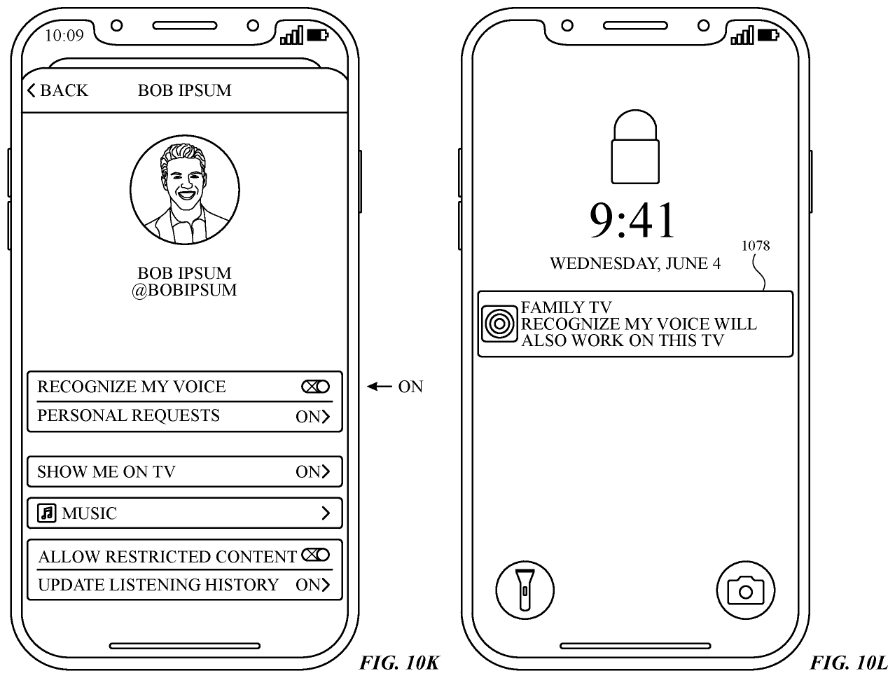

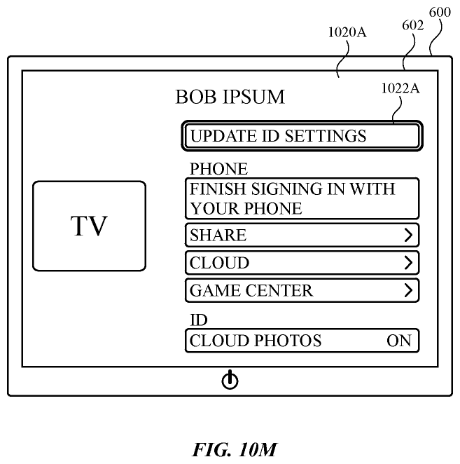

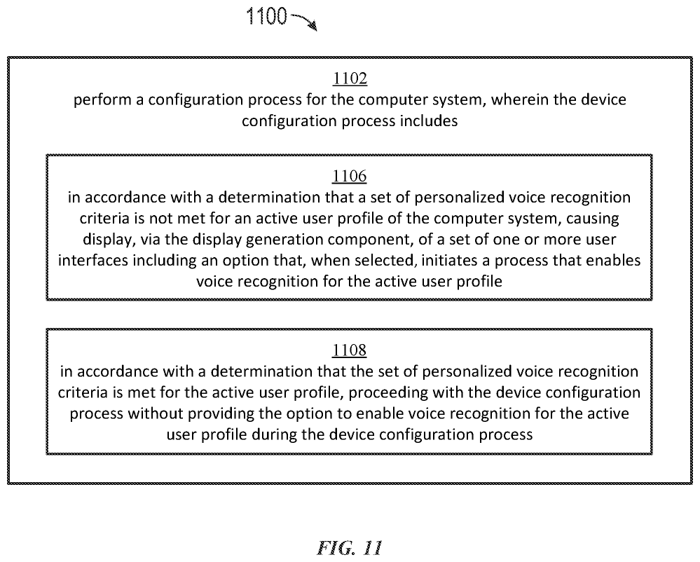

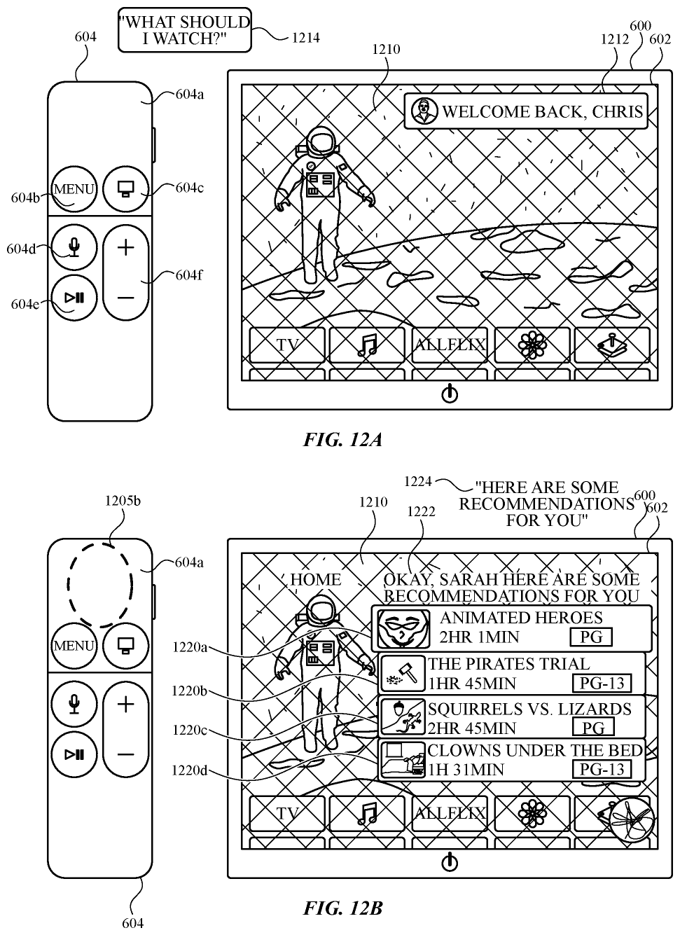

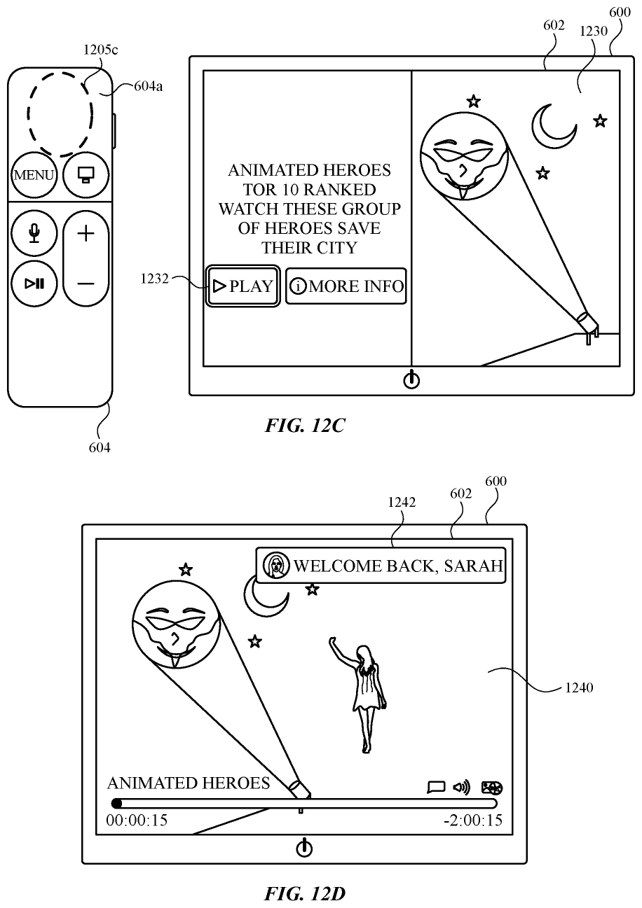

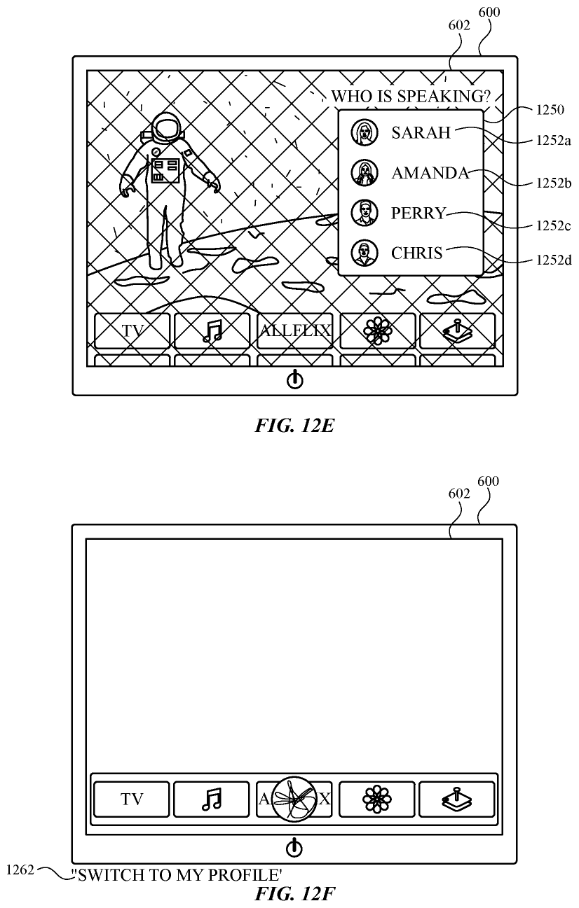

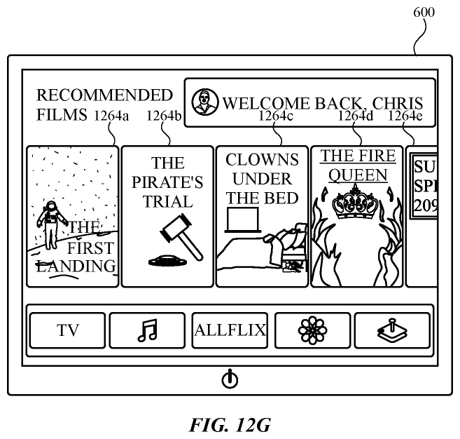

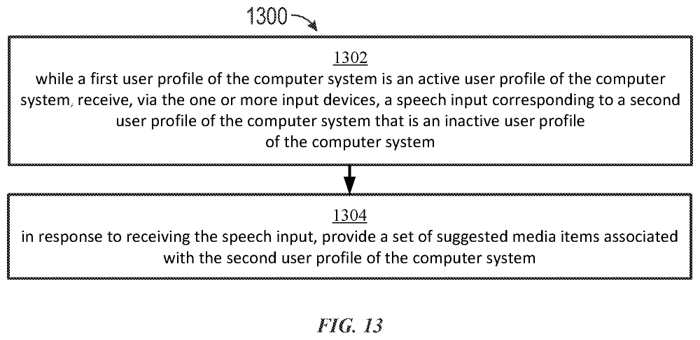

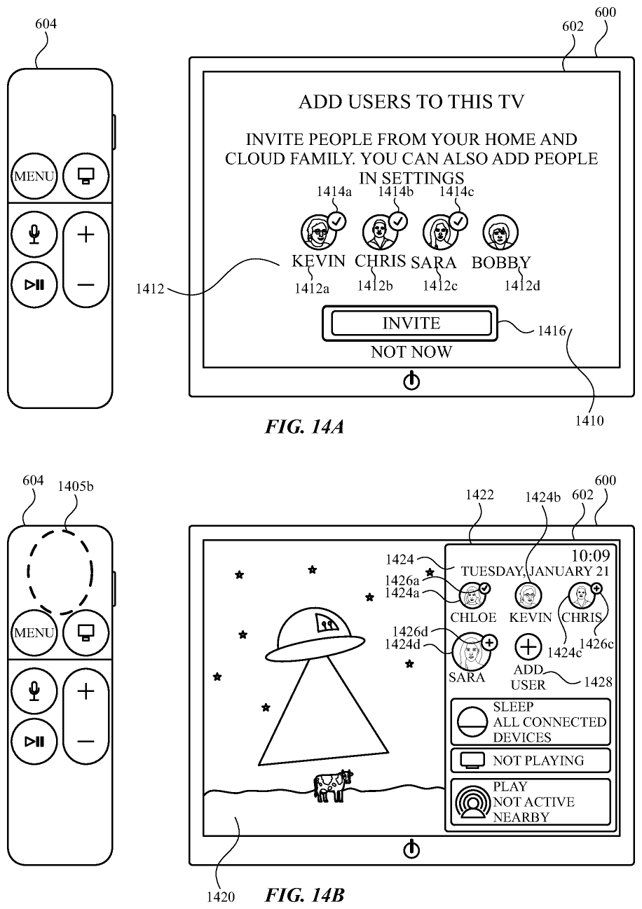

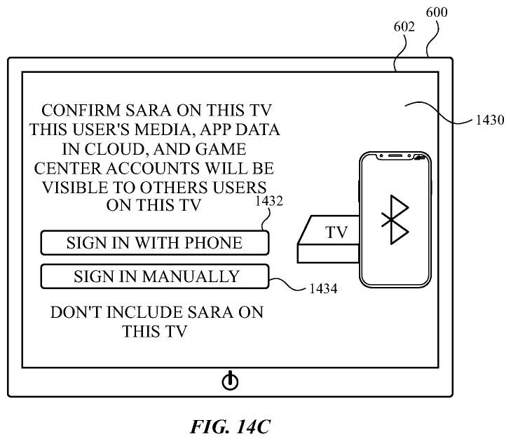

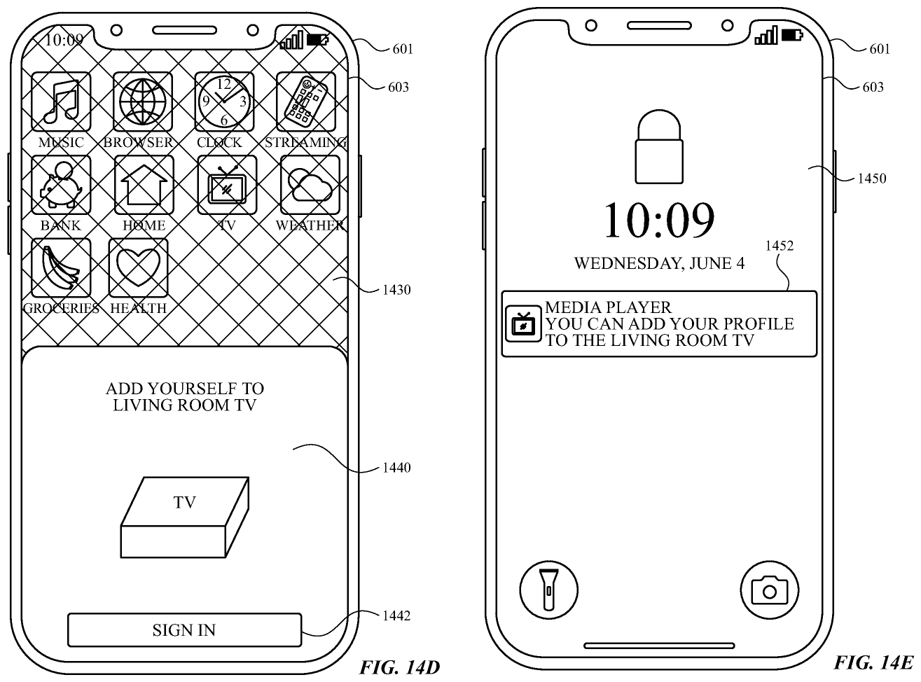

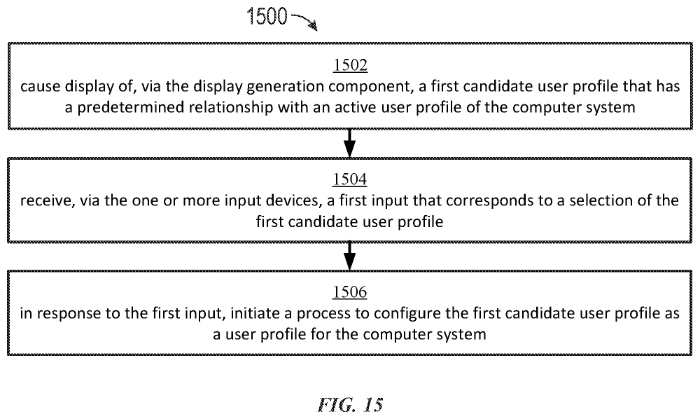

Below, FIGS. 1A-1B, 2, 3, 4A-4B, and 5A-5B provide a description of exemplary devices for performing the techniques for managing event notifications. FIGS. 6A-6M illustrate exemplary user interfaces for providing media content. FIG. 7 is a flow diagram illustrating methods of providing media content in accordance with some embodiments. The user interfaces in FIGS. 6A-6M are used to illustrate the processes described below, including the processes in FIG. 7. FIGS. 8A-8E illustrate exemplary user interfaces for switching user profiles. FIG. 9 is a flow diagram illustrating methods of switching user profiles in accordance with some embodiments. The user interfaces in FIGS. 8A-8E are used to illustrate the processes described below, including the processes in FIG. 9. FIGS. 10A-10M illustrate exemplary user interfaces for performing a configuration process. FIG. 11 is a flow diagram illustrating methods of performing a configuration process in accordance with some embodiments. The user interfaces in FIGS. 10A-10M are used to illustrate the processes described below, including the processes in FIG. 11. FIGS. 12A-12G illustrate exemplary user interfaces for providing suggested content. FIG. 13 is a flow diagram illustrating methods of providing suggested content in accordance with some embodiments. The user interfaces in FIGS. 12A-12G are used to illustrate the processes described below, including the processes in FIG. 13. FIGS. 14A-14E illustrate exemplary user interfaces for configuring user profiles. FIG. 15 is a flow diagram illustrating methods of configuring user profiles in accordance with some embodiments. The user interfaces in FIGS. 14A-14E are used to illustrate the processes described below, including the processes in FIG. 15.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

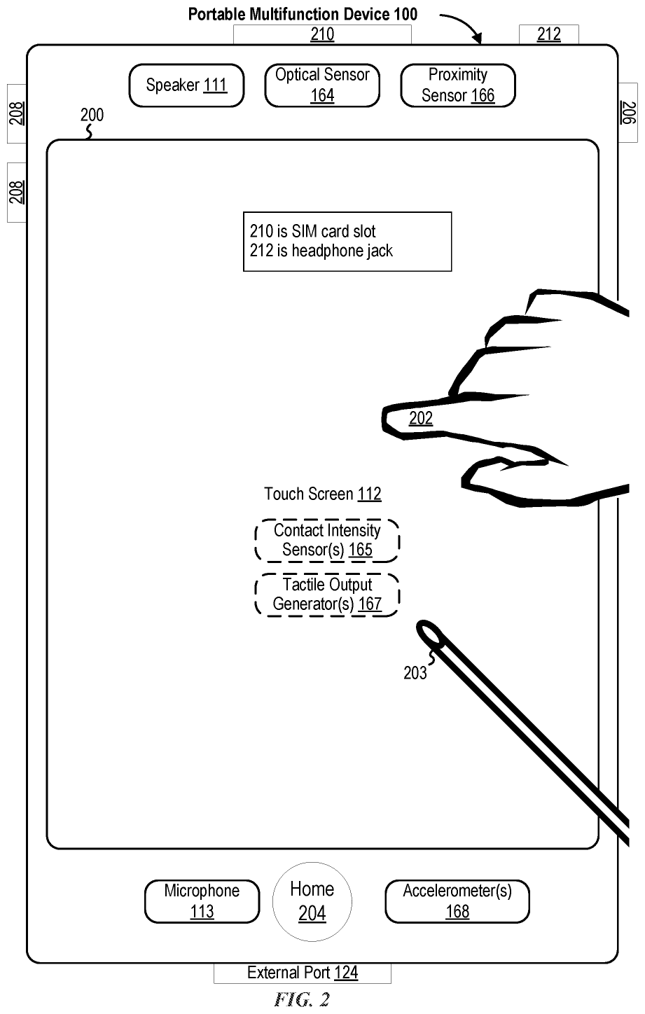

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

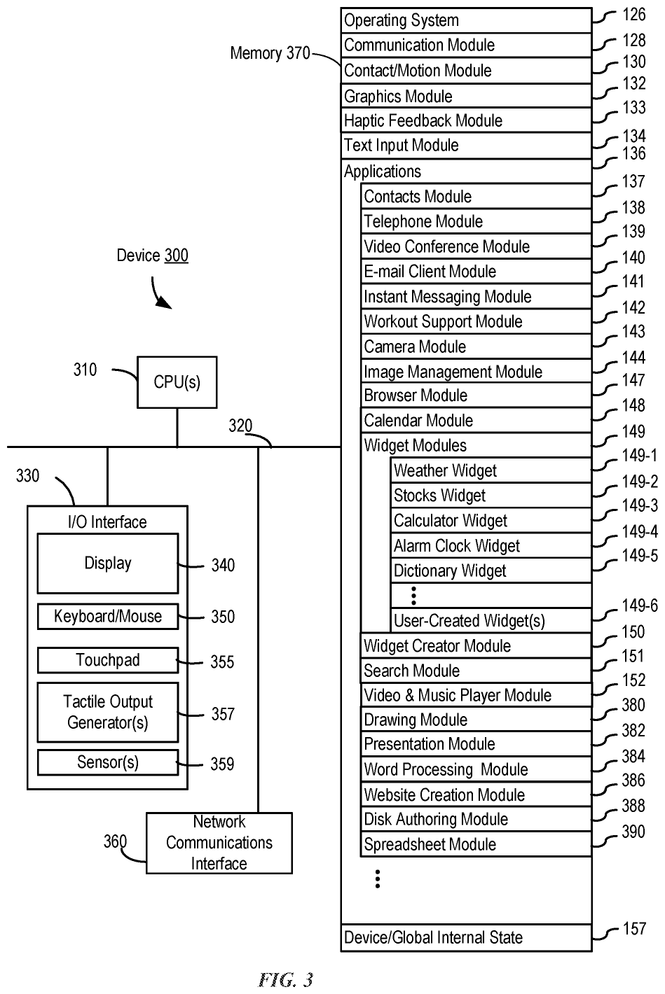

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

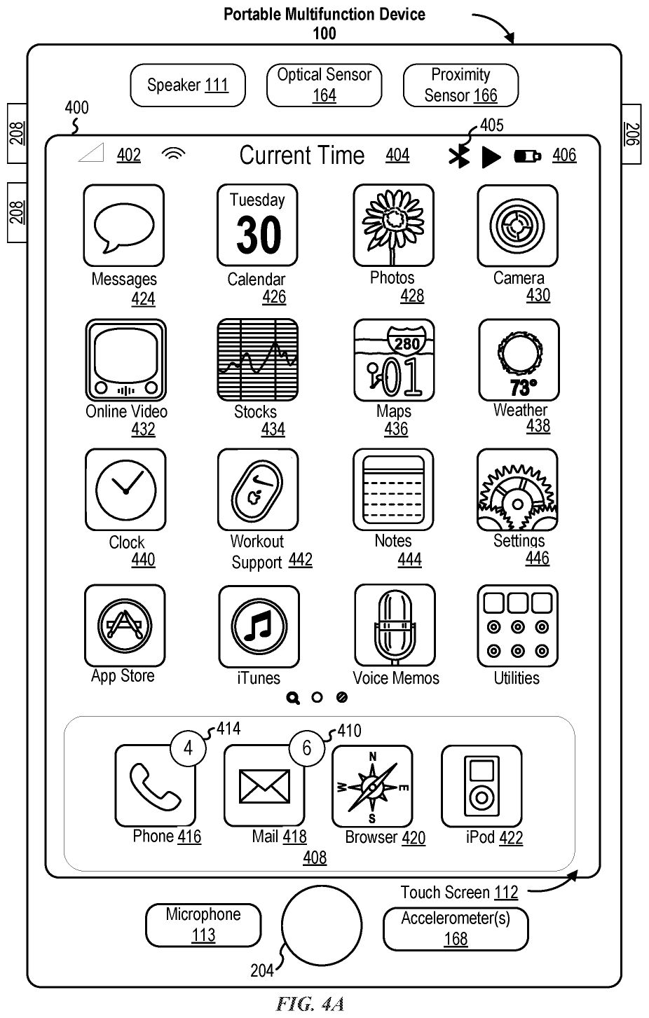

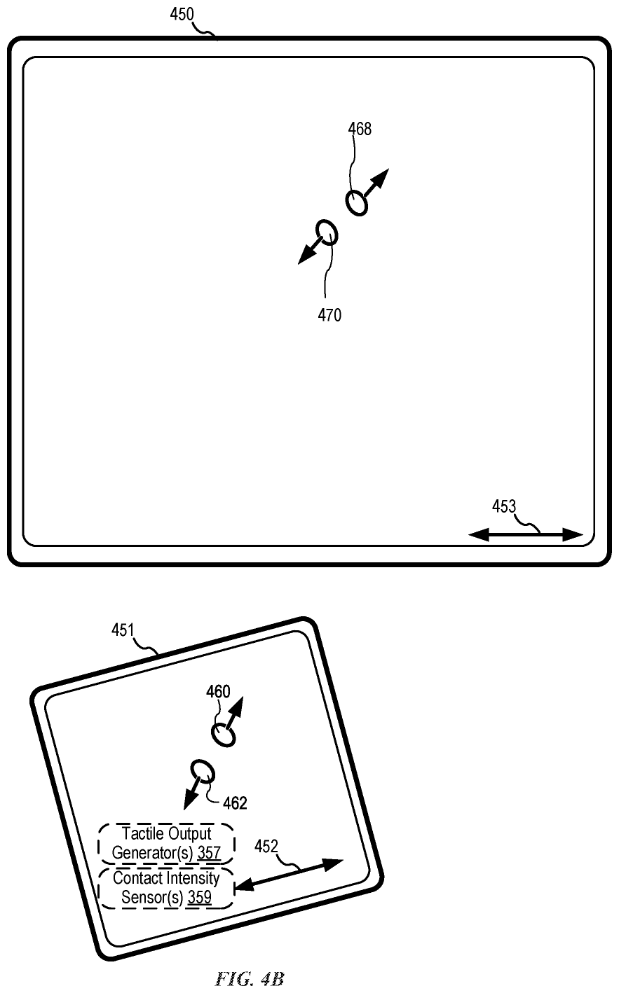

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

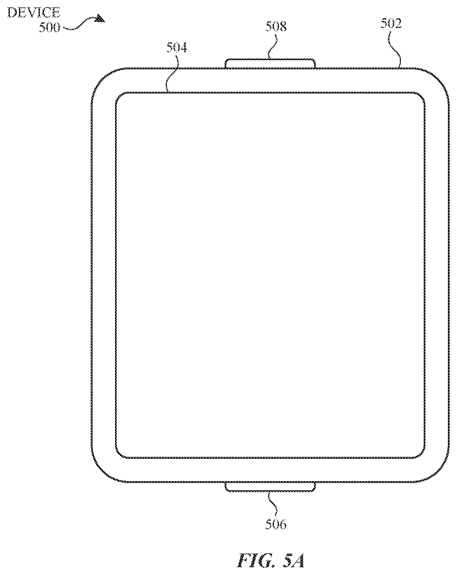

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 (FIG. 7), 900 (FIG. 9), 1100 (FIG. 11), 1300 (FIG. 13), and 1500 (FIG. 15). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6M illustrate exemplary devices and user interfaces for providing media content, in accordance with some embodiments. The user interfaces in these figures are used to illustrate the processes described below, including the processes in FIG. 7.

In the examples described in FIGS. 6A-6M, a device 600 (e.g., a device having one or more features of device 100, 300, and/or 500) causes display, on display 602, of the user interfaces described below. In some embodiments, display 602 is an integrated part of device 600. In some embodiments, device 600 is a separate digital media player (e.g., set top box) that is in communication (e.g., wireless, wired) with display 602.

In some embodiments, device 600 is connected to a remote control 604, which is configured to transmit data (e.g., via RF communication, via Bluetooth, via infrared) to device 600 based on user input (e.g., voice input, tactile input) detected at remote control 604. Remote control 604 includes a selection region 604a, which includes a touch-sensitive surface for detecting tap, press, and swipe gestures, a menu button 604b, a television button 604c, a microphone button 604d, a play/pause button 604e, and volume control buttons 604f.

At FIG. 6A, device 600 (e.g., a smart television) is causing display, on display 602 (e.g., the integrated screen of device 600), of home interface 610. In some embodiments, device 600 is a digital media player in communication with (e.g., connected to) display 602 (e.g., a television). Home interface 610 includes applications 612. In some embodiments, applications 612 include one or more one or more applications that may be used on device 600 to provide content (e.g., media items). Home interface 610 further includes media items 620a, 620b. In some embodiments, one or more of media items 620 are recommended media items or media items selected by device 600 based on user preferences and/or previous user behavior.

While device 600 causes display of home interface 610, device 600 receives, from user 614, user input 618 (“Play The First Landing”) requesting device 600 to initiate playback of restricted media item 620a “The First Landing”. In response to the user input, device 600 determines whether user input 618 is a voice input. If user input 618 is a voice input, device 600 determines whether voice input 618 matches a user profile of device 600 (e.g., a user profile stored on device 600), and if so, whether the user profile is authorized to access requested media item 620a. In some embodiments, determining whether voice input 618 matches a user profile of device 600 includes determining whether voice input 618 matches a voice profile of a user profile of device 600. The voice profile includes one or more voice models which can be used to detect (e.g., identify) a voice of a user associated with the voice profile.

As shown in FIG. 6B, if device 600 determines that voice input 618 matches a user profile authorized to access requested media item 620a, device 600 initiates playback of media item 620a.

If device 600 determines that voice input 618 does not match a user profile, device 600 causes display 602 to display (e.g., replace display of home interface 610 with) passcode interface 622, as shown in FIG. 6C. Passcode interface 622 includes notifications, 624, 626, and field 628. Notification 624 indicates that voice input 618 could not be matched to any user profiles of device 600 (e.g., “User not recognized”). Notification 626 indicates that an alternative form of authentication can be used to access media item 620a. For example, notification 626 indicates that a user can enter a passcode (e.g., password) in field 628 to access media item 620a. If a valid passcode is provided for a user profile authorized to view requested media item 620a, device 600 initiates playback of media item 620a, as shown in FIG. 6B.

If device 600 determines that a voice input matches a user profile, and that the user profile is not authorized to access requested media item 420a, device 600 causes display 602 to display (e.g., replace display of user interface 610 with) passcode interface 630, as shown in FIG. 6D. Passcode interface 630 includes notifications, 632, 634, and field 636. Notification 632 indicates that voice input 618 matched a user profile of device 600, but that the matched user profile is not authorized to view media item 620a (e.g., “Restricted by parental controls”). Notification 634 indicates that an alternative form of authentication can be used to access media item 620a. For example, notification 634 indicates that a user can enter a passcode (e.g., password) in field 636 to access media item 620a. In some embodiments, a valid passcode is a passcode associated with an administrator or parental user account of device 600 that authorizes user accounts to access media items when such user accounts would otherwise be restricted from accessing the media items.

In some embodiments, if a received user input is not a voice input, device 600 instructs the user to provide an alternative form of authentication to access the restricted media item. With reference to FIG. 6E, while device 600 causes display of home interface 610 including a focus on media item 620a, remote control 604 detects activation of selection region 604a via input 638 corresponding to a selection (and request to initiate playback) of media item 620a. Remote control 604 transmits an indication of input 638 to device 600, and in response to the indication of input 638, device 600 causes display 602 to display (e.g., replace display of home interface 610 with) a passcode interface (e.g., passcode interface 630 FIG. 6D) such that a user can provide a passcode to access media item 620a, as described.

FIGS. 6F-6M illustrate techniques for managing features (e.g., voice features, such as voice recognition) of a user profile. At FIG. 6F, device 600 is causing display 602 to display configuration menu interface 640 of a settings application of device 600. As shown, configuration menu interface 640 includes menu affordance 642, and a focus is on menu affordance 642, indicated by the bold outline around menu affordance 642. While device 600 causes display of user interface 640 with the focus on menu affordance 642, remote control 604 detects activation of selection region 604a via user input 644 corresponding to a selection of menu affordance 642 and transmits an indication of user input 644 to device 600. Device 600 receives, from remote control 604, the indication of input 644 corresponding to selection of menu affordance 642.

In response to detecting (e.g., receiving the indication of) input 644, device 600 causes display 602 to display (e.g., replace display of user interface 640 with) voice restrictions menu 648, as shown in FIG. 6G. Voice restrictions menu 648 includes voice restriction affordances 650, global voice restriction affordance 652, and voice setup affordances 654. Global voice restriction affordance 652 is be selected (e.g., via user input) to enable or disable voice recognition on device 600 for all user profiles stored on device 600.

In some embodiments, voice recognition is selectively enabled for individual user profiles. For example, each voice restriction affordance 648 can be selected (e.g., via user input) to enable (e.g., “allow”) or disable (e.g., “don't allow”) the use of voice inputs on device 600 for a particular user profile. With reference to FIG. 6G, for example, the use of voice inputs on device 600 for user profile “John Appleseed” is enabled, and the use of voice inputs on device 600 for user profiles “Jill Appleseed” and “Jane Appleseed” is disabled.

In some embodiments, voice recognition is enabled for a user profile on device 600 only if the user profile belongs to a home ecosystem (e.g., the user profile has rights to modify settings of devices and/or accessories included in the home ecosystem) and, additionally, voice recognition for the user profile is enabled within the home ecosystem. As an example, user profiles for John Appleseed, Jill Appleseed, and Jane Appleseed belong to a home ecosystem and are configured such that voice recognition is enabled for each of the user profiles within the home ecosystem. Accordingly, a voice restriction affordance 648 is provided for each of the user profiles John Appleseed, Jill Appleseed, and Jane Appleseed.

In some embodiments, user profiles can be added to a home ecosystem and/or voice recognition can be enabled for the user profiles within the home ecosystem. As an example, each voice setup affordance 654 corresponds to a user profile stored on device 600 (e.g., Milton Smith, Calvin Smith) that does not belong to the home ecosystem, or belongs to the home ecosystem but does not have voice recognition enabled within the home ecosystem. In response to selection of a voice setup affordance 654 corresponding to a user profile, device 600 causes display 602 to display instructions for performing a process for configuring the user profile (e.g., adding the user profile to the home ecosystem and/or enabling voice recognition for the user profile within the home ecosystem).

As shown in FIG. 6G, a focus is on voice setup affordance 654a for the user profile Milton Smith, indicated by the bold outline around voice setup affordance 654a. While device 600 causes display of user interface 650 with the focus on voice setup affordance 654a, remote control 604 detects activation of selection region 604a via user input 656 corresponding to selection of voice setup affordance 654a and provides (e.g., transmits) an indication of user input 656 to device 600. Device 600 receives, from remote control 604, the indication of input 656 corresponding to selection of voice setup affordance 654a.

In response to detecting (e.g., receiving the indication of) input 656 indicating a selection of voice setup affordance 654a, device 600 causes display 602 to display (e.g., replace display of voice restrictions menu interface 650 with) instructions interface 658, as shown in FIG. 6H. Instructions interface 658 includes indicator 660 indicating that the user profile for Milton Smith can be configured using a home automation application of another device (e.g., device 100, 300, 500) associated with the user (e.g., Milton), such as device 662 (FIG. 6I).

FIGS. 6I-6L illustrate a process for configuring a user profile. FIG. 6I depicts device 662, which is a smartphone with display 663 in some embodiments. Display 663 of device 662 includes a touch-sensitive surface on which device 662 can detect user gestures (e.g., tap, swipe, drag). In some embodiments, device 662 includes one or more features of electronic devices 100, 300, and/or 500.

At FIG. 6I, device 662 displays user profile interface 664. User profile interface 664 is a user interface of a home automation application in some examples. User profile interface 664 includes voice enable object 667 and configure profile affordance 668. Voice enable option 667, when activated, enables or disables the use of voice recognition for the user profile in the home ecosystem.

At FIG. 6I, device 662 detects tap gesture 670 on configure profile affordance 668. In response to detecting tap gesture 670, device 662 displays (e.g., replaces display of user profile interface 664 with) add profile interface 674, as shown in FIG. 6J. Configure profile interface 674 includes indicator 676, continue affordance 678, and cancel affordance 680. Indicator 676 indicates that the user has initiated a process for configuring one or more features of the user profile and that performing the process will allow the user profile to be added to one or more devices (e.g., device 600), if the user profile is not already stored on the device. Activation of the cancel affordance 680 causes the device 662 to cease display of configure profile interface 674 and/or cease the process for configuring the user profile.

At FIG. 6J, device 662 detects tap gesture 682 on continue affordance 678. In response to detecting tap gesture 682, device 662 displays (e.g., replaces display of add profile interface 674 with) device selection interface 684, as shown in FIG. 6K. Device selection interface 684 includes candidate device objects 686, continue affordance 688 and cancel affordance 690. Activation of the cancelation affordance 690 causes device 662 to cease display of device selection interface 684 and/or cease the process for configuring the user profile.

In some embodiments, each of the candidate device objects 686 corresponds to a respective device (e.g., device 600), for instance, of a home ecosystem. In some embodiments, candidate device objects 686 correspond to devices of the home ecosystem having a particular device type (e.g., set top box).

In some embodiments, a candidate device object 686 is activated to add a user profile to the corresponding device. As an example, with reference to FIG. 6K, device objects 686a, 686c are activated. Accordingly, in response to detecting tap gesture 692 on continue affordance, device 662 instructs a device corresponding to “Bedroom TV” and a device corresponding to “Living Room TV” to add the user profile Milton Smith, if the user profile for Milton Smith is not already stored thereon. Optionally, device 662 instructs a device corresponding to “Kitchen TV” to remove the user profile Milton Smith if the user profile is stored on the device for “Kitchen TV”.

Further in response to detecting tap gesture 692, device 662 displays (e.g., replaces display of device selection interface 684 with) voice recognition interface 694, as shown in FIG. 6L. Voice recognition interface 694 includes indicator 696 and recognition affordance 698. Indicator 696 indicates that selection of recognition affordance 698 will enable voice recognition for the user profile on one or more devices to which the user profile has been added (e.g., device 600). At FIG. 6L, device 662 detects tap gesture 602a on completion affordance 698. In response to detecting tap gesture 602a, device 662 enables voice recognition for the user profile Milton Smith within the home ecosystem. As a result of enabling voice recognition in this manner, voice recognition is enabled for Milton Appleseed on device 600, as described.

It will be appreciated that while a particular process for managing user profile features has been described with respect to FIGS. 6I-6L, in some embodiments, one or more aspects of the process can, optionally, be altered or omitted. By way of example, the process for configuring user profiles can be implemented without use of a device selection interface (e.g., device selection interface 684). Instead, selection of a continue affordance of a user profile feature interface causes device 662 to forgo displaying the device selection interface and display a voice recognition interface. As another example, if voice recognition is enabled for a user within a home ecosystem (e.g., in response to enabling voice enable option 667), device 662 forgoes displaying voice recognition interface 694.

As described, in some embodiments, in response to determining that a user profile requesting access to a media item is authorized to access the media item, device 600 initiates playback of the media item. In some embodiments, in response to initiating playback (or prior to playback), the device 600 notifies an external device (e.g., a device associated with a parent account) that playback of the media item is being initiated (e.g., notifies the external device that access to the media item has been granted. In some embodiments, approval from an external device is required before playback may be initiated. As shown in FIG. 6M, device 600 is in communication with external device 604a, which is a smartwatch. In some embodiments, external device 604a is a smartphone (e.g., device 662). In some embodiments, external device 604a includes one or more features of devices 100, 300, and/or 500. In response to receiving a request to initiate playback of a media item requiring approval, device 600 notifies external device 604a of a request to access media item 608a (“The Impossibles 2”).

In response, external device 604a displays authorization interface 606a. Authorization interface 606a includes indicators 608a, 610a. Indicator 608a identifies the media item of the request (“The Impossibles 2”), and indicator 610a indicates a manner in which the request can be approved (“double click to approve”). In response to receiving one or more inputs indicating that playback of the media item is approved (e.g., double press of button 605a), external device 604a notifies device 600 that playback of the media item has been approved, and in response, device 600 initiates playback of the requested media item.

FIG. 7 is a flow diagram illustrating a method for providing media content in accordance with some embodiments. Method 700 is performed at a computer system (e.g., 100, 300, 500, 600) (e.g., a digital media player (e.g., a set top device; a digital media player), a smartphone) that is in communication with a display generation component (e.g., 602) (e.g., a television, a display controller, an internal or external touch-sensitive display system) and one or more input devices (e.g., a touch-sensitive surface, a hardware button, a microphone). Some operations in method 700 are, optionally, combined, the orders of some operations are, optionally, changed, and some operations are, optionally, omitted.

As described below, method 700 provides an intuitive way for providing media content. The method reduces the cognitive burden on a user for providing (e.g., accessing) media content, thereby creating a more efficient human-machine interface. For battery-operated computing devices, enabling a user to provide media content faster and more efficiently conserves power and increases the time between battery charges.

The computer system (e.g., 600) receives (702), via the one or more input devices (e.g., 604), a user input (e.g., 618, 638). In some embodiments, the user input is a voice (e.g., speech) input (e.g., 638) (including a request to access a first restricted media item (e.g., 620a, 620b) (e.g., restricted media content). In some embodiments, the user input is a tactile input (e.g., 638) (e.g., selection of button, for instance, at the device or at a remote control device communicatively coupled to the computer system, or selection of an affordance on a display at, or communicatively coupled to, the device. In some embodiments, the voice input includes a request to access media content, such as movies, TV shows, music, and/or photos (e.g., “Hey Voice Assistant, play Baseball”). In some embodiments, the media content is restricted such that only authorized user profiles may access (e.g., view, play) the restricted media content. In some embodiments, content is restricted based on whether a user's profile is authorized to request media content using voice commands. In some embodiments, content is restricted based on a content rating of the media content indicating suitable age groups for the media content. In some embodiments, all content is restricted. In some embodiments, the request includes a digital assistant trigger (e.g., “Hey Siri”) to indicate that a voice input is intended for the computer system.

In response (704) to the receiving the user input (e.g., 618, 638), and in accordance with (706) a determination that the user input is a voice input and a determination that the voice input corresponds (e.g., sufficiently matches a stored user voice profile) to a stored (e.g., on the computer system) user profile (e.g., user voice profile for a user) that is authorized to access the first restricted media item using voice inputs, the computer system initiates (708) playback of the first restricted media item (e.g., 620a). In some embodiments, the computer system determines whether a user's profile has been authorized to view requested restricted media content. In some embodiments, the computer system determines if the user's profile is authorized to request media content using voice inputs. In some embodiments, the computer system additionally or alternatively determines if the user's profile is authorized to view media content having a particular content rating; by way of example, if requested restricted media content is rated PG-13, the device can determine whether the user's profile has been assigned permissions to view media content rated PG-13). In some embodiments, once the computer system has determined that the user's profile is authorized to view the restricted media content, the computer system automatically initiates playback of the media content. In some embodiments, the media content is played without additional user input. In some embodiments, the media content is played without displaying additional user interfaces.

In response (704) to the receiving the user input (e.g., 618, 638), and in accordance with a determination (710) that the user input is a voice input and a determination that the voice input does not correspond (e.g., a failure to make a determination that the voice input corresponds to an authorized user voice profile) to a stored user profile that is authorized to access the first restricted media item using voice inputs, the computer system forgoes (712) initiating playback of the first restricted media item (e.g., 620a).

In response (704) to the receiving the user input, and in accordance with a determination (710) that the user input is a voice input and a determination that the voice input does not correspond (e.g., a failure to make a determination that the voice input corresponds to an authorized user voice profile) to a stored user profile that is authorized to access the first restricted media item using voice inputs, the computer system causes (714) display, at the display generation component (e.g., 602), of a validation user interface (e.g., 622, 630). In some embodiments, if the computer system determines that the user is not authorized to view the restricted media content, the computer system allows for a user to be authorized in an alternative manner. In some embodiments, the computer system causes display if a validation user interface including a prompt for entry of a passcode. In some embodiments, the computer system receives a set of inputs including a passcode, and if a passcode is determined to be valid, the user is authorized and playback of the restricted media content is initiated. In some embodiments, the validation user interface includes one or more options and/or affordances for providing user credentials (e.g., user names and/or passwords). Initiating playback of a restricted media item in accordance with a determination that a voice input is a request to access the restricted media item and a determination that the voice input corresponds to a user voice profile authorized to access the restricted media item enables the user to quickly and efficiently initiate playback of the restricted media item, which reduces the number of inputs needed to perform an operation.

In some embodiments, the determination that the received voice input corresponds to a stored user profile (e.g., user account) that is authorized to access the first restricted media item includes a determination that a voice profile of a stored user profile matches the received voice input (e.g., 618, 638) (e.g., matching the voice input to a voice profile associated with a user profile for a user). In some embodiments, the voice input is compared to a voice model for each user profile of the computer system). Determining an identity of a user that provided the voice input based on the voice input enables the computing system to quickly, efficiently, and accurately identify a user requesting access to restricted media items, which performs an operation when a set of conditions has been met without requiring further user input.

In some embodiments, the computer system forgoing initiating playback of the first restricted media item includes (e.g., displaying the validation user interface includes), in accordance with a determination that the voice input corresponds to a stored user profile that is not authorized to access the first restricted media item, displaying a first visual indication (e.g., 632). In some embodiments, if the voice input corresponds to a user voice profile (e.g., of a user profile), but the user voice profile is not authorized to access restricted media items using voice inputs, the computing system causes display of a notification indicating the same. In some embodiments, the notification is an alphanumeric string (e.g., “Restricted by Parental Controls”) and/or an image.

In some embodiments, the computer system forgoing initiating playback of the first restricted media item includes, in accordance with a determination that the voice input does not correspond to a stored user profile (e.g., the voice input is not matched to any stored user voice profile), displaying a second visual indication (e.g., 624), different than the first visual indication. In some embodiments, if a voice input does not correspond to a user profile, the computing system causes display of a notification indicating the same. In some embodiments, the notification is an alphanumeric string (e.g., “user not recognized”) and/or an image). Displaying a first visual notification in accordance with a determination that the voice input corresponds to a stored user profile that is not authorized to access the first restricted media item, and displaying a second visual notification, different than the first visual indication, in accordance with a determination that the voice input does not correspond to a stored user profile enables the user to quickly and efficiently diagnose a failure to initiate playback of restricted media items in response to a request, which provides improved visual feedback.

In some embodiments, while displaying the validation user interface (e.g., 622, 630), the computer system receives a second user input (e.g., alphanumeric string, such as a numeric passcode), via the one or more input devices (e.g., 604). In some embodiments, the validation user interface includes a prompt for entry of a passcode. In some embodiments, the computing system receives a user input (e.g., passcode) while displaying the validation user interface and determines whether the user input includes a valid passcode for initiating a requested media item. In some embodiments, passcodes are profile-specific and a passcode is valid if it is a passcode for a profile requesting access to the restricted media item. In some embodiments, a passcode is valid if the user's profile is authorized to view media content having a particular content rating. In some embodiments, passcodes are valid for all profiles.

In some embodiments, while displaying the validation user interface (e.g., 622, 630), in response to receiving the second user input, in accordance with a determination that the second user input is a valid passcode for initiating playback of the first restricted media item, the computer system initiates playback of the first restricted media item (e.g., 620a). In some embodiments, once the computing system has determined that the passcode is valid, the computing system automatically initiates playback of the media content. In some embodiments, the media content is played without additional user input. In some embodiments, the media content is played without displaying additional user interfaces.

In some embodiments, while displaying the validation user interface, in response to receiving the second user input, in accordance with a determination that the user input is not a valid passcode for initiating playback of the first restricted media item, the computer system forgoes initiating playback of the first restricted media item. In some embodiments, if the computing system determines that the passcode is not valid, the computing system displays, at the display generation component, a notification indicating that the passcode is not valid.

In some embodiments, in response to the user input, in accordance with a determination that the user input is not a voice input (e.g., the user input is a tactile input, for instance, provided using a remote control device), the computer system causes display, at the display generation component, of a second validation user interface (e.g., 622, 630). In some embodiments, if the computing system receives a user input including a request to access a first restricted media item and the user input is not a voice input, the computing system causes display of a second validation user interface; in this manner, the user can authenticate with the computing system and initiate playback of the requested restricted media item. In some embodiments, the second validation interface is the same as the validation interface). Causing display of a second validation user interface in accordance with a with a determination that the user input is not a voice input enables the user to quickly and efficiently authenticate with a computing system when unable to do so by voice input, which reduces the number of inputs needed to perform an operation.

In some embodiments, prior to receiving the user input, the computer system receives, via the one or more input devices, a first set of user inputs (e.g., a set of one or more inputs used to navigate through a set of user interfaces, for instance, of a settings menu and/or used to enable or disable one or more features). In some embodiments, in response to receiving the first set of user inputs and in accordance with a determination that a set of authorizing criteria are met, the computer system enables a voice media playback feature for a stored user profile to authorize the stored user profile to access the first restricted media item using voice inputs. In some embodiments, a voice media playback feature may be configured for a user voice profile. In some embodiments, if enabled for a user voice profile, the user voice profile is authorized to initiate playback of restricted media items using voice inputs. In some embodiments, a user may navigate to a voice media playback interface and select an affordance to cause the computing system to selectively enable (e.g., enable and/or disable) the voice media playback feature. Enabling a voice media playback feature in response to receiving the first set of user inputs and in accordance with a determination that a set of authorizing criteria are met enables a user to control whether the user's voice inputs can be used to initiate playback of restricted media items, which provides additional control options without cluttering the user interface.

In some embodiments, the computer system is in communication with an external electronic device (e.g., 604a), and the set of authorizing criteria includes a criterion that is met when a determination is made that a required set of inputs (e.g., a confirmation input received in response to a notification at the external electronic device that was triggered by the first set of user inputs) was received at the external electronic device. In some embodiments, the computer system receives, from the external electronic device, an indication that the required set of inputs was received at the external electronic device.

In some embodiments, in accordance with a determination that a set of notification criteria are met, the computer system provides, to a second external device (e.g., 600, 604a), a notification indicating that access to the restricted media item has been granted in response to the request to access the restricted media item (e.g., 608a). In some embodiments, the set of notification criteria include a criterion (e.g., requirement) that access to restricted media content has been granted for one or more particular profiles of the computing system (e.g., non-owner profiles, child profiles). In some embodiments, the notification is provided prior to initiating playback of the restricted media item (e.g., while a navigation interface is displayed). In some embodiments, a user of the external device must approve playback of the restricted media content in response to the notification for the computing device to initiate playback of the restricted media item. In some embodiments, the notification is provided after initiating playback of the restricted media item.

Note that details of the processes described above with respect to method 700 (e.g., FIG. 7) are also applicable in an analogous manner to the methods described below. For example, method 900 optionally includes one or more of the characteristics of the various methods described above with respect to method 700. For example, in some instances a user may provide a voice input to switch to a new user profile, as described with respect to method 900, and thereafter provide a voice input requesting playback of a media item for which the requested account is authorized to access, as described with respect to method 700. For brevity, these details are not repeated below.

FIGS. 8A-8E illustrate exemplary user interfaces for switching user profiles, in accordance with some embodiments. The user interfaces in these figures are used to illustrate the processes described below, including the processes in FIG. 9.

In the examples described in FIGS. 8A-8E, device 600 (e.g., device 100, 300, 500) causes display, on display 602, of the user interfaces described below. In some embodiments, display 602 is an integrated part of device 600. In some embodiments, device 600 is a separate digital media player (e.g., set top box) that is in communication (e.g., wireless, wired) with display 602. For simplicity, device 600 is not shown in FIGS. 8A-8E.

At FIG. 8A, device 600 is causing display 602 (e.g., a television, a monitor) to display home interface 810, while a first profile stored on device 600 is active and a second profile stored on device 600 is inactive. User interface 810 includes applications 812. In some embodiments, applications 812 include one or more one or more applications that can be used on device 600 to provide content (e.g., media items). In some examples, applications 812 include one or more applications selected for the first profile. Home interface 810 further includes media items 820a, 820b. In some embodiments, one or more of media items 820 are recommended media items, or media items selected by device 600 for the first user profile.

In some embodiments, applications 812 and/or media items 820 of home interface 810 are selected for the first profile based on contextual information, such as contextual information of the device 600 and contextual information of the first user profile. Contextual information of device 600 includes contextual information regarding a state of device 600 (e.g., time, day, week, location). Contextual information of the first user profile includes any information that may be used to personalize home interface 810 for a user, including user-specific information for a user associated with the first user profile (e.g., calendar, age, permissions). In some embodiments, contextual information of the first user profile includes content previously accessed by the first user profile and/or prior usage of the device 600 while the first profile was active (e.g., dwell time on one or more media items while browsing for content).

While device 600 causes display of user interface 810, device 600 receives a voice input (e.g., indication of a voice input at remote control 604). As an example, with reference to FIG. 8A, device 600 receives, from user 814, voice input 818 requesting that device 600 switch profiles (e.g., “Switch to my profile”).

In response to voice input 818, device 600 determines whether voice input 818 includes a request to switch user profiles, and if so, whether voice input 818 corresponds to a second user profile, for instance, different than the first user profile. In some embodiments, determining whether voice input 818 includes a request to switch profiles includes deriving a user intent from the voice input and determining whether the user intent corresponds to a task for switching profiles. In some embodiments, determining whether the voice input corresponds to a second user profile includes determining whether voice input 818 matches a voice profile of a user profile. The voice profile includes one or more voice models used to identify a voice of a user associated with the voice profile. In some embodiments, determining whether voice input 818 corresponds to a second user profile includes determining whether voice input 818 includes a reference to a profile, for instance, stored on device 600 (e.g., “John” in “switch to John's profile”).

If device 600 determines that voice input 818 includes a request to switch user profiles and corresponds to a second user profile, device 600 switches from the first user profile to the second user profile. As a result, the second user profile is active and the first user profile is inactive. Additionally, device 600 causes display 602 to display (e.g., replace display of user interface 810 with) home interface 822, as shown in FIG. 8B. Home interface 822 includes indicator 816. Indicator 816 indicates that device 600 has switched profiles, and optionally, further identifies the second user profile (e.g., “Welcome back, John”).

User interface 822 includes applications 824 and media items 825, including media items 825a, 825b. In some embodiments, applications 824 include one or more one or more applications that can be used on device 600 to provide content (e.g., media items). In some examples, applications 824 include one or more applications selected for the second profile. Home interface 810 further includes media items 820a, 820b. In some embodiments, one or more of media items 820 are recommended media items, or media items selected by device 600 for the second user profile. In some embodiments, applications 824 and/or media items 820a, 820b are selected for the second profile based on contextual information, as described.

If device 600 determines voice input 818 includes a request to switch profiles, but does not correspond to a user profile (e.g., a user profile stored on device 600), device 600 causes display 602 to display disambiguation user interface 826, as shown in FIG. 8C. In some embodiments, device 600 causes display 602 to display (e.g., replaces display of home interface 810 with) disambiguation user interface 826. In some embodiments, device 600 overlays disambiguation user interface 826 on home interface 810.

Disambiguation user interface 826 includes candidate user profiles 828, each of which corresponds to a respective user profile of device 600. In some embodiments, disambiguation user interface 826 includes candidate user profiles 828 for all user profiles of device 600. In some embodiments, disambiguation user interface 826 includes candidate user profiles 828 for a subset of user profiles of device 600. By way of example, in response to determining voice input 818 includes a request to switch profiles, but does not correspond to a user profile stored on device 600, device 600 identifies a threshold number of user profiles determined to most likely correspond to voice input 818. Device 600 identifies the threshold number of profiles by generating a confidence score for each user profile and selects the threshold number of user profiles having the highest confidence scores. In some embodiments, candidate user profiles 828 are displayed according to their respective confidence scores. In some embodiments, candidate user profiles 828 include the currently active user profile (e.g., the first user profile 828a), which is, optionally, highlighted, for instance, using a particular visual indication, such as a particular color or an object (e.g., checkmark 830) displayed near or on the candidate user profile corresponding to the active user profile. Highlighting the active user profile in this manner indicates which user profile is currently being used by device 600.

While device 600 causes display of disambiguation interface 826, device 600 receives a user input 832 (e.g., indication of a user input at remote control 604) corresponding to a selection of a candidate user profile. In response to the user input indicating a selection of the candidate user profile, device 600 switches to the selected user profile.

FIGS. 8D-8E illustrate a process for providing recommended media items. At FIG. 8D, device 600 is causing display 602 (e.g., a television, a monitor) to display home interface 840 while a third user profile stored on device 600 is active and a fourth user profile stored on device 600 is inactive. Home interface 840 includes applications 842. In some embodiments, applications 842 include one or more one or more applications that can be used on device 600 to provide content (e.g., media items). User interface 840 further includes media items 850a, 850b. In some embodiments, one or more of media items 850 are recommended media items, or media items selected by device 600 based on user preferences and/or previous user behavior of a user for the third user profile.

While device 600 causes display of user interface 840, device 600 receives voice input 852 (e.g., indication of voice input 852 at remote control 604). As shown in FIG. 8D, device 600 receives, from user 808, voice input 852 requesting that device 600 provide recommended content for multiple users (e.g., “Show content for all of us”).

In response voice input 852, device 600 determines whether voice input 852 includes a request to provide media item recommendations for multiple users. If so, device 600 identifies a set of user profiles. In some embodiments, device 600 identifies users in the vicinity of device 600 and identifies any user profiles stored on device 600 corresponding to the users in the vicinity of device 600. Users are identified in this manner, for instance, using biometric identification (e.g., face identification, voice recognition). In some embodiments, device 600 identifies user profiles based on voice input 852. A voice input can specify, for instance, one or more user profiles explicitly, and/or contextually (e.g., “Find something for Joe and me to watch”). In some embodiments, device 600 identifies user profiles based on a context state of device 600 (e.g., location, time of day, day of week, etc.). If, for instance, a user requests recommendations at a particular time of day, device 600 can identify user profiles for users that typically watch media items on device 600 at or near the same time of day.

In response to identifying the user profiles, device 600 identifies a set of recommended media items for one or more of the identified user profiles. In some embodiments, identifying recommended media items in this manner includes identifying recommended media items for each user profile and combining the identified recommended media items into a combined set of recommended media items. In some embodiments, identifying recommended media items in this manner includes identifying recommended media items for each user profile and selecting a predetermined number of media items, for instance, corresponding to each profile.

Upon identifying recommended media items for the user profiles, device 600 causes display 602 to display (e.g., replace display of user interface 840 with) user interface 860, as shown in FIG. 8E. User interface 860 includes recommended media items 870 (e.g., recommended media item 870a, recommended media item 870b), which are comprised of the identified recommended media items, in some embodiments.

FIG. 9 is a flow diagram illustrating a method for providing media content using a computer system in accordance with some embodiments. Method 900 is performed at a computer system (e.g., 100, 300, 500, 600) (e.g., a digital media player (e.g., a set top device), a smartphone) that is in communication with a display generation component (e.g., 602) (e.g., a television, a display controller, an internal or external touch-sensitive display system) and a voice input device (e.g., a microphone). Some operations in method 900 are, optionally, combined, the orders of some operations are, optionally, changed, and some operations are, optionally, omitted.

As described below, method 900 provides an intuitive way for switching user profiles. The method reduces the cognitive burden on a user for switching user profiles, thereby creating a more efficient human-machine interface. For battery-operated computing devices, enabling a user to switch user profiles faster and more efficiently conserves power and increases the time between battery charges.

While a first user profile (e.g., a profile associated with a set of user preferences, user authorizations, and/or user access history, a user profile stored on the computer system) is active, the computer system (e.g., 600) receives (902), via the voice input device, a voice input (e.g., 818) (e.g., speech input).

In response (904) to receiving the voice input, and in accordance (906) with a determination that the voice input includes a request to switch (e.g., transition from the first user profile to a different user profile) user profiles, and a determination that the voice input corresponds to (e.g., sufficiently matches a stored user voice profile that is associated with the second user profile) a second user profile, the computer system switches (908) from the first user profile to the second user profile. In some embodiments, the computer system determines whether the voice input indicates an intent for the computer system to switch from a user profile currently active on the computer system to a different user profile (e.g., “switch to John's profile”). In some embodiments, the computer system determines whether the voice input references a particular profile (e.g., “switch to John's profile”). In some embodiments, the computer system determines whether the voice input contextually references a particular profile; as an example, the voice input may recite “switch to my profile”, in which case the computer system identifies the profile as a profile of the user providing the voice input. In some embodiments, the computer system identifies a user providing the voice input only when necessary to identify a user profile referenced by a voice input; as another example, the voice input may recite “switch to the previous profile”, in which case the computer system identifies the profile as the profile most recently active prior to the currently active user profile. In some embodiments, the computer system determines a confidence score for each user profile of the computer system indicating the likelihood that the voice input is indicative of that user profile. In some embodiments, the computer system selects the user profile with the highest confidence score satisfying a threshold confidence score (otherwise the computer system may determine that the voice input is not indicative of a user profile). In some embodiments, once the computer system has determined that a voice input includes a request to transition between user profiles and that the voice input is indicative of a user profile, the computer system transitions (e.g., switches) from the current user profile to the user profile indicated by the voice input. In some embodiments, after switching from the first user profile to the second user profile, the computing system provides a notification indicating that the profile has been switched (e.g., “Welcome, Jeff”).

In response (904) to receiving the voice input, and in accordance (910) with a determination that the voice input includes a request to switch user profiles, and a determination that the voice input does not correspond to (e.g., a failure to make a determination that the voice input corresponds to an authorized user voice profile) a stored user profile (e.g., the second user profile and/or any other user profile accessible to the computer system), the computer system forgoes (912) switching user profiles (e.g., maintaining the first user profile as the active profile).

In response (904) to receiving the voice input, in accordance (910) with a determination that the voice input includes a request to switch user profiles, and a determination that the voice input does not correspond to (e.g., a failure to make a determination that the voice input corresponds to an authorized user voice profile) a stored user profile (e.g., the second user profile and/or any other user profile accessible to the computer system) the computer system causes (914) display, at the display generation component (e.g., 602), of a disambiguation user interface (e.g., 826) that includes a plurality of candidate user profiles (e.g., 828). In some embodiments, the computer system may determine that a user input includes a request to transition between profiles, but is not indicative of a user profile, and in response, cause display of a disambiguation user interface. In some embodiments, the disambiguation user interface includes all or a subset or user profiles of the computer system. In some embodiments, the user may navigate using the disambiguation user interface to select a desired user profile. In some embodiments, the current user profile is highlighted in the disambiguation user interface. In some embodiments, the user profiles are arranged based on how recently each of the user profiles was active. In some embodiments, the user profiles are arranged based on their respective confidence scores. Switching from a first user profile to a second user profile in accordance with a determination that a voice input includes a request to switch user profiles and a determination that the voice input corresponds to a second user profile enables the user to quickly and efficiently transition between user profiles of a computing device, which reduces the number of inputs needed to perform an operation.

In some embodiments, the determination that the voice input corresponds to the second user profile includes a determination that the voice input (e.g., 818) matches a voice profile of the second user profile (e.g., voice model). In some embodiments, the computing system determines whether the voice input matches a voice model for a user profile of the computing system.

In some embodiments, the determination that the voice input corresponds to the second user profile includes a determination that a portion of the voice input includes a reference to the second user profile. In some embodiments, a reference to another profile is a name of a user (e.g., “switch to Eric's profile). In some embodiments, a reference to another profile is a reference to a previously active profile (e.g., “switch to the previous profile”). Determining that a voice input includes a reference to a second user profile enables the computing system to quickly, efficiently, and accurately identify a user profile requested by a user, which performs an operation when a set of conditions has been met without requiring further user input.

In some embodiments, after switching from the first user profile to the second user profile, the computer system identifies a set of content (e.g., 825a, 825b) for the second user profile based on context information of the second user profile. In some embodiments, after switching profiles, the computing system identifies content for the newly active user profile. In some embodiments, content includes personalized content (e.g., recommended media items) and/or application (e.g., streaming application) recommendations for the user of the active user profile. In some embodiments, content is identified based on context information, for instance, of the active user profile. In some embodiments, context information includes context information for the computing system, such as time, day, location, and/or previously viewed content across all user profiles. In some embodiments, context information includes context information for a user profile, such as content previously viewed while the user profile was active, user calendar, and/or applications frequently used by the user.

In some embodiments, the computer system receives a second user input (e.g., 852). In some embodiments, in accordance with a determination that the second user input is a request to provide media item recommendations for a plurality of user profiles, the computer system identifies a first set of recommended media items for a third user profile (e.g., 850a, 850b) (e.g., first user in a plurality of users requesting recommended media items). In some embodiments, the computing system determines that a user input is a request to provide media item recommendations for a plurality of user profiles based on the user input (e.g., the user input specifies that the request is for a plurality of user profiles, e.g., “show recommendations for all of us”, “find something for me and Joe to watch”). In some embodiments, the computing system determines that users corresponding to a plurality of user profiles, respectively, are proximate the computing system and in response determines that a request for media item recommendations is a request for all users proximate the computing system). In some embodiments, in accordance with a determination that the second user input is a request to provide media item recommendations for a plurality of user profiles, the computer system identifies a second set of recommended media items for a fourth user profile (e.g., 850a, 850b) (e.g., second user in a plurality of users requesting recommended media items). In some embodiments, in accordance with a determination that the second user input is a request to provide media item recommendations for a plurality of user profiles, the computer system provides a third set of recommended media items, the third set of recommended media items based on the first and second sets of recommended media items (e.g., 850a, 850b). In some embodiments, the computing system combines one or more media items of the first set of recommended media items and one or more media items of the second set of recommended media items to provide (e.g., obtain, generate) the third set of recommended media items. In some embodiments, media items of the first set and/or second set of recommended media items are ranked according to saliency and, optionally, a threshold number of media items from each set is used to provide the third set of recommended media items. In some embodiments, saliency for each set is determined for a plurality of user profiles. Providing a third set of recommended media items in which the third set of recommended media items is based on a first set of recommended items for a third user profile and a second set of recommended media items for a fourth user profile enables the computing system to efficiently and accurately identify recommended media items for multiple users, for instance, viewing media items together, which performs an operation when a set of conditions has been met without requiring further user input.

In some embodiments, the computer system is further in communication with one or more input devices (e.g., a touch-sensitive surface, a hardware button, for instance, of a remote control device). In some embodiments, while displaying the disambiguation user interface, the computer system receives, via the one or more input devices, a selection of a candidate user profile of the plurality of candidate user profiles. In some embodiments, if the computing system receives a request to switch user profiles but cannot identify a user profile based on the input, the computing system causes display (e.g., displays, causes another device to display) of a plurality of candidate user profiles that a user may desire to switch to). In some embodiments, the computer system switches from the first user profile to the selected candidate user profile. In some embodiments, the user may select a candidate profile and the computing system receives the selection and switches to the selected user profile. In some embodiments, the computing system authenticates the user prior to switching to the selected user profile, for instance, using a passcode (e.g., password) or biometric authentication. Switching from a first user profile to a second user profile in accordance with a determination that a voice input includes a request to switch user profiles and a determination that the voice input corresponds to a second user profile enables the user to quickly and efficiently transition between user profiles of a computing device, which reduces the number of inputs needed to perform an operation.

In some embodiments, the plurality of candidate user profiles includes the first user profile.

In some embodiments, causing display, at the display generation component, of a disambiguation user interface that includes the plurality of candidate user profiles includes highlighting the first user profile. In some embodiments, highlighting the first user profile includes modifying the visual appearance of the first user profile. In some embodiments, the computing system highlights the first user profile to indicate that the first user profile is currently active. In some embodiments, the computing system highlights the first user profile by placing a checkmark on or near the first user profile. In some embodiments, the computing system highlights the first user profile by modifying (e.g., brightening, darkening, greying) a color scheme of the first user profile.

In some embodiments, the plurality of candidate user profiles is assigned a respective plurality of confidence scores. In some embodiments, causing display, at the display generation component, of the disambiguation user interface that includes the plurality of candidate user profiles arranging the plurality of candidate user profiles based on the plurality of confidence scores. In some embodiments, upon receiving a voice input including a request to switch user profiles, the computer system determines, for each user profile, a likelihood, or confidence score, that the user profile corresponds to the voice input. In some embodiments, confidence scores are obtained by comparing, for each user profile, a user voice profile (e.g., voice model) of the user profile to the voice input. In some embodiments, the computing system ranks the candidate user profiles according to their respective confidence scores. In some embodiments, only a subset of candidate user profiles are included in the disambiguation user interface (e.g., only those candidate user profiles having a confidence score exceeding a predetermined threshold confidence score). In some embodiments, candidate user profiles are displayed in the center of the disambiguation user interface. In some embodiments, candidate user profiles are displayed in the lower third of the candidate disambiguation interface. In some embodiments, candidate user profiles are represented by an icon (e.g., avatar corresponding to a user) and/or alphanumeric string (e.g., name of user). Arranging a plurality of candidate user profiles based on a respective plurality of confidence scores enables the computing system to first provide (e.g., highlight) candidate user profiles determined to be most salient to a user, which reduces the number of inputs needed to perform an operation.

Note that details of the processes described above with respect to method 900 (e.g., FIG. 9) are also applicable in an analogous manner to other methods described herein. For example, method 900 optionally includes one or more of the characteristics of the various methods described below with reference to method 1300. For example, in some instances, a voice input may be provided to the device to switch to a new user profile, as described with respect to method 900, and optionally, in response to the voice input the device further may provide suggested content to a user, as described with respect to method 1300. For brevity, these details are not repeated.

FIGS. 10A-10M illustrate exemplary user interfaces for performing a configuration process in accordance with some embodiments. The user interfaces in these figures are used to illustrate the processes described below, including the processes in FIG. 11.

In the examples described below, a device 600 (e.g., a device having one or more features of device 100, 300, and/or 500) causes display, on display 602, of various user interfaces. In some embodiments, display 602 is an integrated part of device 600. In some embodiments, device 600 is a separate digital media player (e.g., set top box) that is in communication (e.g., wireless, wired) with display 602.

In some embodiments, device 600 is connected to a remote control 604, which is configured to transmit data (e.g., via RF communication, via Bluetooth, via infrared) to device 600 based on user input (e.g., voice input, tactile input) detected at remote control 604. Remote control 604 includes a selection region 604a, which includes a touch-sensitive surface for detecting tap, press, and swipe gestures, a menu button 604b, a television button 604c, a microphone button 604d, a play/pause button 604e, and volume control buttons 604f.

FIGS. 10A-10J illustrate a configuration process for device 600 when a set of personalized voice recognition criteria is not met for an active user profile of device 600. In some embodiments, the set of personalized voice recognition criteria includes a requirement that a voice profile is associated with the active user profile. In some embodiments, a voice profile is associated with (e.g., generated for) the user profile during a voice enrollment process performed by a device (e.g., device 601) of a user of the user profile. In some embodiments, the set of personalized voice recognition criteria includes a requirement that voice recognition is enabled for a user profile. In some embodiments, enabling voice recognition in this manner allows one or more devices of a home ecosystem (e.g., a home ecosystem as described with respect to FIG. 6G) to perform voice recognition. In some embodiments, voice recognition is performed using a voice profile associated with the user profile. The voice profile can, for instance, be used to identify and/or authenticate a user, and optionally, allows devices to provide a personalized experience (e.g., the devices operate according to user-specific settings and/or preferences after identifying a user). In some embodiments, voice recognition cannot be enabled for a user profile until a voice profile has been associated with the user profile.

In FIG. 10A, device 601 displays settings interface 1010 including voice recognition option 1012. In some embodiments, device 601 is associated with a user of the active user profile (e.g., Bob Ipsum) on device 600 and device 601 can be used to modify one or more settings of the active user profile on device 600. Voice recognition option 1012, when enabled, allows devices of a home ecosystem, which can include device 600, to perform voice recognition for a user of the active user profile. As shown, voice recognition option 1012 is in an “OFF” (e.g., disabled) state. Accordingly, personalized voice recognition criteria are not met for the active user profile.

In FIG. 10B, device 600 (e.g., a smart television) is causing display of, on display 602 (e.g., the integrated screen of device 600), home interface 1020 during a device configuration process. Home interface 1020 is an initial user interface of the device configuration process, in some embodiments. While device 600 causes display of home interface 1020, remote control 604 detects activation of selection region 604a via user input 1006b and transmits an indication of user input 1006b to device 600. Device 600 receives, from remote control 604, the indication of input 1006b.

In response to detecting (e.g., receiving the indication of) input 1006b, device 600 causes display 602 to display (e.g., replace display of user interface 1020 with) features interface 1030, as shown in FIG. 10C. Features interface 1030 includes continue affordance 1032 and, optionally, indicates one or more features and/or settings of device 600 that are be configured during the configuration process. While device 600 causes display of features interface 1030, remote control 604 detects activation of selection region 604a via user input 1006c and transmits an indication of user input 1006c to device 600. Device 600 receives, from remote control 604, the indication of input 1006c.

In response to detecting (e.g., receiving the indication of) input 1006c, device 600 determines whether voice recognition is enabled for the active user of device 600. Because voice recognition is disabled (recall that voice recognition option 1012 is disabled), device 600 causes display 602 to display (e.g., replace display of features interface 1030 with) voice recognition interface 1040, as shown in FIG. 10D. In some embodiments, if voice recognition is enabled, device 600 forgoes displaying voice recognition interface 1040, as described in more detail below.

Voice recognition interface 1040 includes voice recognition affordance 1042 and cancel affordance 1044. Cancel affordance 1044, when selected, causes device 600 to skip voice recognition configuration during the configuration process. Voice recognition affordance 1042, when selected, causes device 600 to initiate a process for enabling voice recognition for the active user profile. For example, while device 600 causes display of voice recognition interface 1040 with the focus on voice recognition affordance 1042, remote control 604 detects activation of selection region 604a via user input 1006d corresponding to a selection of voice recognition affordance 1042 and transmits an indication of user input 1006d to device 600. Device 600 receives, from remote control 604, the indication of input 1006d corresponding to selection of voice recognition affordance 1042.

In response to detecting (e.g., receiving the indication of) input 1006d, device 600 determines whether a voice profile is associated with the active user profile (e.g., a previously created voice profile, even though use of that profile is disabled because voice recognition option 1012 is disabled). If no voice profile is associated with the active user profile, device 600 causes display 602 to display (e.g., replace display of voice recognition interface 1040 with) voice profile interface 1050 (FIG. 10E), indicating that a voice profile can be associated with the active user profile using a device (e.g., device 601) associated with the user of the active user profile. Thereafter, the device (e.g., device 601) can be used to associate a voice profile with the active user profile, for instance, by performing a voice enrollment process on behalf of the user. Once a voice profile is created it is made available (e.g., by device 601 and/or a server) to device 600.

After associating a voice profile with the active user profile (or if, in response to detecting input 1006d device 600 determines that a voice profile is already associated with the active user profile), device 600 causes display 602 to display (e.g., replace display of voice profile interface 1050 with) confirmation interface 1070, as shown in FIG. 10F.

In some embodiments, voice recognition for the active user profile is enabled in response to authenticating the user of the active user profile. By way of example, in response to selection of passcode affordance 1074 of confirmation interface 1070, device 600 causes display 602 to display an authentication interface for authenticating the user of the active user profile. Once a valid passcode has been provided to authenticate the user, voice recognition is enabled for the active user account, allowing devices of a home ecosystem to recognize the user from voice commands (recall that devices of the home ecosystem may use a voice profile associated with the active user profile to identify and/or authenticate the user).

In some embodiments, voice recognition for the active user profile is enabled using a device of the user of the active user profile (e.g., device 601). By way of example, in response to selection of device affordance 1072 of confirmation interface 1070 (e.g., input 1006f), device 600 causes device 601 to display a notification 1074 (FIG. 10G) indicating that voice recognition for the user profile can be enabled using device 601. While displaying notification 1074, device 601 detects selection of notification 1074. The selection is a tap gesture 1006g on notification 1074. As shown in FIG. 10H, in response to selection of notification 1074, device 601 displays voice recognition enable interface 1080.

Voice recognition enable interface 1080 includes confirmation affordance 1084 which when selected, enables voice recognition for the active user profile. As described, enabling voice recognition in this manner allows devices of a home ecosystem to recognize the user of the active user profile from voice commands. While displaying voice recognition enable interface 1080, device 601 detects selection of confirmation affordance 1084. The selection is a tap gesture 1006h on confirmation affordance 1084. As shown in FIG. 10I, in response to selection of confirmation affordance 1084, device 601 displays completion interface 1090 indicating that voice recognition has been enabled for the active user profile. In some embodiments, data is transmitted to device 600 indicating that voice recognition has now been enabled for the active user profile.

Thereafter (e.g., after receiving data indicating that voice recognition is now enabled for the active user profile), device 600 proceeds with and/or completes the configuration process. For example, once all preferences and/or settings, including but not limited to voice recognition, have been configured during the configuration process, device 600 displays home interface 1010A. In some embodiments, home interface 1010A includes indicator 1012A indicating that the configuration process is complete.

FIGS. 10K-10L illustrate a configuration process for device 600 when the set of personalized voice recognition criteria is met. In FIG. 10K, device 601 displays settings interface 1010 including voice recognition option 1012. As shown, voice recognition option 1012 is in an “ON” (e.g., enabled) state.

In some embodiments, during a configuration process in which personalized voice recognition criteria are met, device 600 may forgo display of one or more user interfaces of a configuration process described herein. By way of example, as described, personalized recognition criteria includes a requirement that a voice profile be associated with an active user profile. Accordingly, in some embodiments, device 600 may forgo display of voice profile interface 1050. As another example, personalized recognition criteria includes a requirement that voice recognition be enabled for an active voice profile (e.g., for a home ecosystem). Accordingly, in some embodiments, device 600 may forgo display of interfaces directed to enabling voice recognition, such as voice recognition interface 1040 and confirmation interface 1070. In such embodiments, omitting certain user interfaces can streamline the configuration process for device 600.

In some embodiments, device 600 receives (e.g., inherits) settings (e.g., preferences) for the active user profile from devices of a home ecosystem. Settings received in this manner include but are not limited to content preferences (e.g., music preferences, movie preferences) and security settings (e.g., two-factor authentication setting). By way of example, in some embodiments, in a configuration process in which personalized voice recognition criteria is not met, device 600 receives settings after enabling voice recognition for the active user profile. As another example, in some embodiments, in a configuration process in which personalized voice recognition criteria is met, device 600 receives settings after display of one or more interfaces (e.g., features interface 1030) and/or in response to detection of one or more inputs (e.g., input 1006c).

In some embodiments, receiving settings in this manner includes receiving a voice profile for the active user profile such that device 600 can recognize the user from voice commands. In some embodiments receiving settings in this manner includes receiving one or more other settings associated with a home automation environment (e.g., security permissions). In some embodiments, receiving settings in this manner includes receiving one or more preferences associated with the active user account, such as music preferences.

With reference to FIG. 10L, in some embodiments, upon receiving settings for the active user profile, device 600 causes device 601 to display notification 1078 indicating that device 600 can recognize the user from voice commands. In some embodiments, device 600 causes device 601 to display notification 1078 only during configuration processes in which personalized voice recognition criteria are met.

While description is made herein with respect to performing a configuration process for device 600 in which personalized voice recognition is enabled for an active user account, it will be appreciated that personalized voice recognition may be enabled during other configuration processes as well. In FIG. 10M, for instance, device 600 displays a settings interface 1020A for configuring one or more settings of an active user account. Update affordance 1022 of settings interface 1020A, when selected, initiates a process for updating one or more aspects of the active user profile. In some embodiments, during the process for updating the active user profile, device 600 can display one or more of the user interfaces described herein (e.g., voice recognition interface 1040, voice profile interface 1050) to allow a user to enable personalized voice recognition on one or more devices, such as device 600.

FIG. 11 is a flow diagram illustrating a method for performing a configuration process using a computer system in accordance with some embodiments. Method 1100 is performed at a computer system (e.g., 100, 300, 500, 600, 601) (e.g., a digital media player (e.g., a set top device), a smartphone) that is in communication with a display generation component (e.g., 602) (e.g., a television, a display controller, an internal or external touch-sensitive display system). In some embodiments, the computer system is, optionally, also in communication with an audio speaker and/or a haptic output device. Some operations in method 1100 are, optionally, combined, the orders of some operations are, optionally, changed, and some operations are, optionally, omitted.

As described below, method 1100 provides an intuitive way for performing a configuration process. The method reduces the cognitive burden on a user for performing a configuration process, thereby creating a more efficient human-machine interface. For battery-operated computing devices, enabling a user to perform a configuration process faster and more efficiently conserves power and increases the time between battery charges.

The computer system performs (1102) a configuration process for the computer system (e.g., a process for configuring one or more aspects of the computer system and/or one or more devices in communication with the computer system). In some embodiments, the configuration process is a device setup (e.g., initial configuration of a device). In some embodiments, the configuration process is an upgrade of an operating system. In some embodiments, the configuration process is a modification of one or more settings (e.g., a voice recognition setting).

The configuration process includes, in accordance with a determination that a set of personalized voice recognition criteria is not met (e.g., voice recognition is not enabled) for an active (e.g., a currently active, logged in user profile) user profile of the computer system, causing (1106) display, via the display generation component, of a set of one or more user interfaces (e.g., 1040, 1070) including an option (e.g., 1042, 1072, 1074) (e.g., affordance) that, when selected (e.g., selected via an input or a set of one or more inputs (e.g., tap on a displayed affordance)), initiates a process that enables voice recognition for the active user profile. In some embodiments, during the configuration process, the computer system determines whether personalized voice recognition criteria is met for an active user profile (e.g., a profile currently active on the computer system). In some embodiments, voice recognition criteria is determined to be met when a voice profile of a user is registered and/or otherwise associated with a home ecosystem such that any number of devices included in the home ecosystem may be operated by the user using voice commands. In some embodiments, voice recognition criteria includes a first criterion and a second criterion. In some embodiments, the first voice recognition criterion is met when a voice profile has been generated for the user. In some embodiments, a first device (or server) generates a voice profile for the user during a voice enrollment process and provides the voice profile to one or more other user devices for use in speech recognition. In some embodiments, a first device (or server) generates a voice profile for the user during a voice enrollment process and performs voice recognition on behalf of other devices using the voice profile (e.g., a user device receives a voice inputs from the user and provides the voice input to a server for use in speech recognition). In some embodiments, the second voice recognition criterion is met when a user has enabled a setting to allow devices of the home ecosystem (e.g., devices of the user, devices not assigned to the user) to perform voice recognition for the user (e.g., providing voice inputs to the server for voice recognition and performing one or more tasks based on a response from the server). In some embodiments, during the configuration process, if the computer system determines that voice recognition criteria is not met for an active user profile, the computer system displays a set of user interfaces that includes the option. In some embodiments, the option is displayed in its own discrete UI screen. In some embodiments, the option, when selected, enabled voice recognition in response to authenticating the user. In some embodiments, the option, when selected, initiates a process for enabling voice recognition on a device (e.g., mobile device) in communication with the computer system. In some embodiments, enabling voice recognition includes generating a voice profile for the user, for instance, as part of a voice enrollment process. In some embodiments, the voice profile generated for the user allows for one or more devices to identify a user based one speech inputs provided by the user. In some embodiments, enabling voice recognition further includes associating devices of a home ecosystem with the voice profile. In some embodiments, associating devices of a home ecosystem with a voice profile of a user allows devices of the home ecosystem (and optionally, a server in communication with the ecosystem) to identify (e.g., authenticate) the user in response to speech inputs. In this manner, the user may control devices of the home ecosystem using voice inputs, even when authentication is required to do so. In some embodiments, associating devices of a home ecosystem further allows for devices of the home ecosystem to better interpret speech inputs provided by the user.

The configuration process includes, in accordance with a determination that the set of personalized voice recognition criteria is met (e.g., voice recognition is enabled) for the active user profile, proceeding (1108) with the configuration process (e.g., completing the process) without providing the option (e.g., without providing 1042, 1072, 1074) to enable voice recognition for the active user profile during the configuration process. In some embodiments, during the configuration process, if the computer system determines that voice recognition criteria is met for an active user profile, the computer system forgoes providing the option to enable voice recognition. In some embodiments, forgoing providing the option includes forgoing display of one or more UIs for enabling voice recognition.

Causing display of an option to initiate a process to enable voice recognition in accordance with a determination that a set of personalized voice recognition criteria is not met for an active user profile of the computer system enables the computer system to quickly and efficiently provide the option without additional user input, which performs an operation when a set of conditions has been met without requiring further user input.

In some embodiments, during (e.g., as part of) the configuration process, the computer system is added to the home ecosystem. In some embodiments, adding the computer system in this manner causes the computer system to receive (e.g., retrieve) one or more user profiles associated with the home ecosystem. In this manner, the computer system can, optionally, be configured to work any number of users associated with the home ecosystem. The computer system can, for instance, have an active user profile for a first user and recognize a voice of one or more other users associated with user profiles that are not active.

In some embodiments, the set of personalized voice recognition criteria includes a criterion that is met when the active user profile of the computer system is associated with a voice profile. In some embodiments, a voice profile is a voice model (or multiple voice models) which can be used to detect (e.g., identify) a voice of a user associated with the voice profile. In some embodiments, a voice model is a model that has been trained using one or speech inputs provided by the user. In some embodiments, the voice model is implemented, at least in part, using one or more machine learning algorithms and/or neural networks (e.g., classification network). In some embodiments, a voice profile is associated with (e.g., generated for) the user profile by performing a voice enrollment process, for instance, using a device of a user of the user profile. In some embodiments, a voice profile may be generated by the computer system or another device during the configuration process. In some embodiments, the voice profile is used to authenticate and/or identify a user). Causing display of an option to initiate the process to enable voice recognition when the active user profile of the computer system is not associated with a voice profile enables the computer system to provide a voice profile during a configuration process, thereby reducing the number of required inputs.

In some embodiments, the set of personalized voice recognition criteria includes a criterion that is met when voice recognition is enabled for the active user profile of the computer system. In some embodiments, when enabled, voice recognition allows the computer system and/or one or more devices of a home ecosystem to perform voice recognition. In some embodiments, voice recognition cannot be enabled for a user profile until a voice profile has been associated with the user profile. Causing display of an option to initiate the process to enable voice recognition when voice recognition is enabled for the active user profile of the computer system enables the computer system to enable voice recognition during a configuration process, thereby reducing the number of required inputs.

In some embodiments, causing display, via the display generation component, of the set of one or more user interfaces including the option includes causing display of a voice recognition interface (e.g., 1040) including the option (e.g., 1042). In some embodiments, the set of one or more interfaces includes any number of interfaces for a configuration process, one of which includes the option. In some embodiments, the option is included in a voice recognition interface and selection of the option provides additional options which may be selected to select a manner in which voice recognition is to be enabled. In some embodiments, the option is included in a confirmation interface and selection of the option indicates the manner in which voice recognition is to be enabled. In some embodiments, proceeding with the configuration process without providing the option includes proceeding with the configuration process without causing display of the voice recognition interface (e.g., without displaying interface 1040) including the option. In some embodiments, in instances in which personalized voice criteria is met during the configuration process (e.g., voice recognition is enabled for the active user profile), the computer system does not display a voice recognition interface including the option that initiates a process to enables voice recognition for the active user profile. Selectively causing display of a voice recognition interface including the option enables the computer system to display the voice recognition interface only during configuration processes in which the set of personalized voice recognition criteria is not met, thereby reducing the number of required inputs and reducing the use of computer resources needed to display the option, when not required.

In some embodiments, causing display of, via the display generation component, the set of one or more user interfaces including the option includes causing display of a first set of user interfaces (e.g., 1020, 1030, 1050) that does not include the option. In some embodiments, proceeding with the configuration process without providing the option includes causing display of the first set of user interfaces (e.g., 1020, 1030, 1050) that does not include the option. In some embodiments, during the configuration process, the computer system displays a same subset of configuration user interfaces regardless of whether personalized voice recognition criteria is met, and any user interfaces directed to voice recognition are displayed in addition to the subset of configuration interfaces; in this manner, one or more aspects of the configuration process may be the same regardless of whether personalized voice recognition criteria is met during the configuration process. In some embodiments, all interfaces, other than interfaces related to the process for enabling voice recognition, are the same in each configuration process. In some embodiments, a configuration process in which voice recognition criteria is met may have other additional interfaces (e.g., interfaces not pertaining to voice recognition) compared to a configuration process in which voice recognition criteria is not met (and vice versa). Causing display of the first set of user interfaces in this manner enables the computer system to provide a consistent experience across configuration processes and to present options that are required regardless of whether the set of personalized voice recognition criteria is met or not met, which in turn enables the user to quickly and efficiently complete a configuration process on the computer system, which reduces the number of inputs needed to perform an operation.

In some embodiments, the process that enables voice recognition for the active user profile includes causing an external device (e.g., 601) to display a second set of one or more user interfaces (e.g., interface including 1074, 1080, 1090). In some embodiments, the process for enabling voice recognition on the external device includes causing display, on the external device, of a set of user interfaces indicating to the user that voice recognition may be enabled using the external device and/or enabled in response to selection of one or more affordances. Causing an external device to display a second set of interfaces enables a user to quickly and efficiently perform a process for enabling voice recognition using the external device, which reduces the number of inputs needed to perform an operation.

In some embodiments, the process that enables voice recognition for the active user profile includes causing display of a passcode interface for authenticating a user of the active user profile. In some embodiments, the passcode interface may be used to authenticate a user. In some embodiments, the passcode interface includes a field for entry of an input including a numerical passcode and/or password which may be used to authenticate the user. In some embodiments, the computer system receives the input and selectively authenticates the user; if the user is authenticated, the computer system (or another device in communication with the computer system) enables voice recognition and/or prompts the user to provide an additional input confirming that voice recognition is to be enabled by the computer system (or a device in communication with the computer system. Causing display of a passcode interface for authenticating a user of the active user profile allows the computer system to quickly and efficiently authenticate a user such that voice recognition may be enabled, which reduces the number of inputs needed to perform an operation.

In some embodiments, proceeding with the configuration process without providing the option to enable voice recognition for the active user profile during the configuration process includes, causing display, at an external device (e.g., 601), of a second notification (e.g., 1078) indicating that voice recognition has been enabled on the computer system (e.g., 600) for the active user profile. In some embodiments, if, during the configuration process, the set of personalized voice recognition criteria is met, the computer system forgoes a process to enable voice recognition and causes an external device to provide a notification that the computer system may be operated by the user using voice commands. In some embodiments, the computer system retrieves a voice profile for the active user account such that the computer system can identify and/or authenticate the user, and optionally, provide a personalized experience based on preferences and/or settings for the user profile). Causing display of a notification indicating that voice recognition has been enabled on the computer system for the active user profile provides the user with intuitive feedback regarding the state of voice recognition on the computer system, thereby providing improved feedback to the user.

In some embodiments, proceeding with the configuration process without providing the option to enable voice recognition for the active user profile during the configuration process includes retrieving, from an external device (e.g., a device of a home ecosystem in communication with the computer system), a voice profile associated with the active user profile. Retrieving a voice profile for an active user profile enables a user of the active user profile to quickly and efficiently operate the computer system using voice recognition, which reduces the number of inputs needed to perform an operation.

In some embodiments, the process that enables voice recognition for the active user profile includes providing (e.g., generating) a voice profile for the active user profile. In some embodiments, the computer system performs a voice enrollment process to generate the voice profile. In some embodiments, the computer system causes an external device to display a notification, which when selected, causes the external device to display a notification. In some embodiments, selection of the notification initiates a voice enrollment process on the external device. In some embodiments, after performing the voice enrollment process, the external device provides the voice profile to one or more devices of a home ecosystem and/or the computer system.

In some embodiments, after performing the configuration process (e.g., after process has been completed), the computer system receives a speech input (e.g., 1214, 1262) indicative of a task. In some embodiments, the speech input is a natural-language speech input including a request corresponding to a task (e.g., “Play me something”, “Switch to my profile”)). In some embodiments, in response to receiving the speech input indicative of a task, in accordance with a determination that the speech input corresponds to a first user profile, the computer system performs the task (e.g., provide content, switch profiles) based on the first user profile. In some embodiments, determining whether the speech input corresponds to a first user profile of the computer system. In some embodiments, the computer system determines whether the speech input corresponds to a user profile of the computer system using one or more voice recognition algorithms. In some embodiments, the computer system determines whether the speech input corresponds to a user profile of the computer system by comparing the speech input (or a representation thereof) to voice profiles of the computer system and determines whether the speech input (or the representation thereof) matches any of the voice profiles. In some embodiments, if the computer system determines that the speech input corresponds to a user profile on the computer system, the computer system performs the task according to the user profile. In some embodiments, in response to receiving the speech input indicative of a task, in accordance with a determination that the speech input does not correspond to the first user profile, the computer system forgoes performing the task based on the first user profile. In some embodiments, if the computer system determines that the speech input does not correspond to a user profile, the computer system forgoes performing the task according to the user profile. In some embodiments, the computer system determines that a speech input does not correspond to any user profiles of the computer system, and the computer system performs the task based on a common or default profile, or optionally, performs the task without referencing any user profile. In some embodiments, the configuration process is a device configuration process of a device, such as the computer system. In some embodiments, the device configuration process includes set up and/or updates for firmware, operating systems, and/or device settings. In some embodiments, the configuration process is a user configuration process. In some embodiments, the user configuration process includes set up of a new user profile and/or a modification (e.g., upgrade) of an existing user profile. Performing a task based on a user profile or not based on the user profile, in accordance with a determination that a speech input corresponds to a user profile, enables allows the computer system to perform an operation when a set of conditions has been met without requiring further user input, which reduces the number of inputs needed to perform an operation.

Note that details of the processes described above with respect to method 1100 (e.g., FIG. 11) are also applicable in an analogous manner to other methods described herein. For example, method 1100 optionally includes one or more of the characteristics of the various methods described above with reference to method 700. For example, in some instances after a device is configured via a configuration process, as described with respect to method 1100, and thereafter a voice input may be provided to the device to switch to a new user profile, as described with respect to method 900. For brevity, these details are not repeated.

FIGS. 12A-12G illustrate exemplary user interfaces for providing suggested content, in accordance with some embodiments. The user interfaces in these figures are used to illustrate the processes described below, including the processes in FIG. 13.

In the examples described in FIGS. 12A-12G, a device 600 (e.g., a device having one or more features of device 100, 300, and/or 500) causes display, on display 602, of the user interfaces described below. In some embodiments, display 602 is an integrated part of device 600. In some embodiments, device 600 is a separate digital media player (e.g., set top box) that is in communication (e.g., wireless, wired) with display 602.

In some embodiments, device 600 is connected to a remote control 604, which is configured to transmit data (e.g., via RF communication, via Bluetooth, via infrared) to device 600 based on user input (e.g., voice input, tactile input) detected at remote control 604. Remote control 604 includes a selection region 604a, which includes a touch-sensitive surface for detecting tap, press, and swipe gestures, a menu button 604b, a television button 604c, a microphone button 604d, a play/pause button 604e, and volume control buttons 604f.

At FIG. 12A, device 600 (e.g., a smart television) is causing display, on display 602 (e.g., the integrated screen of device 600), of home interface 1210. As shown, in some embodiments, home interface 1210 includes notification 1212 indicating that a user profile for a particular user (e.g., Chris) is active on device 600. In some embodiments, notification 1212 is displayed in response to switching an active profile on device 600.

While device 600 causes display of home interface 1210, device 600 receives user input 1214, a voice command (“What should I watch?”) from a user (e.g., Sarah) associated with a user profile that is not active on device 600. In some embodiments, user input 1214 is received directly by device 600 via an integrated microphone. In some embodiments, user input 1214 is received via a microphone of remote control 604, with an indication of being transmitted to device 600. In some embodiments, user input 1214 is a request for one or more items of suggested media content. In response to user input 1214, device 600 determines whether user input 1214 matches a user profile of device 600. In some embodiments, determining whether user input 1214 matches a user profile includes determining whether user input 1214 matches a voice profile of a user profile of device 600.

As shown in FIG. 12B, if device 600 determines that user input 1214 matches a user profile, device 600 provides a set of suggested media items 1220a-d (e.g., for the matching user profile). In some embodiments, device 600 identifies suggested media items 1220a-d based on user preferences and/or previous user behavior for the matching user profile.

In some embodiments, device 600 displays suggested media items 1220a-d such that suggested media items 1220a-1220d are overlaid on home interface 1210. In some embodiments, suggested media items 1220a-1220d are displayed according to a ranking of saliency scores. For example, in response to user input 1214, device 600 identifies a set of candidate media items, and based user preferences and/or user behavior, determines for each candidate media item, a saliency score reflecting a determined relevance of the candidate media item to the user of the matching user profile. A threshold number (e.g., four) of the media items having the highest respective saliency scores may be provided as suggested media items, and optionally, may be provided in an order corresponding to respective saliency scores. Suggested media item 1220a, for instance, may be a media item of the suggested media items 1220a-d corresponding to a highest saliency score, and a result, may be displayed as the first suggested media item in the set of suggested media items 1220a-d.

In some embodiments, device 600 indicates a user corresponding to the matching user profile. For example, in response to identifying the matching user profile and/or while displaying the set of suggested media items 1220a-d, device 600 causes device 602 to display indicator 1222 (e.g., “Okay, Sarah. Here are some recommendations for you.”), indicating that the set of suggested media items 1220a-d are provided for the user profile determined to match user input 1214 (e.g., “Sarah”; a different user profile than the currently active user profile). In some embodiments, device 600 further provides an auditory output, such as output 1224 (e.g., “Here are some recommendations for you.”), indicating suggested media items have been provided.

While device 600 causes display of suggested media items 1220a-d (e.g., overlaid on home interface 1210) including a focus on suggested media item 1220a, remote control 604 detects activation of selection region 604a via input 1205b corresponding to a selection (and request to initiate playback) of suggested media item 1220a (e.g., “Animated Heroes”). Remote control 604 transmits an indication of input 1205b to device 600, and in response to the indication of input 1205b, device 600 causes display 602 to display title interface 1230 corresponding to suggested media item 1220a, as shown in FIG. 12C. Title interface 1230 includes play affordance 1232, which when selected, causes playback of the selected media item (e.g., suggested media item 1220a).

While device 600 causes display of title interface 1230 including a focus on suggested media item 1220a, remote control 604 detects activation of selection region 604a via input 1205c corresponding to a selection (and request to initiate playback) of suggested media item 1220a (e.g., “Animated Heroes”). In response to the indication of input 1205c, device 600 initiates playback of suggested media item 1220a on device 602, as shown in playback interface 1240 of FIG. 12D. In some embodiments, after initiating playback, device 600 switches the active user profile on device 600 to the matching user profile. In some embodiments, in response to switching profiles, device 600 displays notification 1242 (e.g., “Welcome back, Sarah”) indicating that the active user profile on device 600 has been switched from the profile for Chris to the profile for Sarah.

In some embodiments, if device 600 determines that a user input, such as user input 1214, does not match (e.g., correspond to) a user profile of device 600 (e.g., such that that a confidence threshold is satisfied), device 600 provides suggested media items for the current active user profile and/or a generic user profile (e.g., a user profile that does not correspond to a user of device 600). In some embodiments, if device 600 determines that a user input, does not match a user profile of device 600, device 600 causes display 602 to display (e.g., replace display of home interface 1010 with) disambiguation interface 1250, as shown in FIG. 12E. In some embodiments, device 600 overlays disambiguation interface 1250 on home interface 1210.

Disambiguation user interface 1250 includes candidate user profiles 1252a-d, each of which corresponds to a respective user profile of device 600. In some embodiments, disambiguation interface 1250 includes candidate user profiles for all user profiles of device 600. In some embodiments, disambiguation interface 1250 includes candidate user profiles 1252a-d for a subset of user profiles of device 600. By way of example, in response to determining user input 1214 does not correspond to a user profile stored on device 600, device 600 identifies a threshold number of user profiles determined to most likely correspond to user input 1214. In some embodiments, device 600 identifies the threshold number of profiles by generating a confidence score for each user profile and selects a threshold number of user profiles corresponding to the highest confidence scores. In some embodiments, candidate user profiles 1252a-d are displayed according to their respective confidence scores. In some embodiments, candidate user profiles 1252a-d include the currently active user profile (e.g., the last user profile 1252a), which is, optionally, visually emphasized (e.g., highlighted).

While device 600 causes display of disambiguation interface 1250, device 600 receives a user input corresponding to a selection of a candidate user profile. Thereafter, device 600 may provide suggested media items for the selected user profile, as described.

While description is made herein with respect to providing suggested media items in response to a request for suggested media items, it will be appreciated that suggested media items may be provided in response to other types of requests as well. With reference to FIG. 12F, for example, device 600 receives user input 1262, a voice input (“Switch to my profile”) that includes a request to switch active user profiles on device 600. In response, device 600 switches the active user profile of device 600 to the user profile of the user providing user input 1262 (e.g., “Chris”), and displays home interface 1260 (FIG. 12G) including suggested media items (e.g., personalized based on preferences for Chris's profile) for the active user profile.

FIG. 13 is a flow diagram illustrating a method for providing suggested content using a computer system in accordance with some embodiments. Method 1300 is performed at a computer system (e.g., 100, 300, 500, 600) (e.g., a digital media player (e.g., a set top device), a smartphone) that is in communication with a display generation component (e.g., 602) (e.g., a television, a display controller, an internal or external touch-sensitive display system) and a set of one or more input devices (e.g., a voice input device, such as a (a microphone). Some operations in method 1300 are, optionally, combined, the orders of some operations are, optionally, changed, and some operations are, optionally, omitted.

As described below, method 1300 provides an intuitive way for providing suggested content. The method reduces the cognitive burden on a user for providing media content, thereby creating a more efficient human-machine interface. For battery-operated computing devices, enabling a user to access media content faster and more efficiently conserves power and increases the time between battery charges.

While a first user profile of the computer system (e.g., a profile for a first user associated with a set of user preferences, user authorizations, and/or user data, such as user access history) is an active user profile of the computer system, the computer system receives (1302), via the one or more input devices, a speech input (e.g., 1214, 1262) corresponding to a second user profile of the computer system (e.g., and does not correspond to the first user profile) that is an inactive user profile of the computer system. In some embodiments, a profile of a set of user profiles stored on and/or otherwise associated with the computer system may be active; when a profile is active, the computer system, optionally, operates according to one or more aspects of the profile (e.g., user preferences). As an example, the computer system can, optionally, provide suggested content for a particular profile (e.g., based on the user's preferences and/or previous behavior). In some embodiments, the speech input is a request for the computer system to provide suggested items. In some embodiments, the speech input is a request to switch profiles on the computer system such that a second user profile becomes active and the first user profile become inactive. In some embodiments, the speech input is received by the computer system. In some embodiments, the speech input is received by a device in communication with the computer system and transmits the speech input (or a representation thereof) to the computer system). In some embodiments, the computer system identifies, based on the speech input, a second user profile different than a currently active profile. In some embodiments, an active user profile is a user profile currently logged in on the computer system. In some embodiments, an active user profile is a user profile corresponding to a user currently (or most recently) operating the computer system. In some embodiments, the computer system operates according to one or more settings and/or preferences of an active user profile. In some embodiments, the computer system identifies the user profile based on a voice profile associated with the second user profile. In some embodiments, the computer system cannot identify a second user profile that satisfies a confidence threshold, and optionally, provides (e.g., displays) a disambiguation interface by which a user can select the appropriate profile. In some embodiments, the disambiguation interface includes a plurality of candidate user profiles that are, optionally, ranked according to respective confidence levels).

In response to receiving the speech input, the computer system provides (1304) a set of suggested media items (e.g., 1220a-1220d) associated with the second user profile (e.g., an inactive user profile, a user profile for “Sarah”) (e.g., and not associated with the first user profile) of the computer system. In some embodiments, in response to the speech input, the computer system provides (e.g., displays) one or more suggested media items (e.g., movies, television episodes, podcasts, songs, playlists, etc.). In some embodiments, the one or more suggested media items are provided based on the second user profile. The set of suggested media items may, for instance, be identified and/or provided based on previous behavior by a user of the second user profile. If for instance, the user prefers to watch a lot of action movies, the computer system may bias the set of suggested items toward including action movies. As another example, the set of suggested media items may be identified and/or provided based on user preferences of the second user profile. If, for instance, the user prefers to exclude content for children, the computer system may provide a set of suggested media items that does not include content for children. In some embodiments, the computer system provides the set of suggested media items associated with the second user profile without switching profiles (e.g., the set of suggested media items is provided while the first user profile is active). In some embodiments, the computer system displays a suggestions interface including one or more media items of the set of suggested media items. In some embodiments, the computer system receives a request for playback of a suggested media item of the set of media items (e.g., a selection of a suggested media item in the suggestions interface) and initiates playback of the suggested media item. In some embodiments, after (e.g., in response to) initiating playback of the suggested media item, the computer system switches to the second profile.

Receiving a speech input corresponding to a second user profile while a first user profile is active, and providing suggested media items for the second user profile allows the computer system to provide suggested media items for the second user profile without requiring that the second profile to be active while receiving the request, which reduces the number of inputs needed to perform an operation.

In some embodiments, the speech input (e.g., 1214) includes a request for one or more suggested media items. In some embodiments, the speech input is a request for the computer system (or a device in communication with the computer system) to provide suggested media items (e.g., “What should I watch?”). In some embodiments, the suggested media items are associated with the user profile of the requesting user and, optionally, are identified from a media library based on user preferences and/or settings of the user profile; as an example, if the user profile indicates a preference of the user for action movies, the process for identifying suggested media items may be biased toward action movies; as another example, if the user profile is a user profile for a child, the suggested media items may include only content deemed suitable for children. Providing a set of suggested media items in response to a request for suggested media items enables a user to quickly and efficiently request suggested media items using speech inputs, which reduces the number of inputs needed to perform an operation.

In some embodiments, the speech input (e.g., 1262) includes a request to switch user profiles on the computer system. In some embodiments, the speech input is a request to switch user profiles on the computer system (or on a device in communication with the computer system) such that a new profile is active on the computer system (e.g., “Switch to my profile”). In some embodiments, in response to the speech input, the computer system identifies a user profile matching the request, and thereafter provides a set of suggested media items corresponding to the user profile. In some embodiments, the computer system switches to the user profile prior to providing the set of suggested media items. In some embodiments, the computer system witches to the user profile after providing the set of suggested media items. Providing a set of suggested media items in response to a request to switch user profiles enables a user to quickly and efficiently view suggested media items when requesting a using speech inputs, which performs an operation when a set of conditions has been met without requiring further user input.

In some embodiments, after providing the set of suggested media items associated with the second user, the computer system receives, via the one or more input devices, a set of inputs (e.g., 1205b, 1205c) corresponding to a selection of a suggested media item (e.g., 1220a) of the set of suggested media items. In some embodiments, after providing the set of suggested media items, the computer system receives a set of inputs corresponding to a selection of a suggested media item of the set of suggested media items. In some embodiments, in response to receiving the set of inputs corresponding to the selection of the suggested media item, the computer system initiates playback of the selected suggested media item. In some embodiments, the set of inputs includes a selection of a suggested media item affordance corresponding to the suggested media item and/or selection of a play affordance, which when selected, causes playback of the suggested media item. In some embodiments, the play affordance is included in a canonical splash interface for the selected suggested media item. In some embodiments, the canonical splash interface is displayed in response to selection of the suggested media item affordance. In some embodiments, in response to receiving the set of inputs corresponding to the selection of the suggested media item, the computer system switches the active user profile of the computer system from the first user profile (e.g., a profile for a user “Chris”) to the second user profile (e.g., a profile for a user “Sarah”). In some embodiments, in response to the set of inputs, the computer system designates the second user profile as the active user profile on the computer system. In some embodiments, the computer system switches the active profile of the computer system from the first user profile to the second user profile (e.g., the user profile associated with the request). In some embodiments, the computer system switches the active profile prior to initiating playback of the suggested media item. In some embodiments, the computer system switches the active profile and initiates playback of the suggested media item concurrently. In some embodiments, the computer system switches the active profile after initiating playback of the suggested media item). Switching the active profile and initiating playback in response to the set of inputs allows the computer system to perform the switching operation when a set of conditions (e.g., selection of the suggested media item) has been met without requiring further user input.

In some embodiments, prior to providing the set of suggested media items, the computer system switches the active user profile of the computer system from the first user profile to the second user profile. In some embodiments, the computer system provides suggested media items after switching to the user profile matching the speech input. Switching to an active user profile of the computer system prior to providing a set of suggested media items enables the computer system to indicate to the user that a user profile of the user is active, indicating that the set of suggested items correspond to the user, thereby providing improved feedback to the user.

In some embodiments, switching the active user profile of the computer system from the first user profile to the second user profile includes receiving a user input corresponding to a confirmation to switch user profiles (e.g., a selection of any of candidate user profiles 1252a-1252d). In some embodiments, switching the active user profile of the computer system from the first user profile to the second user profile includes in response to the user input corresponding to a confirmation to switch user profiles, switching the active user profile of the computer system from the first user profile to the second user profile. In some embodiments, the computer system requires confirmation prior to switching an active user profile of the computer system. In some embodiments, the computer system displays a user interface by which a user can provide an input confirming that the computer system is to switch to a new active user profile (e.g., a user profile corresponding to a received speech input). Receiving confirmation prior to switching user profiles enables the computer system to better avoid switching user profiles at a time when the user does not desire to switch user profiles, thereby improving reliability and efficiency of the computer system.

In some embodiments, switching the active user profile of the computer system from the first user profile to the second user profile includes switching the active user profile of the computer system from the first user profile to the second user profile includes providing (e.g., displaying) a notification (e.g., 1242) indicating that the active user profile of the computer system has been switched (e.g., “Welcome, Sarah”). In some embodiments, the computer system displays a notification, for instance, on a home interface, indicating that the active profile of the computer system has been switched. In some embodiments, the computer system further provides a non-visual (e.g., auditory) notification indicating that the active user profile has been switched. In some embodiments, the notification identifies the user profile (e.g., “Sarah”). Providing a notification indicating that the active user profile of the computer system has been switched enables the computer system to quickly and efficiently notify the user of which user profile is active on the computer system at a given time, thereby providing improved feedback to the user.

In some embodiments, the speech input is a first speech input. In some embodiments, the computer system receives, via the one or more input devices, a second speech input (e.g., 1262) different from the first speech input. In some embodiments, the computer system identifies (e.g., displays an indication of) a third user profile (e.g., a user profile for a user “Chris”) (e.g., the first user profile, the second user profile, a user profile different than the first and second user profiles) based on the second speech input. In some embodiments, the computer system determines whether the speech input matches a voice profile of a user profile of the computer system; if so, the user profile of the matching profile is identified as the second user profile. Identifying a user profile based on a speech input allows the computer system to identify a user without requiring additional inputs from the user indicating an identity of the user, which reduces the number of inputs needed to perform an operation.

In some embodiments, identifying the third user profile based on the second speech input includes, identifying, based on the second speech input, a plurality of candidate user profiles (e.g., 1252a-1252d). In some embodiments, the computer system cannot readily identify a user profile based on the speech input (e.g., a top matching profile of the computer system has a confidence score (e.g., a score indicating a likelihood that the speech input corresponds to a user profile) below a threshold value), and in response, a set of user profiles determined to most likely correspond to the speech input is identified. In some embodiments, candidate profiles are identified by the computer system. In some embodiments, candidate profiles are identified by a device in communication with the computer system. In some embodiments, identifying user profiles in this manner includes generating a confidence score for each user profile of the computer system. In some embodiments, the computer system selects a predetermined number of user profiles having the highest confidence scores as candidate user profiles. In some embodiments, the currently active user profile is selected as a candidate user profile regardless of confidence score). In some embodiments, identifying the third user profile based on the second speech input includes, causing display, via the display generation component, of a disambiguation interface (e.g., 1250) including the plurality of candidate user profiles (e.g., 1252a-1252d). In some embodiments, the computer system causes display of an interface including each of the candidate user profiles. In some embodiments, the candidate user profiles are displayed in an order corresponding to confidence score (e.g., highest first). In some embodiments, the disambiguation interface is overlaid on another interface, such as a home interface. In some embodiments, identifying the third user profile based on the speech input includes, while causing display of the disambiguation interface, the computer system receives, via the one or more input devices, a selection (e.g., tap gesture) of a candidate user profile of the plurality of candidate user profiles. Disambiguating a user profile by displaying a plurality of candidate user profiles enables the computing system to allow a user to select from salient candidate user profiles, which reduces the number of inputs needed to perform an operation.

In some embodiments, the plurality of candidate user profiles includes the active user profile (e.g., 1252d) of the computer system. In some embodiments, the currently active user profile is selected as a candidate user profile. Including a currently active user profile in the plurality of candidate user profiles enables a user to maintain the current profile as the active profile when the computer system interprets a speech input as corresponding to another user profile, which reduces the number of inputs needed to perform an operation.

In some embodiments, providing a set of suggested media items associated with the second user profile of the computer system includes causing display of the suggested media items (e.g., 1220a-1220d) in a ranked order. In some embodiments, the computer system determines a saliency score for each of the suggested media items. In some embodiments, the saliency score indicates a determined relevance of the media item to the user of the user profile and/or a predicted interest of the user of the user profile in the media item. In some embodiments, suggested media items of the set of suggested media items are ranked according to their respective saliency scores and displayed according to the ranking. Displaying the suggested media items in a ranked order enables the computing system to first provide (e.g., highlight) suggested media items determined to be most salient to a user, which reduces the number of inputs needed to perform an operation.

In some embodiments, providing a set of suggested media items associated with the second user profile of the computer system includes providing (e.g., outputting) a non-verbal (e.g., auditory) output (e.g., 1222) indicating that the set of suggested media items has been provided (e.g., “Here are some recommendations”). Providing a non-verbal output indicating that the set of suggested media items has been provided enables the computer system to notify a user, using an additional type of output, that suggested media items have been provided, which provides improved visual feedback.

In some embodiments, providing a set of suggested media items associated with the second user profile of the computer system includes providing (e.g., causing to be displayed) a notification (e.g., 1222) identifying the second user profile. In some embodiments, upon providing the set of suggested media items, the computer system provides a notification identifying the user profile corresponding to the speech input, and optionally, indicating that the set of suggested media items corresponds to the identified user profile. Providing a notification identifying the second user profile while providing a set of suggested media items enables the user to quickly and efficiently identity a user corresponding to the suggested media items, which provides improved visual feedback.

In some embodiments, in accordance with a determination that the second user profile corresponds to a user profile associated with a first set of profile preferences, the set of suggested media items is a first set of suggested media items that are based on the first set of profile preferences. In some embodiments, profile preferences include television, movie, and/or music preferences (e.g., preferred genres). In some embodiments, preferences include settings for the user profile (e.g., a setting indicating a user's age). In some embodiments, the set of suggested media items is further based on content previously viewed while the user profile was active, a calendar of the user profile, contacts of the user profile, and/or applications frequently used by the user. In some embodiments, in accordance with a determination that the second user profile corresponds to a user profile associated with a second set of profile preferences, the set of suggested media items is a second set of suggested media items that are based on the second set of profile preferences and that is different from the first set of suggested media items. Conditionally providing suggested media items based on the set of profile preferences that correspond to the second user profile allows the computer system to perform an operation when a set of conditions has been met without requiring further user input.

In some embodiments, the speech input is data corresponding to speech input received at an external device (e.g., a device of a user providing the speech input) that is transmitted to the computer system. In some embodiments, the computer system receives a speech input (or a representation thereof) from a device communicatively coupled to the computer system and, based on the speech input, identifies a user profile corresponding to the speech input. In some embodiments, after identifying the user profile, the computer system provides a set of suggested media items for the identified user profile.

In some embodiments, in response to receiving the second speech input, the computer system provides a second set of suggested media items (e.g., 1264a-1264e) associated with the third user profile (e.g., and not associated with the first or second user profiles) of the computer system.

Note that details of the processes described above with respect to method 1300 (e.g., FIG. 13) are also applicable in an analogous manner to other methods described herein. For example, method 1300 optionally includes one or more of the characteristics of the various methods described above with reference to method 700. For example, a voice input may be provided to the device to request suggested content, as described with respect to method 1300, and prior to providing such content, the device may ensure that suggested content only include media items for which the user is authorized, as described with respect to method 700. For brevity, these details are not repeated.

FIGS. 14A-14E illustrate exemplary user interfaces for configuring user profiles, in accordance with some embodiments. The user interfaces in these figures are used to illustrate the processes described below, including the processes in FIG. 15.

In the examples described in FIGS. 14A-14E, device 600 causes display, on display 602, of the user interfaces described below. As discussed above, display 602 is an integrated part of device 600. Also as discussed above, in some embodiments, device 600 is a separate digital media player (e.g., set top box) that is in communication (e.g., wireless, wired) with display 602.

In the embodiment of FIGS. 14A-14E, device 600 is connected to a remote control 604, which is configured to transmit data (e.g., via RF communication, via Bluetooth, via infrared) to device 600 based on user input (e.g., voice input, tactile input) detected at remote control 604. Remote control 604 includes a selection region 604a, which includes a touch-sensitive surface for detecting tap, press, and swipe gestures, a menu button 604b, a television button 604c, a microphone button 604d, a play/pause button 604e, and volume control buttons 604f.

In FIG. 14A, device 600 is performing a configuration process, for instance, while a user profile for a particular user (e.g., “Chloe”) is active (e.g., logged in and/or signed in). In some embodiments, the configuration process is a device configuration process, such as a device configuration process performed during a first use of device 600 by a user or a device configuration process performed during a device upgrade (e.g., firmware upgrade and/or OS upgrade). In some embodiments, the configuration process is an account configuration process, for instance, for an account corresponding to the active user profile.

As shown in FIG. 14A, during the configuration process (e.g., while a user profile for a user “Chloe” is active), device 600 causes display of, on display 602 (e.g., the integrated screen of device 600), user profile interface 1410 that includes a set of candidate user profiles 1412. In some embodiments, candidate user profiles 1412 are candidate profiles available to be (but not currently) configured on device 600. In some embodiments, configuring a user profile on device 600 includes storing the user profile on device 600 such that a user of the user profile can log into device 600 and operate device 600 according to the user profile. In some embodiments, storing the user profile in this manner includes storing a voice profile for the user profile and/or one or more settings corresponding to the user profile on device 600.

In some embodiments, candidate user profiles 1412 are associated with the active user profile of device 600. As an example, in some embodiments, candidate user profiles are user profiles that share one or more subscriptions and/or services with the active user profile. As another example, in some embodiments, candidate user profiles are user profiles that belong to a same account group as the active user profile (e.g., accounts belonging to a same family). As yet another example, in some embodiments, candidate user profiles are user profiles associated with a same home automation application and/or home ecosystem (e.g., home automation system) as the active user profile.

Candidate user profiles 1412 include candidate user profile 1412a corresponding to a user profile “Kevin”, candidate user profile 1412b corresponding to a user “Chris”, candidate user profile 1412c corresponding to a user “Sara”, and candidate user profile 1412d corresponding to a user “Bobby”. While device 600 displays user profile interface 1410, any number of candidate user profiles 1412 can be selected by a user to be configured on device 600. As an example, selection indicators 1414a-1414c are displayed adjacent to candidate user profile 1412a-1412c, respectively, indicating that candidate user profiles 1412a-1412c have been selected to be configured on device 600 (e.g., in response to one or more inputs detected by device 600). In response to selection of confirmation affordance 1416, device 600 initiates a process to configure each of the selected user profiles 1412a-1412c on device 600, respectively, without configuring unselected user profile 1412d on device 600.

In some embodiments, a process to configure a selected user profile includes requesting consent (e.g., approval and/or authorization) from a user of the selected user profile. Accordingly, in some embodiments, device 600, in response to selection of confirmation affordance 1416, requests consent from each user corresponding to one or more of user profiles 1412a-1412c. In some embodiments, requesting consent includes sending an email to an email account corresponding to a selected user profile. As shown in FIG. 14E, in some embodiments, requesting consent includes causing a device (e.g., device 601) associated with a user of a candidate user profile to display a notification 1452 indicating that consent to configure the user profile has been requested. In some embodiments, selection of notification 1452 initiates a process to provide consent for the selected candidate user profile to be configured on device 600. Once consent has been provided for a candidate user profile, device 600 configures the candidate user profile for use on device 600 and proceeds with (e.g., completes) the configuration process.

In FIG. 14B, device 600 displays home interface 1420. In FIG. 14B, device 600 also displays control interface 1422, which is overlaid on home interface 1420.

Generally, control interface 1422 includes one or more user profiles configured on device 600. For example, control interface 1422 includes user profile 1424a (e.g., for a user “Chloe”) corresponding to an active user profile of device 600 and user profile 1424b (e.g., for a user “Kevin”) corresponding to a user profile that is configured for use on device 600 (e.g., a user profile that was selected during a configuration process and consented to be configured on device 600) that is currently not logged in (e.g., is not the active profile). In some embodiments, the active user profile is highlighted in control interface 1422. For example, as shown, active profile indicator 1426a (e.g., a checkmark and/or an asterisk) is displayed adjacent to user profile 1424a, indicating that user profile 1424a is active on device 600.

In some embodiments, control interface 1422 includes one or more user profiles not configured on device 600. In some embodiments, user profiles of control interface 1422 that are not configured on device 600, such as user profiles 1426c and 1426d, are candidate user profiles. As described, candidate user profiles are associated with the active user profile of device 600, for instance, by virtue of sharing one or more subscriptions and/or services with the active user profile, belonging to a same account group as the active user profile and/or being associated with a same home automation application and/or home ecosystem as the active user profile.

In some embodiments, display of control interface 1422 occurs after device 600 has performed a configuration process (e.g., the process of FIG. 14A). Accordingly, one or more user profiles of control interface 1422 that are not configured on device 600 can be user profiles with a consent request that is pending (e.g., one or more candidate user profiles selected during the configuration process for which consent has not yet been received). For example, control interface 1422 further includes user profiles 1424c (e.g., for a user “Chris”) and 1424d (e.g., for a user “Sara”). In some embodiments, user profiles 1424c and 1424d are user profiles with a pending consent request. In some embodiments, user profiles that have not been consented (e.g., approved and/or authorized) to be configured on device 600 are highlighted. For example, consent indicators 1426c and 1426d are displayed adjacent to user profiles 1424c and 1424d, respectively, indicating that consent has not been provided for user profiles 1424c and 1424d.

In some embodiments, device 600 presents candidate profiles 1424c, 1424d automatically, based on identifying predetermined relationships with one or more profiles that are already configured for use on device 600 (e.g., user profile 1424a and 1424b). In such embodiments, candidate profiles 1424c, 1424d are presented in control interface 1422 without a previous configuration process (e.g., the process of FIG. 14A) and without previously requesting consent. In such embodiments, consent indicators 1426c, 1426d indicate that consent needs to be provided to enable the use of candidate profiles 1424c, 1424d on device 600, but do not indicate that a consent request was sent to the users of those profiles.

In FIG. 14B, control interface 1422 includes add affordance 1428. Add affordance 1428, when selected, causes device 600 to provide (e.g., identify and/or display) one or more candidate user profiles for selection by a user. In some embodiments, candidate user profiles provided in response to selection of add affordance 1428 include one or more candidate user profiles provided, but not selected, during a device configuration process (e.g., candidate user profile 1414d corresponding to a user “Bobby”). In some embodiments, candidate user profiles provided in response to selection of add affordance 1428 include, one or more user profiles not previously identified as candidate user profiles (e.g., a user profile recently added to a home ecosystem).

In some embodiments, a user of a candidate user profile may wish to provide consent, directly while operating device 600, for a user profile using control interface 1422. For example, while device 600 causes display of control interface 1422 and while a focus is on user profile 1424d (e.g., for a user profile “Sara”), remote control 604 detects activation of selection region 604a via user input 1405b and transmits an indication of user input 1405b to device 600. Device 600 receives, from remote control 604, the indication of input 1405b.

In response to detecting (e.g., receiving the indication of) input 1405b, device 600 causes display 602 to display (e.g., replace display of control interface 1020 with) consent interface 1430, as shown in FIG. 14C. Consent interface 1430 includes device affordance 1432 and, optionally, authentication affordance 1434 (in some embodiments, consent interface 1430 does not include authentication affordance 1434). In response to selection of authentication affordance 1434, device 600 causes display 602 to display an authentication interface for authenticating the user associated with user profile 1424d (e.g., “Sara”). The authentication interface can be used, for example, to sign in the user associated with user profile 1424d on device 600 using secure credentials associated with user profiled 1424d. Once valid credentials have been provided to authenticate the user, device 600 configures user profile 1424d on device 600.

In response to selection of device affordance 1432, device 600 causes a device of a user associated with user profile 1424d (e.g., a device corresponding to the user “Sara”) (e.g., device 601) to indicate that consent to configure the user profile has been requested.

In some embodiments, the indication that consent has been requested is displayed if device 601 satisfies communication criteria. In some examples, communication criteria is met when device 601 is within a threshold distance of device 600. In some embodiments, the communication criteria is met when device 601 shares a network (e.g., LAN and/or WLAN) with device 600.

With reference to FIG. 14D, if device 600 determines that the communication criteria is met, device 600 causes device 601 to display a request interface 1440 including authentication affordance 1442 which, when selected, causes device 601 to display an authentication interface for authenticating the user of associated with user profile 1424d (e.g., “Sara”). Once a valid passcode has been provided to authenticate the user, device 600 configures user profile 1424d on device 600.

In some embodiments, device 600 causes device 601 to indicate that consent has been requested by causing device 601 to display a notification (e.g., notification 1452 of FIG. 14E) indicating that consent has been requested. In some embodiments, device 600 causes the device of the user to display the notification if communication criteria is met. In some embodiments, device 600 causes device 601 to display the notification irrespective of whether communication criteria is met.

FIG. 15 is a flow diagram illustrating a method for configuring user profiles using a computer system in accordance with some embodiments. Method 1500 is performed at a computer system (e.g., 100, 300, 500, 600) (e.g., a digital media player (e.g., a set top device), a smartphone) that is in communication with a display generation component (e.g., 602) (e.g., a television, a display controller, an internal or external touch-sensitive display system) and a set of one or more input devices (e.g., a voice input device (e.g., a microphone), a touch-sensitive surface, a button). Some operations in method 1500 are, optionally, combined, the orders of some operations are, optionally, changed, and some operations are, optionally, omitted.

As described below, method 1500 provides an intuitive way for configuring user profiles. The method reduces the cognitive burden on a user for configuring user profiles, thereby creating a more efficient human-machine interface. For battery-operated computing devices, enabling a user to configure user profiles faster and more efficiently conserves power and increases the time between battery charges.

The computer system causes (1502) display of, via the display generation component, a first candidate user profile (e.g., 1412a-1412d, 1426c, 1426d) (e.g., a profile that is currently not available for activating/logging on at the computer system) that has a predetermined relationship with an active user profile (e.g., a profile for a user “Chloe”) of the computer system (e.g., a user profile that is currently logged into the computer system). In some embodiments, the computer system identifies candidate user profiles to be configured on the computer system.

In some embodiments, candidate user profiles are profiles that share one or more subscriptions and/or services with the active user profile. In some embodiments, candidate user profiles are profiles associated with a same home automation application and/or home ecosystem (e.g., home automation system) as the active user profile.

In some embodiments, the computer system identifies and/or displays candidate user profiles during a configuration process (e.g., device configuration process, user account configuration process). In some embodiments, the computer system identifies and/or displays candidate user profiles while a user accesses a settings application for managing one or more settings of the computer system.

In some embodiments, the computer system displays candidate user profiles in a user profile interface. The user profile interface is displayed during the configuration process and/or as part of the settings application in some embodiments. In some embodiments, one or more of the candidate user profiles are displayed using an avatar associated with the user profile. In some embodiments, the user profile interface includes user profiles already configured on the computer system. In some embodiments, candidate user profiles and configured user profiles are visually distinct; for example, candidate user profiles can be displayed with a first visual characteristic and configured user profiles can be displayed with a second visual characteristic different than the first visual characteristic. In some embodiments, configured user profiles may be managed from the user profile interface, and optionally, candidate user profiles cannot be managed from the user profile interface.

In some embodiments, only user profiles of a particular type are included in the plurality of candidate user profiles. In some embodiments, only profiles associated with adults are included in the plurality of candidate user profiles.

The computer system receives (1504), via the one or more input devices, a first input (e.g., a tap, a button press) that corresponds to a selection of the first candidate user profile (e.g., a selection of one or more of 1412a-1412d, 1426c, 1426d, 1405b).

In response to the first input, the computer system initiates (1506) a process to configure the first candidate user profile as a user profile for the computer system (e.g., a profile that can be activated/logged into at the computer system). In some embodiments, a profile of the computer system is associated with a set of access privileges and/or stored preferences on the computer system).

In some embodiments, in response to selection of a candidate user profile, the computer system initiates a process for configuring the selected user profile as a profile for the computer system. In some embodiments, the process to configure the selected candidate profile includes requesting approval (e.g., authorization) from a user of the user profile. Accordingly, in some embodiments, the computer system, during the process to configure the selected candidate profile, requests approval from the user of the selected user profile. In some embodiments, the computer system requests approval by sending an email account for the user of the selected user profile. In some embodiments, the computer system requests approval by causing a device of the user of the selected user profile to display a notification requesting approval. In some embodiments, selection of the notification initiates a process on the device of the user of the selected user profile to provide authorization to configure the selected user profile for the computer system.

In some embodiments, after a user profile has been selected in the user profile interface, but prior to a user providing authorization to configure the user profile, the selected user profile is displayed in a manner indicating that authorization is still pending (e.g., the avatar for the user profile is displayed with a plus sign). In some embodiments, after a user has provided authorization, the user profile is displayed in the user profile interface as having been configured.

In some embodiments, the computer system configures one or more profiles without user authorization. In some embodiments, if the computer system belongs to a home ecosystem (e.g., home automation system) with another device that has previously received authorization to configure a user profile, the computer system can, in some instances, configure the user profile without authorization. In this manner, a user need provide authorization to configure their user profile only once. In some embodiments, the computer system is a device of a first type (e.g., a digital media player) and configures user profiles only if the computer system belongs to a home ecosystem with another device of the first type that has previously received authorization to configure a user profile.

Causing display of a candidate user profile and in response to selection of the candidate user profile, initiating a process to configure the candidate user profile on the computer system, allows a user to quickly and efficiently configure user profiles, which reduces the number of inputs needed to perform an operation. Causing display of a candidate profile that has a predetermined relationship performs an operation (e.g., display of the candidate profile) when a set of conditions have been met (e.g., the predetermined relationship). Further, causing display of a candidate profile that has a predetermined relationship reduces the risk of an unauthorized profile being configured on the device, which improves security and enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the predetermined relationship includes the first candidate user profile and the active user profile being associated with a first home automation system (e.g., a home automation system including device 600 and/or device 601). In some embodiments, each of the first candidate user profile and the active user profile are associated with (e.g., belong to) a same home automation system and/or home ecosystem. Accordingly, in some embodiments, users of the first candidate user profile and the active user profile reside at a same location and/or share access to a same home automation system. Displaying a candidate user profile that has a predetermined relationship with the active user profile in which the first candidate user profile and the active user profile are associated with a same home automation system allows a user to quickly and efficiently configure user profiles for a home ecosystem, which reduces the number of inputs needed to perform an operation and also improves security.

In some embodiments, the computer system is associated with the first home automation system. In some embodiments, the first candidate user profile and the active user profile are configured on (e.g., are validated user profiles that are available for active use on) a first device of the first home automation system. In some embodiments, each of the first candidate user profile and the active user profile are configured on one or more devices of a home automation system that includes the computer system. In some embodiments, the predetermined relationship includes the first candidate user profile and the active user profile being associated with a first account group (e.g., an account group including the active user profile for “Chloe”) (e.g., a group of accounts belonging to a family sharing service). Displaying a candidate user profile that has a predetermined relationship with the active user profile in which the first candidate user profile and the active user profile are associated with a same account group allows a user to quickly and efficiently configure user profiles for an account group, which reduces the number of inputs needed to perform an operation and also improves security.

In some embodiments, the first candidate user profile and the active user profile have access to a set of services (e.g., subscriptions and/or applications) associated with a primary user account (e.g., an account for a user selected as an admin for the first account group) of the first account group. In some embodiments, the predetermined relationship is a predetermined relationship of a first type (e.g., a relationship in which the first candidate user profile and the active user profile are associated with a same home automation system or a relationship in which the first candidate user profile and the active user profile are associated with a same account group). In some embodiments, the computer system displays, via the display generation component, a second candidate user profile, different than the first candidate user profile, that has a second predetermined relationship of a second type with the active user profile of the computer system, wherein the first type and the second type are different (e.g., a relationship in which the first candidate user profile and the active user profile are associated with a same home automation system or a relationship in which the first candidate user profile and the active user profile are associated with a same account group). In some embodiments, candidate user profiles have various predetermined relationships with an active profile of the computer system. In some embodiments, a candidate user profile is a user profile that shares one or more subscriptions and/or services with the active user profile. As another example, in some embodiments, a candidate user profile is a user profile that belongs to a same account group as the active user profile (e.g., accounts belonging to a same family). As yet another example, in some embodiments, a candidate user profile is a user profile associated with a same home automation application and/or home ecosystem (e.g., home automation system) as the active user profile. Displaying a second candidate user profile having a different predetermined relationship than the first candidate user profile allows the device to simultaneously display candidate user profiles corresponding to different types of predetermined relationships for selection, which reduces the number of inputs needed to perform an operation.

In some embodiments, the process to configure the first candidate user profile as a user profile for the computer system includes providing, to an external device (e.g., device 601) (e.g., a mobile device) associated with a user of the first candidate user profile, a request for consent to configure the first candidate user profile on the computer system. In some embodiments, requesting consent includes sending an email to an email account corresponding to a selected user profile. In some embodiments, requesting consent includes causing a device associated with a user of the selected candidate user profile to display a notification requesting that the user provide consent. In some embodiments, selection of the notification initiates a process to provide consent for the selected candidate user profile to be configured on the computer system. Once consent has been provided for a candidate user profile, the computer system configures the candidate user profile on the computer system. In some embodiments, the process to configure the first candidate user profile as a user profile for the computer system does not include providing a request if the first candidate user profile is a user profile of a first type (e.g., a user account for a minor or for a user under a threshold age). Providing a request for consent to an external device allows a user to quickly and efficiently provide consent for a user profile of the user to be configured on a computer system, which reduces the number of inputs needed to perform an operation and improves security by reducing the risk that an incorrect or non-consented user profile is added to the computer system.

In some embodiments, the computer system is associated with a second home automation system. In some embodiments, the process to configure the first candidate user profile as a user profile for the computer system includes, in accordance with a determination that a third candidate user profile (e.g., a user profile other than user profiles 1412a-1412d, 1426c, 1426d) is configured on a first device of the second home automation system, automatically (e.g., without user input) configuring the third candidate user profile as a user profile for the computer system (e.g., a profile that can be activated/logged into at the computer system) (ISE, a profile of the computer system is associated with a set of access privileges and/or stored preferences on the computer system). In some embodiments, the computer system is associated with a home automation system including one or more devices. In some embodiments, if the computer system identifies (e.g., during a configuration process) a third candidate user profile that is configured on a device of the home automation system, the computer system does not display the third candidate user profile for selection, but rather automatically configures the third candidate user profile on the computer system. In some embodiments, the computer system automatically configures the third candidate user profile if the third candidate user profile is configured on a same type of device as the computer system (e.g., the computer system is a digital media player and the third candidate user profile is configured on a digital media player of the home automation system). Automatically configuring a user profile if the user profile is configured on another device of a home ecosystem shared by the computer system enables the computer system to automatically configure user profiles for which consent has already been provided within the home ecosystem, which performs an operation when a set of conditions has been met without requiring further user input and improves security.

In some embodiments, the computer system displays the first candidate user profile (e.g., 1412a-1412d, 1426c, 1426d) during a configuration process wherein at least one other respective setting of the computer system is configured. In some embodiments, the configuration process is a device configuration process, such as a device configuration process performed during a first use of the device by a user or a device configuration process performed during a device upgrade (e.g., firmware upgrade and/or OS upgrade). In some embodiments, the configuration process is an account configuration process, for instance, for an account corresponding to the active user profile. In some embodiments, the configuration process is a configuration process for adding a user profile to an account group. Displaying candidate user profiles during a configuration process allows a user to quickly and efficiently configure user profiles when initiating and/or modifying one or more aspects of the computer system, which reduces the number of inputs needed to perform an operation.

In some embodiments, after initiating the process to configure the first candidate user profile as a user profile for the computer system, the computer system displays a plurality of user profiles (e.g., in a control interface that is, optionally, overlaid on a home interface of the computer system) including a first user profile (e.g., 1426a, 1426b), wherein the first user profile is configured (e.g., stored) as a user profile on the computer system and is displayed with a first visual characteristic (e.g., an indicator indicating that the first user profile is an active user profile of the computer system (e.g., a checkmark) or no indicator indicating that the first user profile is configured on the computer system) and a second user profile (e.g., 1426c, 1426d), wherein the second user profile is not configured as a user profile (e.g., the second user profile has not been consented and/or authorized to be configured on the computer system) on the computer system and is displayed with a second visual characteristic different from the first visual characteristic (e.g., an indicator indicating that consent has not been provided for the second user profile to be configured on the computer system (e.g., a plus sign)). In some embodiments, after initiating (or completing) the process to configure the first candidate user profile, the computer system displays an interface including user profiles. In some embodiments, the displayed user profiles include profiles configured on the computer system. In some embodiments, the displayed user profiles include profiles not configured on the computer system. In some embodiments, the active user profile is displayed with an indicator, allowing a user to readily identify the active user profile. In some embodiments, user profiles not configured on the computer system are displayed with an indicator, allowing a user to readily identify the active user profile. In some embodiments, selection of a user profile not configured on the computer system initiates a process for providing consent to configure the selected user profile on the computer system. Displaying a first user profile with a first visual characteristic to indicate that the first user profile is configured on the computer system and displaying a second user profile with a second visual characteristic to indicate that the second user profile is not configured on the computer system allows a user to quickly and efficiently identify which profiles are or are not configured on the computer system, thereby providing improved feedback to the user.

Note that details of the processes described above with respect to method 1500 (e.g., FIG. 15) are also applicable in an analogous manner to other methods described herein. For example, method 1500 optionally includes one or more of the characteristics of the various methods described above with respect to method 1300. For example, a user profile can be configured on a device, as described with respect to method 1500, and thereafter, suggested content can be provided in response to requests made by a user of the user profile, as described with respect to method 1300. For brevity, these details are not repeated.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve manner in which user profiles are managed. As an example, one aspect improves the manner in which the playback of media items is initiated. As another example, one aspect improves the manner in which user profiles are switched. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to identify users, for instance, using voice profiles. Accordingly, use of such personal information data enables users to utilize user profiles in an improved manner. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of user profiles, the present technology can be configured to allow users to select to “opt in” or “opt out” of participation in the collection of personal information data during registration for services or anytime thereafter. In another example, users can select not to provide data for voice profiles. In yet another example, users can select to restrict the manner in which recommended content is personalized based on historical viewing patterns. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available, or publicly available information.

What is claimed is:

1. A computer system configured to communicate with a display generation component and a voice input device, comprising:
one or more processors; and
memory storing one or more programs configured to be executed by the one or more processors, the one or more programs including instructions for:
while a first user profile is active, receiving, via the voice input device, a voice input; and
in response to receiving the voice input:
in accordance with a determination that the voice input includes a request to switch user profiles, and a determination that the voice input corresponds to a second user profile, switching from the first user profile to the second user profile; and
in accordance with a determination that the voice input includes a request to switch user profiles, and a determination that the voice input does not correspond to a stored user profile:
forgoing switching user profiles; and
causing display, at the display generation component, of a disambiguation user interface that includes a plurality of candidate user profiles.

2. The computer system of claim 1, wherein the determination that the voice input corresponds to the second user profile includes a determination that the voice input matches a voice profile of the second user profile.

3. The computer system of claim 1, wherein the determination that the voice input corresponds to the second user profile includes a determination that a portion of the voice input includes a reference to the second user profile.

4. The computer system of claim 1, the one or more programs further including instructions for:
after switching from the first user profile to the second user profile, identifying a set of content for the second user profile based on context information of the second user profile.

5. The computer system of claim 1, the one or more programs further including instructions for:
receiving a second user input; and
in accordance with a determination that the second user input is a request to provide media item recommendations for a plurality of user profiles:
identifying a first set of recommended media items for a third user profile;
identifying a second set of recommended media items for a fourth user profile; and
providing a third set of recommended media items, the third set of recommended media items based on the first and second sets of recommended media items.

6. The computer system of claim 1, wherein the computer system is further in communication with one or more input devices, the one or more programs further including instructions for:
while displaying the disambiguation user interface, receiving, via the one or more input devices, a selection of a candidate user profile of the plurality of candidate user profiles; and
switching from the first user profile to the selected candidate user profile.

7. The computer system of claim 1, wherein the plurality of candidate user profiles includes the first user profile.

8. The computer system of claim 7, wherein causing display, at the display generation component, of a disambiguation user interface that includes the plurality of candidate user profiles includes:
highlighting the first user profile.

9. The computer system of claim 1, wherein the plurality of candidate user profiles is assigned a respective plurality of confidence scores and wherein causing display, at the display generation component, of the disambiguation user interface that includes the plurality of candidate user profiles includes:
arranging the plurality of candidate user profiles based on the plurality of confidence scores.

10. A non-transitory computer-readable storage medium storing one or more programs configured to be executed by one or more processors of a computer system that is in communication with a display generation component and a voice input device, the one or more programs including instructions for:
while a first user profile is active, receiving, via the voice input device, a voice input; and
in response to receiving the voice input:
in accordance with a determination that the voice input includes a request to switch user profiles, and a determination that the voice input corresponds to a second user profile, switching from the first user profile to the second user profile; and
in accordance with a determination that the voice input includes a request to switch user profiles, and a determination that the voice input does not correspond to a stored user profile:
forgoing switching user profiles; and
causing display, at the display generation component, of a disambiguation user interface that includes a plurality of candidate user profiles.

11. A method, comprising:
at a computer system in communication with a display generation component and a voice input device:
while a first user profile is active, receiving, via the voice input device, a voice input; and
in response to receiving the voice input:
in accordance with a determination that the voice input includes a request to switch user profiles, and a determination that the voice input corresponds to a second user profile, switching from the first user profile to the second user profile; and
in accordance with a determination that the voice input includes a request to switch user profiles, and a determination that the voice input does not correspond to a stored user profile:
forgoing switching user profiles; and
causing display, at the display generation component, of a disambiguation user interface that includes a plurality of candidate user profiles.
